(19) United States
(12) Patent Application Publication
(10) Pub. No.: US 2020/0357069 A1
(43) Pub. Date: Nov. 12, 2020

(54) Financial planning system with automated selection of products and financing

(71) Applicants: Arthur M. Berd, New York, NY (US); Rohit M. D'Souza, New York, NY (US)

(72) Inventors: Arthur M. Berd, New York, NY (US); Rohit M. D'Souza, New York, NY (US)

(73) Assignee: Wealth Technologies Inc., New York, NY (US)

(21) Appl. No.: 16/731,021

(22) Filed: Dec. 30, 2019

Related U.S. Application Data
(63) Continuation-in-part of application No. 15/960,637, filed on Apr. 24, 2018.
(60) Provisional application No. 62/878,782, filed on Jul. 26, 2019.
(60) Provisional application No. 62/547,786, filed on Aug. 19, 2017.

(51) Int. Cl. G06Q 40/06; G06Q 40/02; G06F 21/62

(52) U.S. Cl. CPC G06Q 40/06; G06F 21/6245; G06Q 40/025

(57) ABSTRACT

A financial planning system automatically chooses products and financing for goals in an individual's financial plan or financial strategy, in accordance with desired product characteristics, financing templates, and test criteria provided by the individual. The financial planning system automatically commits to product purchases and loans on behalf of the individual. Financing alone can be selected for goals, and automatically committed. Products without financing can be selected for goals, and automatically purchased. Reduced (anonymized) versions of the financial plans are automatically analyzed to create product demand curves by product type, and loan demand curves by loan type, and these demand curves are respectively sent to product suppliers and loan providers, to encourage commercial offers in accordance with the individuals' financial plans or financial strategies.

### CROSS-REFERENCE TO RELATED APPLICATIONS

This application is a continuation in part of U.S. patent application Ser. No. 15/960,637, filed Apr. 24, 2018, and claims priority to U.S. provisional patent application Ser. No. 62/878,782, filed Jul. 26, 2019, having common inventors herewith, and a common assignee herewith, the disclosure of which is hereby incorporated by reference.

### BACKGROUND OF THE INVENTION

The present invention relates to a financial planning system that automatically selects products and financing in accordance with goals in a financial plan of an individual, and automatically commits to purchases and loans on behalf of the individual.

### Conventional Financial Planning Systems

A financial planner advises his or her client as to how to invest to achieve their financial goals. Computer-based systems exist that automate the calculations and projections typically made by a financial planner.

FIG. 1 shows configurations for a conventional financial planning (CFP) system.

A solo financial planner may execute software on their personal computer 50, and may use Internet 10 to access client accounts at banks 20 or brokerages 30. The financial planner may use information service 40 to obtain, e.g., quotes for current market valuation of client investments.

Alternatively, a solo financial planner having personal computer 50, with locally stored client information 55, can use a CFP system operative at financial planning server 60. Instead of a personal computer, the financial planner can use a tablet computer or a smartphone. Typically, personal computer 50 uses a public network, such as Internet 10, to communicate with server 60. In one configuration, referred to as software-as-a-service (SaaS), personal computer 50 has an operating system and browser, but lacks special software. In another configuration, referred to as a client-server configuration, personal computer 50 must first download special client software, and must execute this client software to gain access to the program at financial planning server 60.

An employee financial planner typically uses personal computer 70 on the premises of their employer, which operates financial planning server 60. Local area network (LAN) 62 provides the physical connection from personal computer 70 to financial planning server 60. The client information is stored in storage device 75 that is connected to LAN 62. Financial planning server 60 may use the Internet to access client accounts at banks or brokerages.

Alternatively, an employee financial planner can use financial planning server 60 in a SaaS or client-server configuration.

CFP software can be characterized as goal-based (CFP-GB), cash-flow-based (CFP-CF), or hybrid (CFP-HY).

In a goal-based system, the CFP-GB system explicitly allocates certain funds towards achieving a particular goal and then projects whether the goal can be achieved under simulations. Goals are funded separately, and the likelihood of their achievement is evaluated based on a Monte Carlo analysis of investments dedicated towards each goal. In a purely goal based system, there is no accounting of incomes and expenses, but instead there is an assumption about a level of necessary savings needed to achieve the set goals. The household's actual cash flows remain to be determined by the advisor in a separate exercise to see if the savings can be achieved.

The outcome of the CFP-GB system is a goal-based financial plan (FP-GB), which outlines how much ongoing savings in total are required in order to achieve the customer's goals and how these savings should be apportioned across the goals, and what allocation of investment products is recommended for investing these savings towards the goals.

FIG. 2A is a graph showing a single goal CFP-GB account. Assume that the goal involves one-time spending of a fixed amount, such as a piece of jewelry. Curve A shows the savings per period that the client expects to add to the goal account. Curve B shows the cumulative investment return on the savings in the account. Curve C shows that all of the money in the account is spent on the goal. Curve D shows the balance in the account: savings+return on investment−spending.

FIG. 2B is a graph showing three accounts for three goals in a CFP-GB system, such as home purchase, college tuition for one child, retirement nest egg, and boat. Each account behaves as in FIG. 2A. Importantly, the accounts are maintained independently.

During system set-up (not shown), the financial planning system is configured with tax tables, so that a client's estimated taxes can be automatically computed, and with expected life tables, so that years of retirement can be estimated.

FIG. 2C is a flowchart showing client set-up in a CFP-GB system.

At step 105, the user, either a financial planner acting on behalf of his/her client, or the client him/herself, opens an account for the client, and populates it with the client's age. The system then looks up the client's expected life, subtracts the user's age, and determines the timeframe T for the financial plan, in months, from the present month until the client's expected end of life. The user provides an initial savings balance (ISB) for the client, an expected monthly savings amount for each month, and a set of goal amounts G$[g], g=1 . . . G, and corresponding goal end dates GT[g].

At step 110, the user identifies the client's accounts with third-party systems, such as banks or brokerages, and provides access (read) and/or alteration permission. Most brokerages are set-up to enable a financial advisor to trade a client's account, but not withdraw funds therefrom.

At step 115, the financial planning system populates the client's account with information from the client's third-party accounts.

At step 120, the financial planning system gets initial values for the market environment for the client's account. Typically, this includes current prices for the financial instruments that the users holds, and might wish to hold, and price history for these financial instruments, to derive volatility per instrument. The market environment may also include future forecasts for returns and risk, if the planning system relies on such forecasts.

FIG. 2D is a flowchart showing operation in a CFP-GB system.

At step 150, the financial planner identifies the investments INV v=1 . . . V that will be used in the financial plan, and their risk parameters. For example, the investments that will be considered may be INV={bond1, bond2, bond3, equity1, equity2, equity3}, where each investment is a mutual fund or exchange-traded fund. Assume that bond1 and equity1 have low risk, bond2 and equity2 have medium risk, and bond3 and equity3 have high risk.

At step 155, the financial planning system pre-computes a set of Monte Carlo simulations, to create a Scenario Investment Return array SIR[n,t,v] based on the number of scenarios n=1 . . . N, where N is typically chosen as a large number such as 1,000, but any number may be used so long as it is large enough that the statistical distribution across scenarios is realistic, such as N being at least around 100; the time periods t=1 . . . T, where T was computed at step 105 of FIG. 2C; and the investments v=1 . . . . V chosen at step 150.

The Monte Carlo simulations use random numbers to simulate the behavior of markets. For instance, a low risk investment may be defined to have a monthly return in the range −10% to +10%, a medium risk investment may be defined to have a monthly return in the range −20% to +20%, a high risk investment may be defined to have a monthly return in the range −30% to +30%. The probability distribution for each investment may be defined as Gaussian (bell-shaped), centered at 2% for low risk investments, 6% for medium risk investments, and 12% for high risk investments. For each time period, a pseudo-random number in the range 0 to 1 is generated, with the distribution being equiprobable. Then, the generated number is mapped into a range using the probability distribution appropriate for the type of investment. Other techniques may be used to generate the Scenario Investment Return array SIR[n,t,v], such as a Monte Carlo simulation.

At step 160, the financial planner creates the Goal Accounts, one per goal.

At step 165, the financial planner sets the starting conditions, also referred to as a Trial Financial Plan, by allocating the ISB among the Goal Accounts, setting weights ws[g] for allocating monthly savings S (from step 105 of FIG. 2C) among the Goal Accounts, selecting k=1 . . . K investments for each goal account, and setting the weights w[g,k] for the investments in the Goal Accounts. Table 1 below shows an exemplary Trial Financial Plan, assuming ISB=$100,000.

TABLE 1
Exemplary Trial Financial Plan

| Goal | home purchase | college tuition | retirement | boat |
|---|---|---|---|---|
| | | for one child | nest egg | |
| ISB allocation for goal account | $50,000 | $5,000 | $40,000 | $5,000 |
| ws[g] | .50 | .15 | .30 | .05 |
| weights for savings S allocation | | | | |
| investments | equity2 | bond1 | equity2 | equity1 |
| | equity3 | bond2 | bond2 | equity2 |
| | bond1 | bond3 | bond3 | equity3 |
| wI[g, k] | .30 | .20 | .40 | .20 |
| | .10 | .30 | .30 | .20 |
| | .60 | .50 | .30 | .60 |

At step 170, the financial planning system creates the N scenarios based on the Trial Financial Plan and the Scenario Investment Return SIR[n,t,v] from the Monte Carlo simulation. For each scenario, for each time period, for each goal account, the financial planning system system computes the Goal Account Return GAR[n,t,g]:

GAR[n,t,g]=ₖ₌₁^{K}SIR[n,t,k]*wI[g,k] (equation 1)

and computes the Goal Account balance GA[n,t,g]:

GA[n,t,h]=(1+GAR[n,t,g])*GA[n,t−1,g]+S[t,g] (equation 2)

The financial planning system rebalances the goal account investments to conform to the weighted allocation in the Trial Financial Plan. If the goal's time limit GT[g] has been reached, the financial planning system closes the goal account for the goal, stores the final value of the Goal Account GAFV[n,g]=GA[n,t=GT[g],g], and allocates the savings that would have been used for the goal to other goals by a suitable method such as proportional reallocation or weighted reallocation. In proportional reallocation, each adjusted savings weight ws_adj[g] is increased by the same amount. Assume goal1 (g=1) has been reached, then for g=2 . . . G

ws_adj[g]=ws[g]+ws[1]/(g−1) (equation 3)

In weighted reallocation, each adjusted savings weight ws_adj[g], g=2 . . . G, is increased so that its share of savings remains constant:

ws_adj[g]=ws[g]+ws[g]/Σ_{g=2}^{G} ws[g] (equation 4)

At step 175, the financial planning system determines the goals success likelihood across all scenarios based on the stored GAFV[n,g]. A goal has succeeded when the scenario-wide GAFV[n,g] is at least equal to the goal amount G$[g] specified at step 105 of FIG. 2C. The Heaviside step function 1(⋅) has a value of one for positive arguments and zero for negative arguments.

Goals_success_likelihood=N⁻¹*Σₙ₌₁^{N}1(GAFV[n,g]≥G$[g]) (equation 5)

At step 180, the financial planning system decides whether the Trial Financial Plan is acceptable, that is, whether equation 5 is true for all goals g=1 . . . G. If so, processing continues at step 185. If not, processing returns to step 165, and the financial planner adjusts the Trial Financial Plan.

At step 185, the financial planning system defines the recommended financial plan as the first Trial Financial Plan that was deemed acceptable at step 180.

At step 190, if the customer has given permission, the financial planning system automatically moves funds among accounts, and/or places trades. Fund movement occurs when the ISB is allocated among accounts, when the monthly savings is allocated among accounts, and when accounts are rebalanced to conform to the financial plan.

In a cash-flow-based system, the CFP-CF system is acting more like an accounting system that projects into the future. It computes the planned incomes, expenses, accounts for taxes and other withholdings, and projects a simulated investment portfolio income. The goals in CFP-CF system are also represented as specific cash flow outlays planned for specific times in the future, such as a plan to purchase a second home 5 years from now or a plan to pay for kids' college expenses when they reach 18 years old. The system projects the cash flows and alerts the advisor if there is a deficit or surplus in cash flows under the advisor's financial plan assumptions.

The outcome of the CFP-CF system is a cash-flow-based financial plan (FP-CF), which outlines the parameters of the goals that are achievable given the customer's income and expenses assumptions, as well as the allocation of net savings across investment accounts and across investment products within accounts, recommended in order to achieve the selected goals.

FIG. 3A is a graph separately showing three goals in a CFP-CF system. Curve A shows the calculated savings per period that the client expects to add to the goal account, where savings=income−expenses−taxes. Curve B shows a first goal, with spending over a short time, such as college tuition for one child. Curve C shows a second goal, with one-time spending, such as a jewelry purchase. Curve D shows a third goal with spending over an extended period, such as retirement.

FIG. 3B is a graph showing events in a CFP-CF system. Curves A-D are as above. Curve E shows the cumulative investment return on the savings in the account, note that ater money is spent on a goal, the account balance is reduced so the investment return is calculated on a reduced amount, and thus is smaller. Curve F shows the balance in the account: savings+return on investment−spending.

FIG. 3C is a flowchart showing client set-up in a CFP-CF system.

Step 205 is similar to step 105 of FIG. 2C, except that instead of providing monthly savings S[t], the user provides monthly income INC[t] and monthly expenses EXP[t].

Steps 210, 215 and 220 are similar to steps 110, 115 and 120 of FIG. 2C.

FIG. 3D is a flowchart showing operation in a CFP-CF system.

Steps 250 and 255 are similar to steps 150 and 155 of FIG. 2D.

At step 260, the financial planner selects k=1 K investments for the client's single account, and sets weights w[k] for the investments in the single portfolio account. All goals are funded from this single account. The selected investments k=1 K, and the weights w[k] comprise the Trial Financial Plan.

At step 270, the financial planner set the initial account balance B[t=0] to be the ISB.

At step 275, the financial planning system creates the N scenarios based on the Trial Financial Plan and the Scenario Investment Return SIR[n,t,v] from the Monte Carlo simulation. For each scenario, for each time period, for the single portfolio account, the financial planning system system computes the Net Savings NS[t], where GCF[t,g] represents the goal cash flow spending for goal g at time t:

NS[t]=INC[t]−EXP[t]−TAXES[t]−Σ_{g=1}^{G}GCF[t,g] (equation 6)

then computes the scenario's Portfolio Return PR[n,t]:

PR[n,t]=Σₖ₌₁^{K}SIR[n,t,k]*wI[k] (equation 7)

then computes the account balance B[n,t]

B[n,t]=(1+PR[n,t])*B[n,t−1]+NS[t] (equation 8)

The financial planning system rebalances the goal account investments to conform to the weighted allocation in the Trial Financial Plan, as at step 170 of FIG. 2D. Rebalancing is needed because market growth, regardless of the financial plan, may be different for different investments, causing the portfolio to become imbalanced relative to the desired balance. At the conclusion of the scenario, the financial planning system stores the account balance B[n,t=T].

At step 280, the financial planning system determines the goals success likelihood across all scenarios based on the stored B[n,T]. If B[n,T] is positive, then the scenario is a success.

Goals_success_likelihood=N⁻¹*Σₙ₌₁^{N}(B[n,T]>0) (equation 9)

At step 285, the financial planning system decides whether the Trial Financial Plan is acceptable, that is, whether the Success metric is greater than 0. If so, processing continues at step 290. If not, processing returns to step 260, and the financial planner adjusts the Trial Financial Plan.

At step 290, the financial planning system defines the recommended financial plan as the first Trial Financial Plan that was deemed acceptable at step 285.

At step 295, if the customer has given permission, the financial planning system automatically moves funds among accounts, and/or places trades. Fund movement occurs when the ISB is allocated among accounts, when the monthly savings is allocated among accounts, and when accounts are rebalanced to conform to the financial plan.

In a hybrid system, the CFP-HY system is based on goals, like in case of CFP-GB system, however instead of relying on assumption about the level of net savings, it uses a more detailed accounting for cash flows, like in case of CFP-CF system. In a CFP-HY system, all goals are funded together, from the overall net cash flows.

The outcome of the CFP-HY system is a hybrid financial plan (FP-HY), which outlines the recommended levels of net savings (i.e. recommended level of expenses given the customer's income assumptions) together with the parameters of the goals that are achievable given such level of savings, as well as the allocation of net savings across investment accounts and across investment products within accounts, recommended in order to achieve the selected goals.

FIG. 4A is a graph showing a single goal CFP-HY account. Curves A-D of FIG. 4A are similar to curves A-D of FIG. 2A, except that in FIG. 4A, curve A is computed rather than being provided directly by the client or a financial planner, and curve C show a goal that involves spending for a short time, such as college tuition, rather than a one-time spending spike.

FIG. 4B is a graph showing three accounts for three goals in a CFP-HY system. As in a CFP-GB system, each goal has a separately funded goal account. As in a CFP-CF system, the savings allocation for each goal is based on the client's income, expenses and taxes. When a goal's spending has ended, the savings allocation is split among the remaining goal accounts according to a suitable re-allocation method, as discussed above for a CFP-GB system.

FIG. 4C is a flowchart showing client set-up in a CFP-HY system. CFP-HY client set-up steps 305, 310, 315, 320 are similar to CFP-CF setup steps 205, 210, 215, 220, discussed above.

FIG. 4D is a flowchart showing operation in a CFP-HY system.

Steps 350, 355, 360, 365 are similar to steps 150, 155, 160, 165 of FIG. 2D.

Step 370 is similar to step 170 of FIG. 2D, except that at the start of step 370, the net savings is calculated as at step 275, equation 6, of FIG. 3D. Then, the net savings is allocated among goal accounts:

S[t,g]=ws[g]*NS[t] (equation 10)

Steps 375, 380, 385, 380 are similar to steps 175, 180, 185, 190 of FIG. 2D.

There is room for improvement in financial planning systems.

### SUMMARY OF THE INVENTION

In accordance with an aspect of this invention, there is provided a method of creating a best financial plan for a user, the financial plan showing how at least one goal is affordable based on the user's income, expenses and investment performance, the financial plan having automatically selected financing for the at least one goal. In a user database, there are stored the at least one goal defined by the user, at least one financing template chosen by the user, acceptability criteria and optimality criteria. In a financing database, there are stored financing offers from financing providers, each financing offer having financing terms.

For each goal, a set of goal-financing scenarios is created, based on the goal, the user financing templates, and the financing offers. A draft financial plan is generated for each goal-financing scenario. Draft financial plans are eliminated according to the acceptability criteria to generate a set of acceptable financial plans. The best financial plan is selected according to the optimality criteria from the acceptable financial plans, and stored in the user database.

In accordance with another aspect of this invention, there is provided a method of creating a best financial strategy for a user, the financial strategy showing how at least one goal is affordable based on the user's income, expenses and investment performance, the financial strategy having automatically selected financing for at least one goal. In a user database, there are stored the at least one goal defined by the user, at least one financing template chosen by the user, periodic criteria and scenario-best criteria. In a financing database, there are stored financing offers from financing providers, each financing offer having financing terms.

For each goal, a set of goal-financing scenarios is created based on the goal, the user financing templates, and the financing offers. For each goal-financing scenario, the effect of financing on user wealth is estimated. Goal-financing scenarios are eliminated by comparing user wealth with the periodic criteria. The best goal-financing scenario is selected according to the scenario-best criteria. The best financial strategy is generated in accordance with the best goal-financing scenario, and stored in the user database.

In accordance with a further aspect of this invention, there is provided a method of creating a best financial plan for a user, the financial plan showing how at least one goal is affordable based on the user's income, expenses and investment performance, the financial plan having an automatically selected product for the at least one goal. In a user database, there are stored the at least one goal defined by the user, a set of chosen product characteristics associated with the goal and chosen by the user, acceptability criteria and optimality criteria. In a products database, there are stored product offers from product providers, each product offer having offered product characteristics.

A set of products is automatically selected from the products database, the offered product characteristics of each selected product satisfying the chosen product characteristics. A draft financial plan is generated for each selected product as the goal. Draft financial plans are eliminated according to the acceptability criteria to generate a set of acceptable financial plans. The best financial plan is selected according to the optimality criteria from the acceptable financial plans, and stored in the user database.

In accordance with a still further aspect of this invention, there is provided a method of creating a best financial strategy for a user, the financial strategy showing how at least one goal is affordable based on the user's income, expenses and investment performance, the financial strategy having an automatically selected product for at least one goal. In a user database, there are stored the at least one goal defined by the user, a set of chosen product characteristics associated with the goal and chosen by the user, periodic criteria and scenario-best criteria. In a products database, there are stored product offers from product providers, each product offer having offered product characteristics.

A set of products is automatically selected from the products database, the offered product characteristics of each selected product satisfying the chosen product characteristics. For each selected product, the effect of purchasing the product on user wealth is estimated. Products are eliminated by comparing user wealth with the periodic criteria. A best product is selected according to the scenario-best criteria. The best financial strategy is generated in accordance with the best product, and stored in the user database.

It is not intended that the invention be summarized here in its entirety. Rather, further features, aspects and advantages of the invention are set forth in or are apparent from the following description and drawings.

### BRIEF DESCRIPTION OF THE DRAWINGS

FIG. 1 shows configurations for a conventional financial planning (CFP) system;

FIG. 2A is a graph showing a single goal CFP-GB account;

FIG. 2B is a graph showing three accounts for three goals in a CFP-GB system;

FIG. 2C is a flowchart showing client set-up in a CFP-GB system;

FIG. 2D is a flowchart showing operation in a CFP-GB system;

FIG. 3A is a graph separately showing three goals in a CFP-CF system;

FIG. 3B is a graph showing events in a CFP-CF system.

FIG. 3C is a flowchart showing client set-up in a CFP-CF system;

FIG. 3D is a flowchart showing operation in a CFP-CF system;

FIG. 4A is a graph showing a single goal CFP-HY account;

FIG. 4B is a graph showing three accounts for three goals in a CFP-HY system;

FIG. 4C is a flowchart showing client set-up in a CFP-HY system;

FIG. 4D is a flowchart showing operation in a CFP-HY system;

FIG. 5 shows configurations for a financial planning system according to the present invention;

FIG. 6 is a chart showing prioritized goals with time and cost variability;

FIG. 7 shows a goal with value variability;

FIG. 8A-8H are graphs showing generation of MWAG curves;

FIG. 9 is a flowchart showing system set-up in a financial planning system according to the present invention;

FIG. 10 is a flowchart showing client registration in a financial planning system according to the present invention;

FIGS. 11A-11C are a flowchart showing operation in a financial planning system according to the present invention;

FIG. 12 is a graph showing Monte Carlo simulations of a user's financial life compared to MWAG curves;

FIGS. 13A-13C are charts showing different types of financing;

FIG. 14A is a chart showing the conventional process of financial planning;

FIG. 14B is a chart showing financial planning with automatically selected financing;

FIG. 15A is a graph showing the number of loans taken by users by time;

FIG. 15B is a graph showing financing demand curves for different predicted default rates;

FIG. 15C is a chart showing the deterministic nature of a modified conventional financial planning system;

FIG. 15D is a chart showing the probabilistic nature of a benchmark financial planning system;

FIG. 16A is a diagram showing the system configuration for a modified conventional financial planning system with automatically selected financing;

FIG. 16B is a flowchart showing system setup for the modified conventional financial planning system with automatically selected financing;

FIG. 16C is a flowchart showing user setup for the modified conventional financial planning system with automatically selected financing;

FIGS. 16D-16F are a flowchart showing user operation for the modified conventional financial planning system with automatically selected financing;

FIG. 16G is a flowchart showing creation of financing demand curves for the modified conventional financial planning system with automatically selected financing;

FIG. 16H is a flowchart showing loan provider setup for the modified conventional financial planning system with automatically selected financing;

FIG. 16I is a flowchart showing loan provider operation for the modified conventional financial planning system with automatically selected financing;

FIG. 17A is a diagram showing the system configuration for a benchmark financial planning system with automatically selected financing;

FIG. 17B is a flowchart showing system setup for the benchmark financial planning system with automatically selected financing;

FIG. 17C is a flowchart showing user setup for the benchmark financial planning system with automatically selected financing;

FIGS. 17C-17H are a flowchart showing user operation for the benchmark financial planning system with automatically selected financing;

FIG. 17I is a flowchart showing creation of financing demand curves for the benchmark 1 financial planning system with automatically selected financing;

FIG. 17J is a flowchart showing loan provider setup for the benchmark financial planning system with automatically selected financing;

FIG. 17K is a flowchart showing loan provider operation for the benchmark financial planning system with automatically selected financing;

FIG. 18 is a chart showing financial planning with automatically selected products and financing;

FIGS. 19A and 19B are charts showing exemplary dual goal sensitivity analysis reports;

FIG. 20A is a graph showing the number of products purchased by users by time;

FIG. 20B is a graph showing a product demand curve;

FIG. 21A is a diagram showing the system configuration for a modified conventional financial planning system with automatically selected products and financing;

FIG. 21B is a flowchart showing system setup for the modified conventional financial planning system with automatically selected products and financing;

FIGS. 21C-21D are a flowchart showing user setup for the modified conventional financial planning system with automatically selected products and financing;

FIGS. 21E-21H are a flowchart showing user operation for the modified conventional financial planning system with automatically selected products and financing;

FIG. 21I is a flowchart showing creation of financing demand curves for the modified conventional financial planning system with automatically selected products and financing;

FIG. 21J is a flowchart showing loan provider setup for the modified conventional financial planning system with automatically selected products and financing;

FIG. 21K is a flowchart showing loan provider operation for the modified conventional financial planning system with automatically selected products and financing;

FIG. 21L is a flowchart showing product supplier setup for the modified conventional financial planning system with automatically selected products and financing;

FIG. 21M is a flowchart showing product supplier operation for the modified conventional financial planning system with automatically selected products and financing;

FIG. 22A is a diagram showing the system configuration for a benchmark financial planning system with automatically selected products and financing;

FIG. 22B is a flowchart showing system setup for the benchmark financial planning system with automatically selected products and financing;

FIG. 22C-22D are a flowchart showing user setup for the benchmark financial planning system with automatically selected products and financing;

FIGS. 22E-22J are a flowchart showing user operation for the benchmark financial planning system with automatically selected products and financing;

FIG. 22K is a flowchart showing creation of financing demand curves for the benchmark financial planning system with automatically selected products and financing;

FIG. 22L is a flowchart showing loan provider setup for the benchmark financial planning system with automatically selected products and financing;

FIG. 22M is a flowchart showing loan provider operation for the benchmark financial planning system with automatically selected products and financing;

FIG. 22N is a flowchart showing product supplier setup for the benchmark financial planning system with automatically selected products and financing; and

FIG. 22O is a flowchart showing product supplier operation for the benchmark financial planning system with automatically selected products and financing.

### DETAILED DESCRIPTION

A specific goals/financing financial planning system, also referred to as a consumption planning system, enables connection between an individual's financial plan, and real world product and financing offers that are resources for helping the individual achieve his or her goals.

Only the very richest tier of population has enough wealth and income to be able to manage their financial lives and reach their life goals purely based on the results obtained from investments. For the vast majority of people both in the United States and elsewhere in the world, the bigger portion of their financial lives are centered on ongoing consumption of products and services.

Thus, a financial planning system adapted for planning and managing consumption is needed for the rest of the population, so they can understand the implications of their decisions over their lifetimes. A consumption-oriented financial planning system opens the door to aggregating consumption of individuals into a group, obtaining benefits from product and service providers based on the group, and feeding such benefits back to the individuals.

An important aspect of an optimal financial plan is timing. First, it is necessary to model the full cost of consumption, including upfront and periodic costs as well as savings. Second, it is helpful to have consumption priorities so that resources can be optimally allocated. Third, it is helpful to know flexibility in usage and cost.

Optimal wealth management creates more money for consumption. Wealth management comprises properly allocating savings between cash and investments of differing types and differing taxability, and managing risk exposure across different investments.

Optimal consumption management depends on spending limited resources on the things that matter, which is modelled by assigning priorities to goals.

A critical part of a consumption managing system is the ability to choose the best financing for a user. Accordingly, financial planning systems automating the choice of financing will now be discussed.

As shown in Table 1.5, this application presents six configurations of financial planning systems (FPSs), three based on a conventional FPS, and three based on a benchmark FPS. The three configurations are: (a) baseline (without automatically selected products and financing), (b) modified for automatically selected financing, and (c) modified for automatically selected products and financing.

Use cases are presented at the end of this specification.

TABLE 1.5
Configurations of Financial Planning Systems

| | Non-Benchmark FPS | | | Benchmark FPS | | |
|---|---|---|---|---|---|---|
| | | Mod. + | Mod. + | | Benchmark + | Bench + |
| | Conventional | F | P + F | Benchmark | F | P + F |
| Physical configuration | 1 | 16A | 21A | 5 | 17A | 22A |
| System Setup | — | 16B | 21B | 9 | 17B | 22B |
| Individual Setup | 3C | 16C | 21C | 10 | 17C | 22C |
| . . . Select product chars. | — | — | 21D | — | — | 22D |
| Individual Operation | 3D | 16D | 21E | 11A | 17D | 22E |
| . . . Benchmark | — | — | — | 11B | 17E | 22F |
| . . . Select Financing [Prod] | — | 16E | 21F | — | 17F | 22G |
| . . . Purchase Commitment | — | — | 21G | — | — | 22H |
| . . . Fin'l Strategy | — | — | — | 11C | 17G | 22I |
| . . . Loan Commitment | — | 16F | 21H | — | 17H | 22J |
| Create Demand Curves | — | 16G | 21I | — | 17I | 22K |
| Lender Setup | — | 16H | 21J | — | 17J | 22L |
| Lender Operation | — | 16I | 21K | — | 17K | 22M |
| Product Supplier Setup | — | — | 21L | — | — | 22N |
| Product Supplier Oper'n | — | — | 21M | — | — | 22O |
| Relevant Use Case | First | Third | Fifth | Second | Fourth | Sixth |

In other configurations (not shown), an FPS automatically selects products but lacks capability to automatically select financing.′

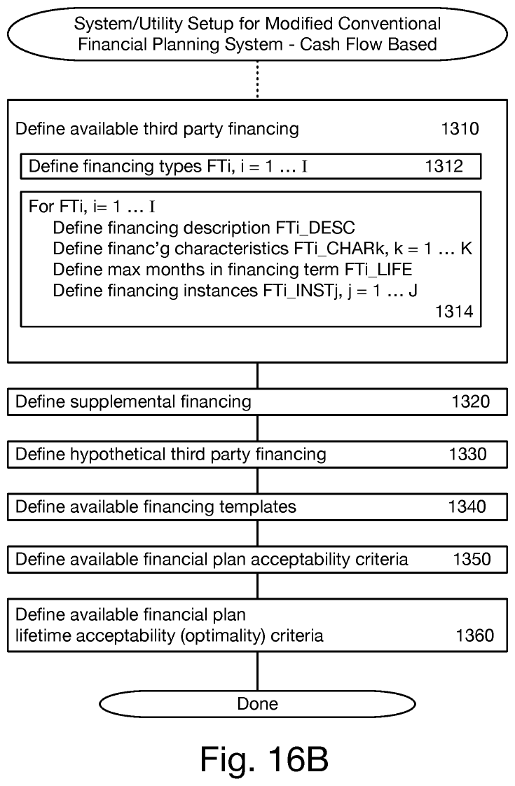

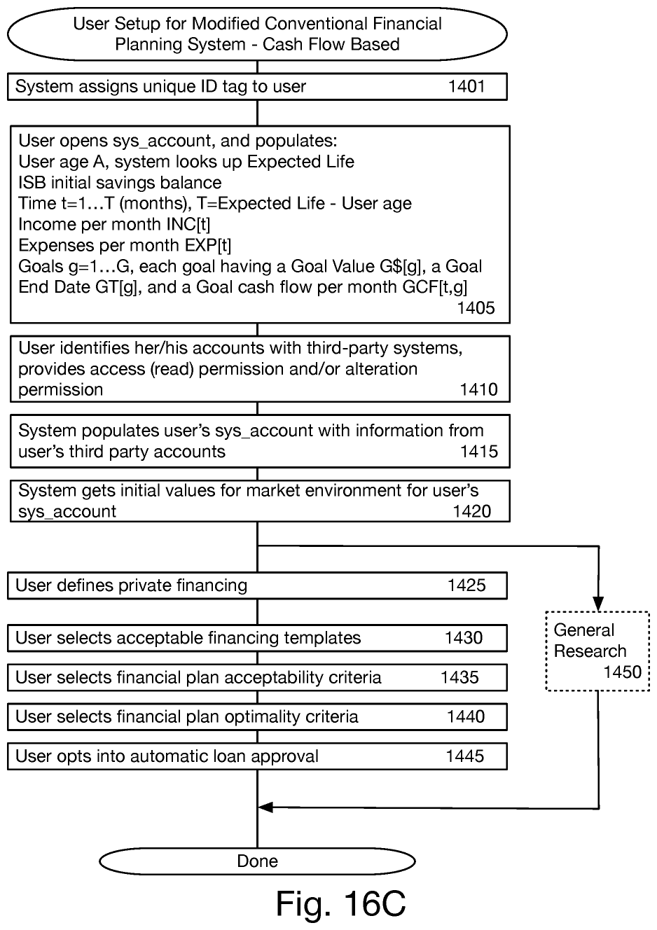

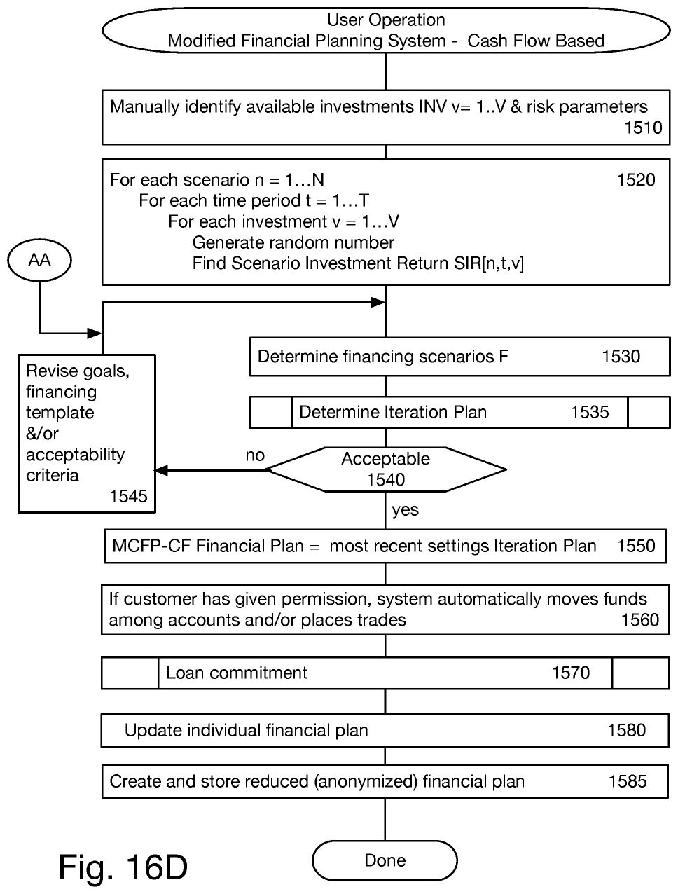

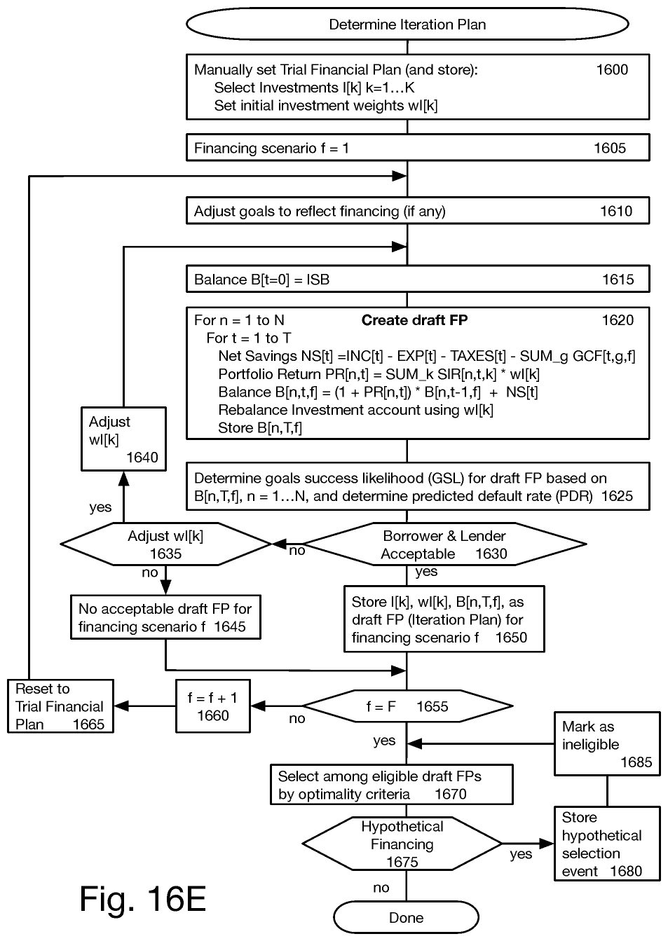

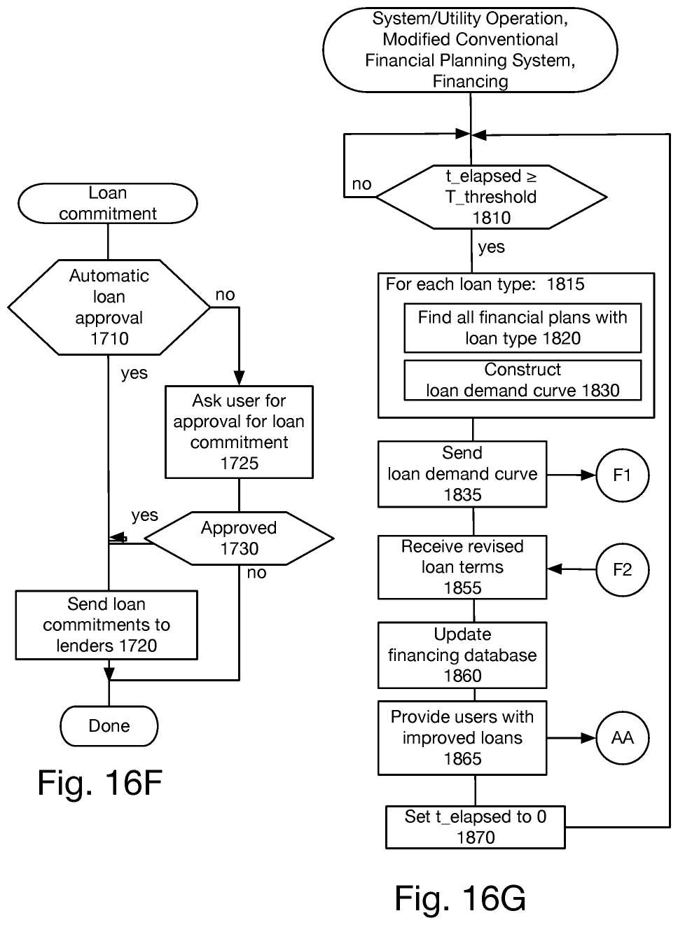

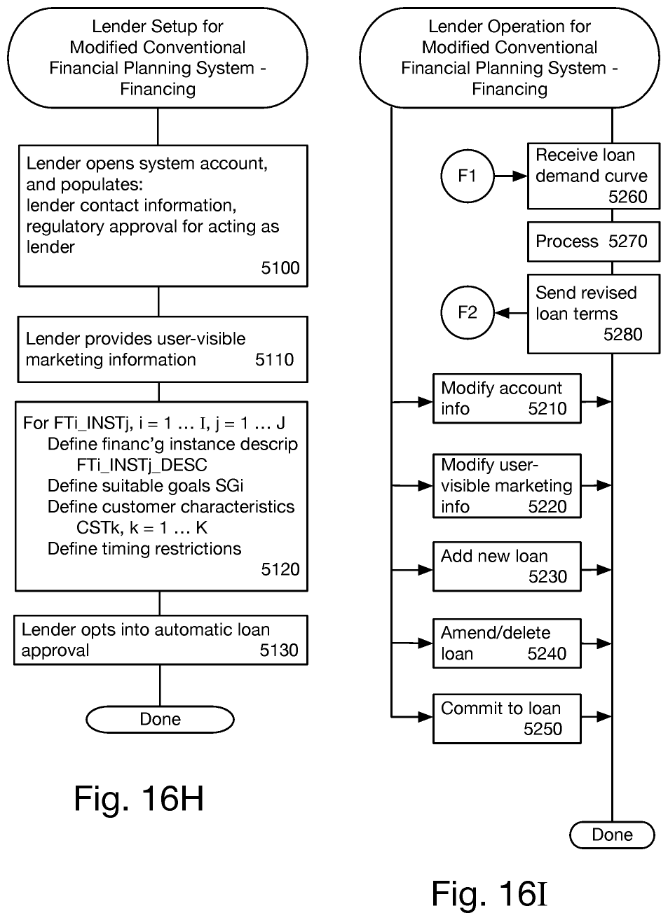

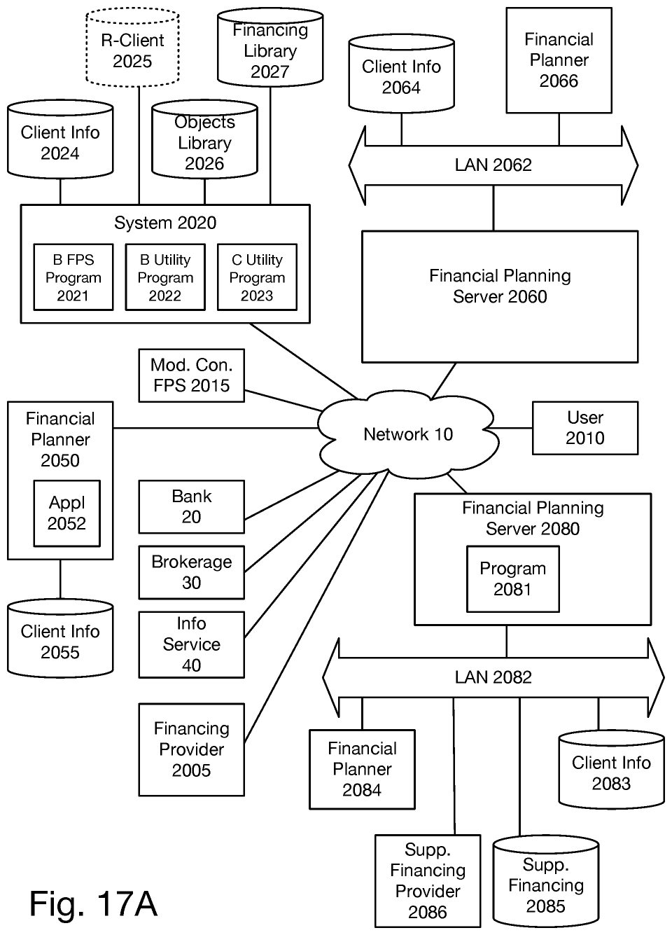

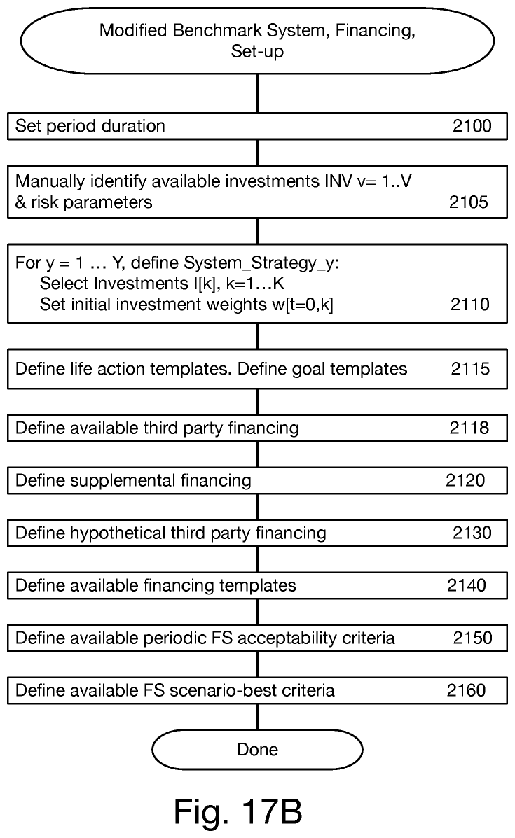

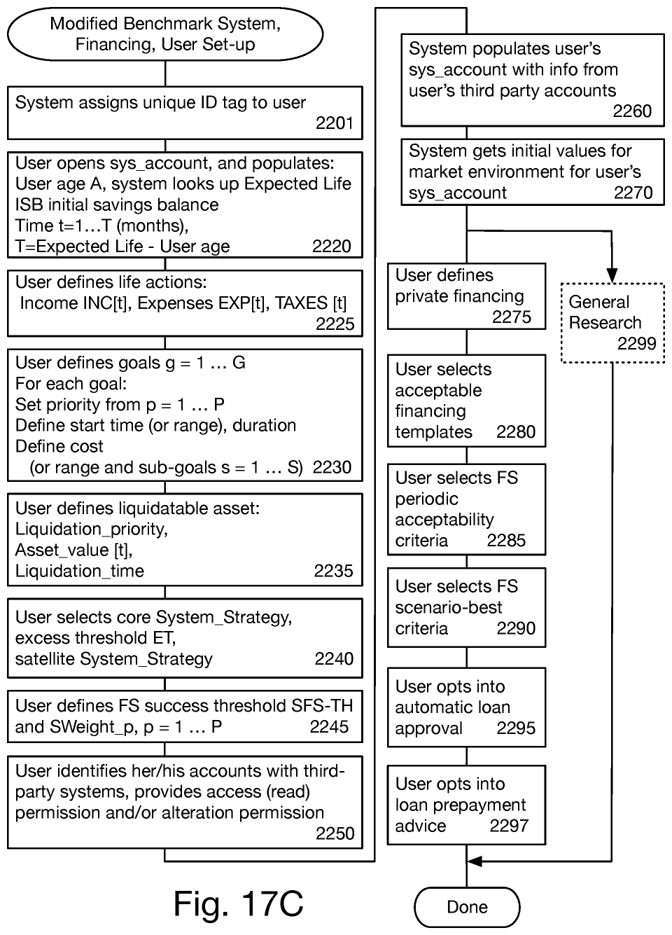

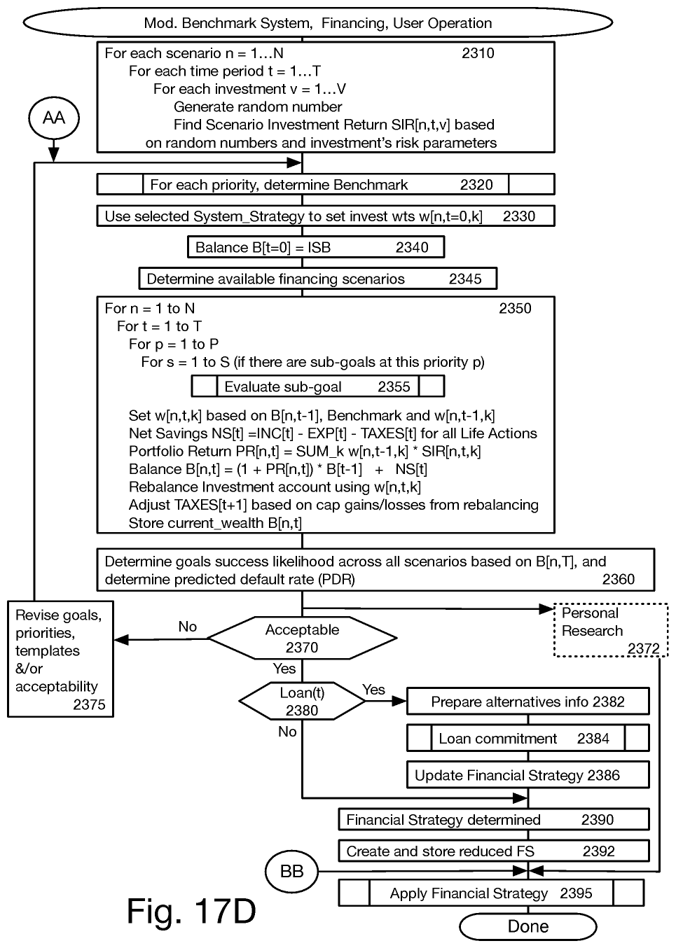

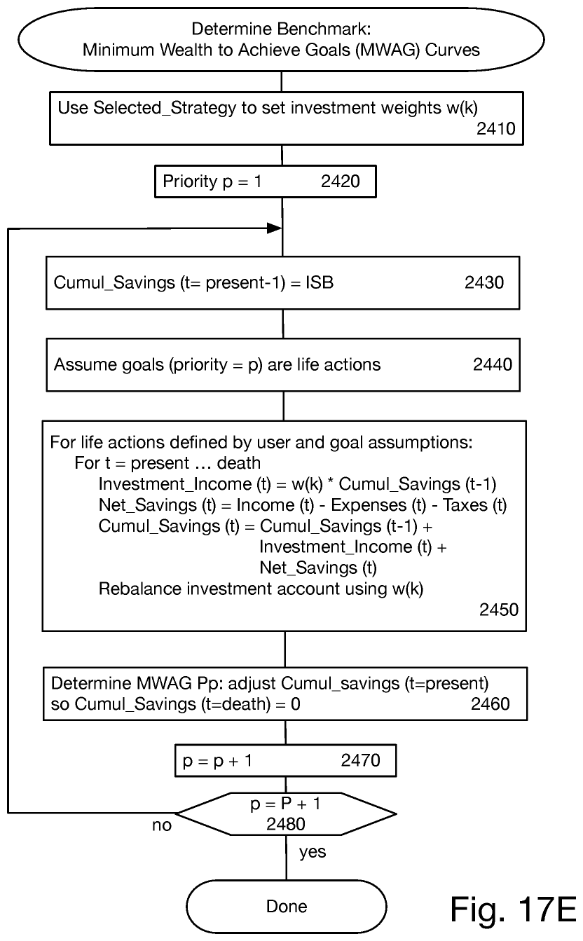

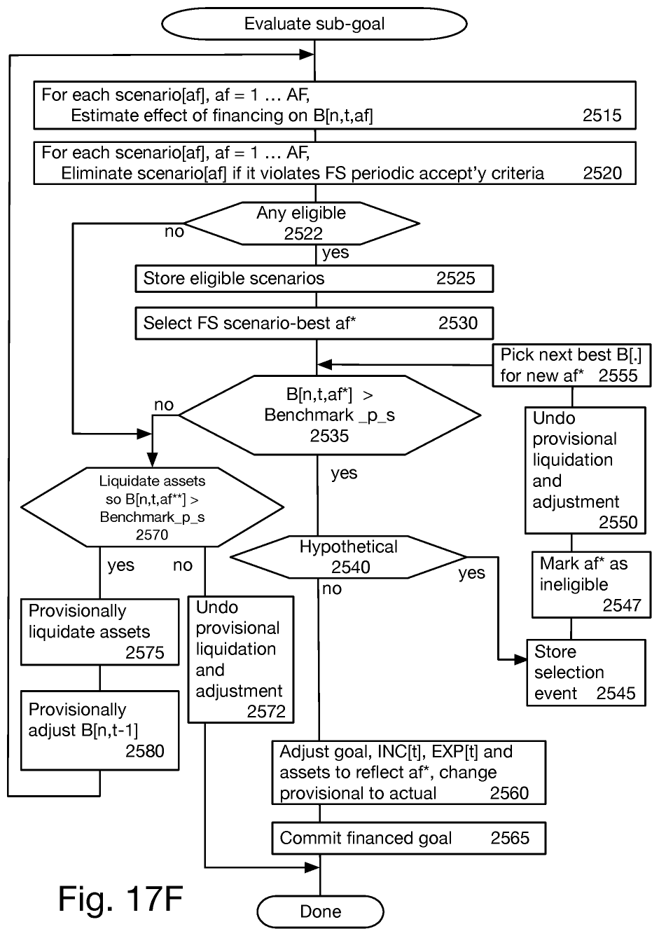

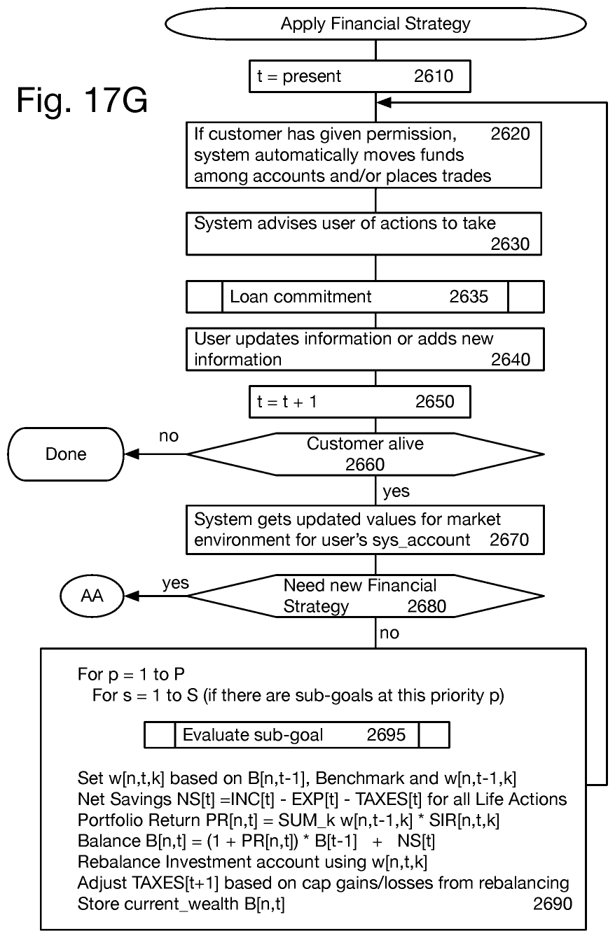

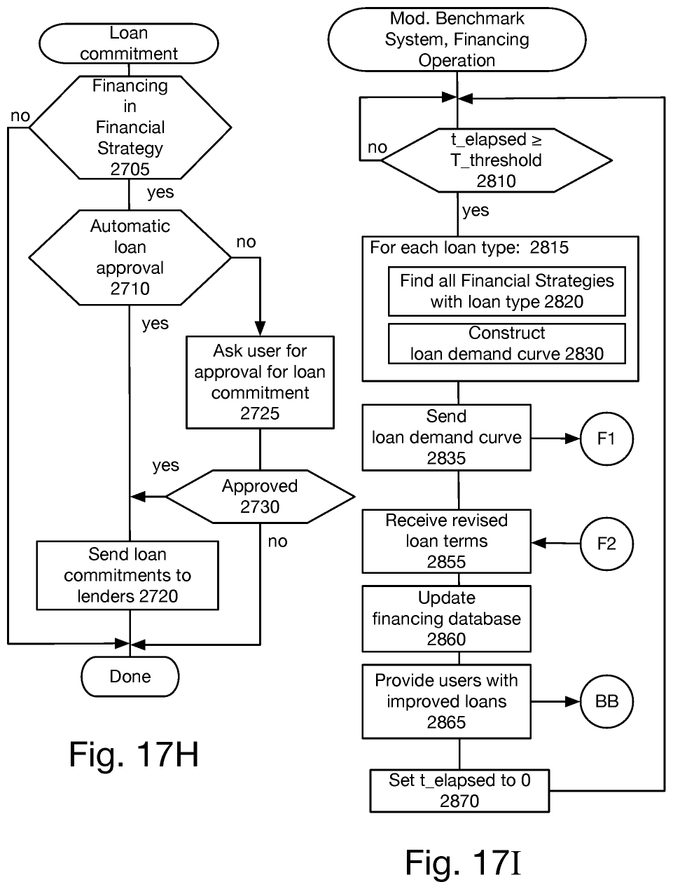

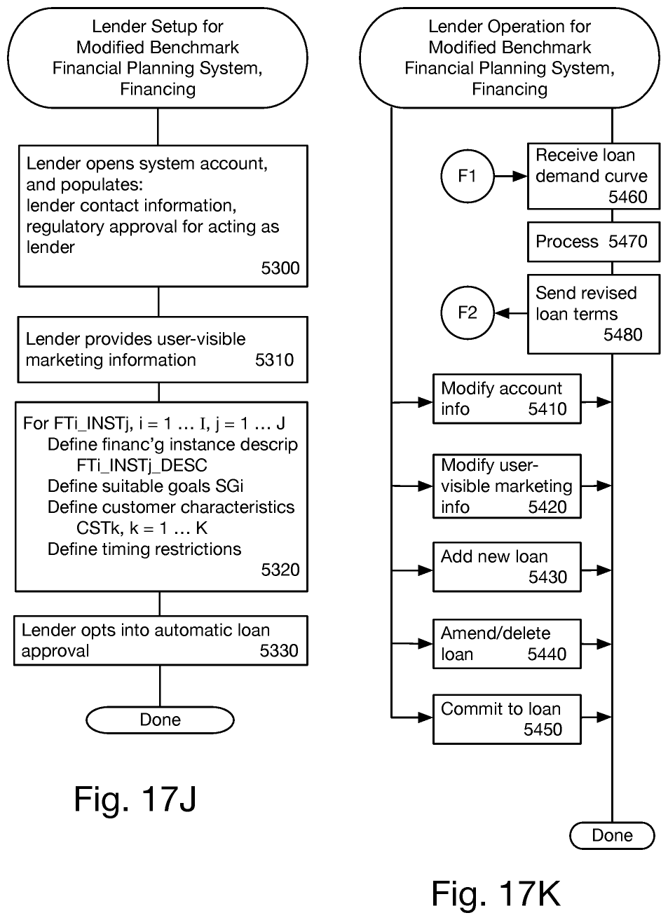

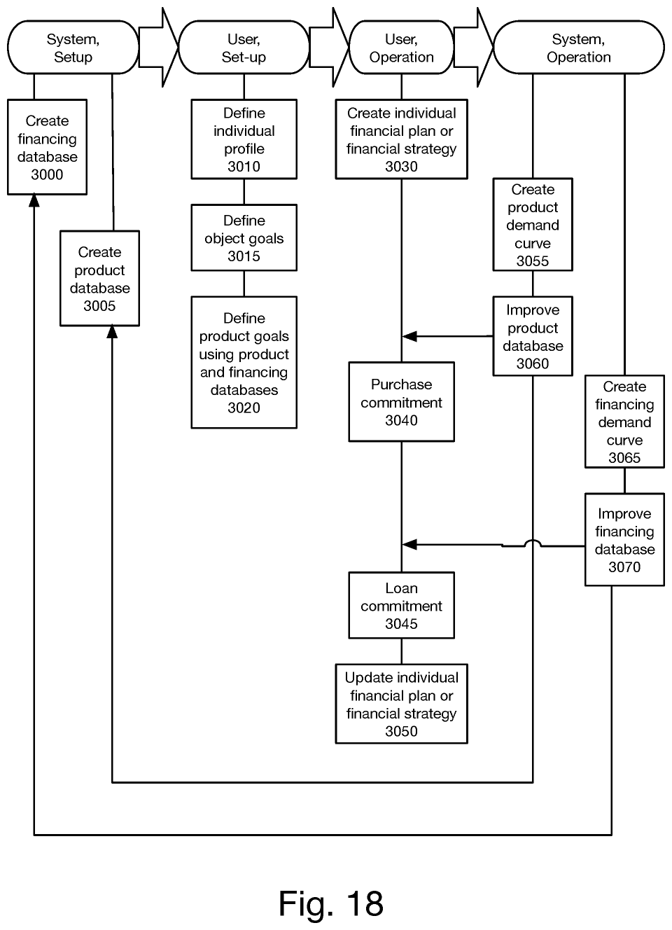

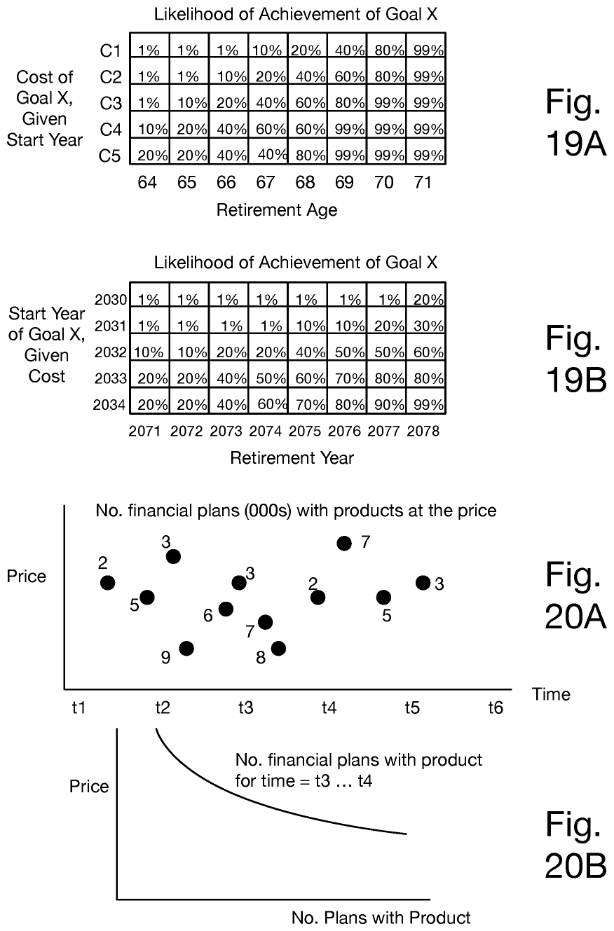

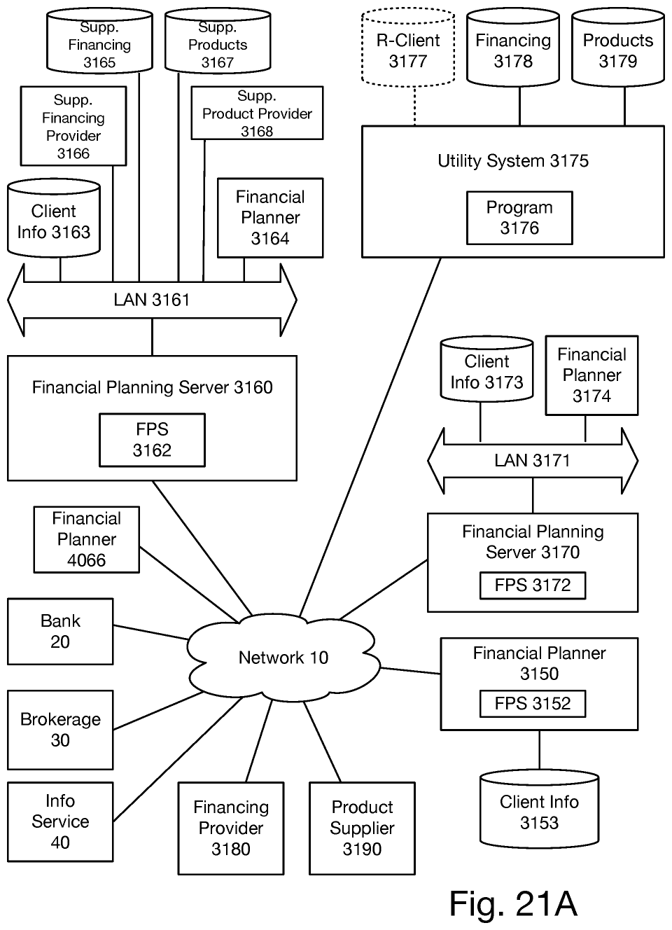

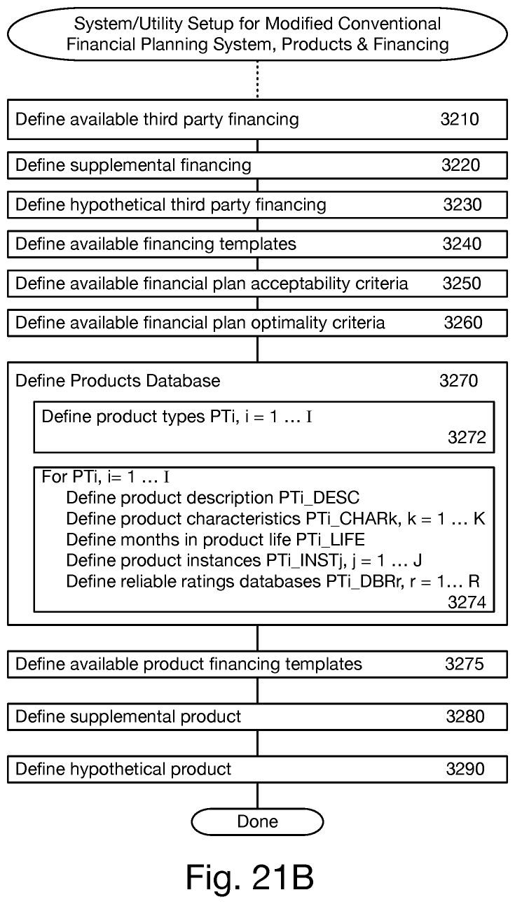

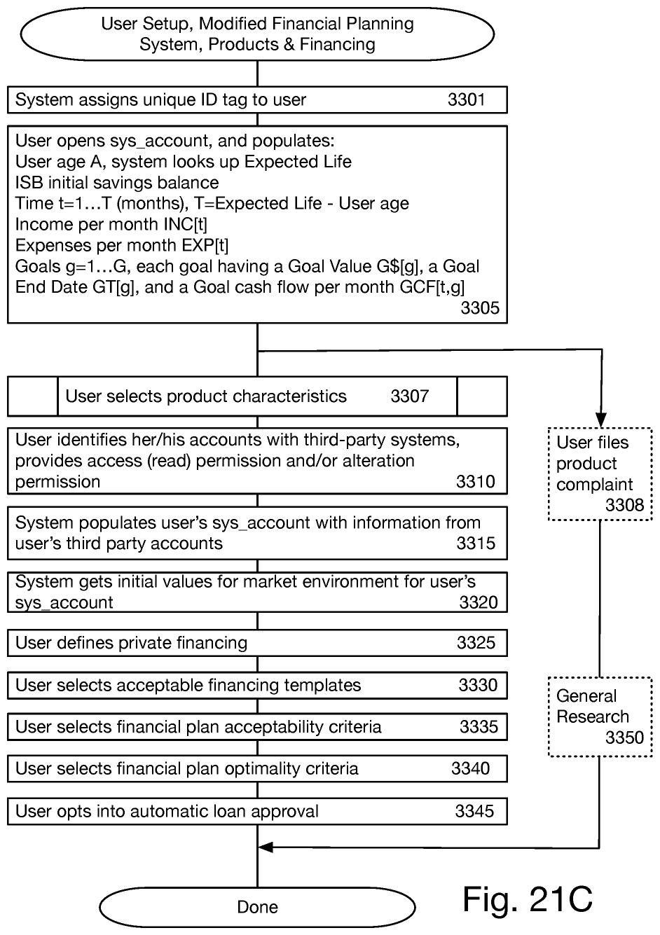

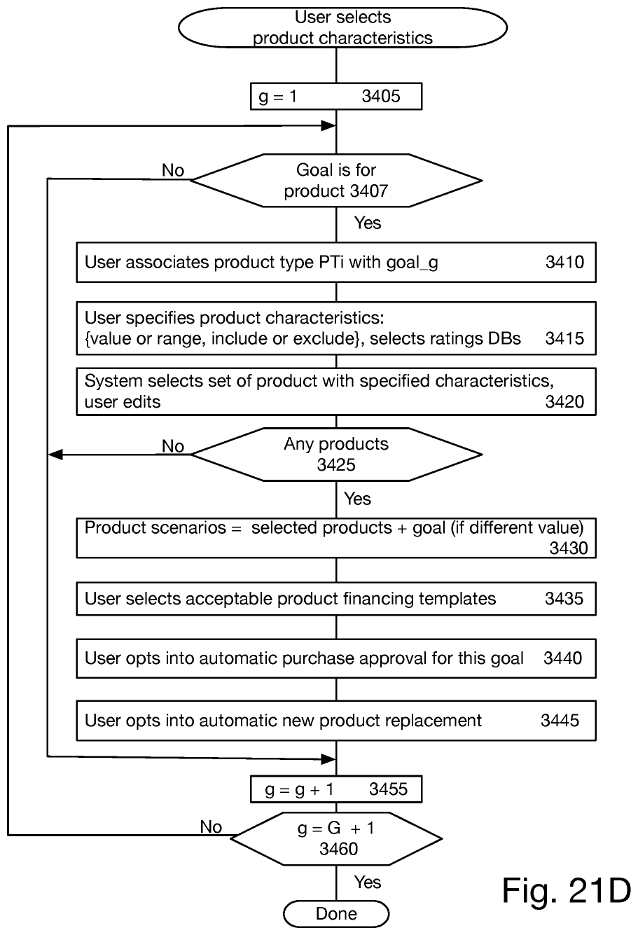

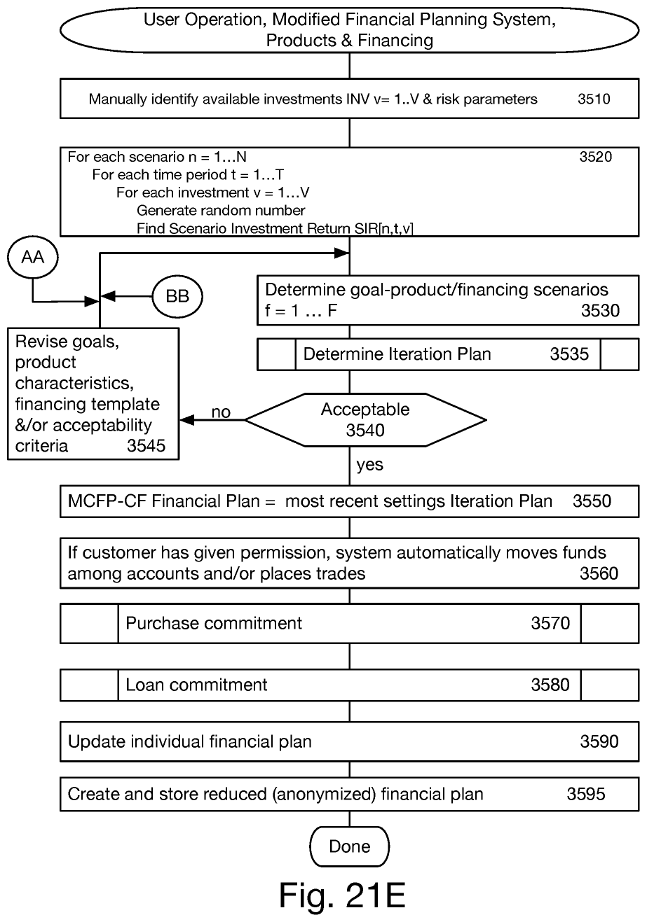

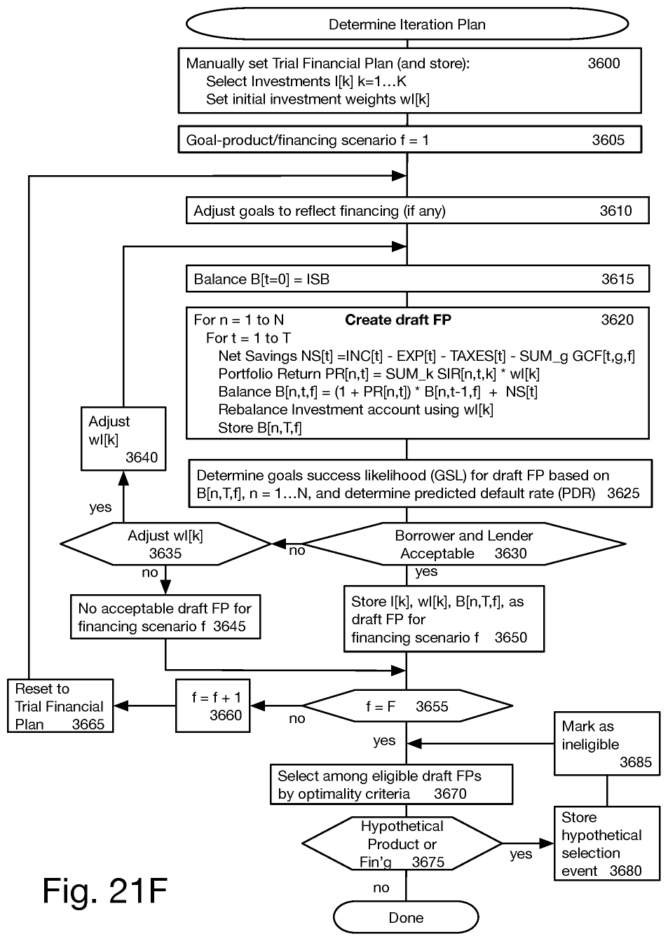

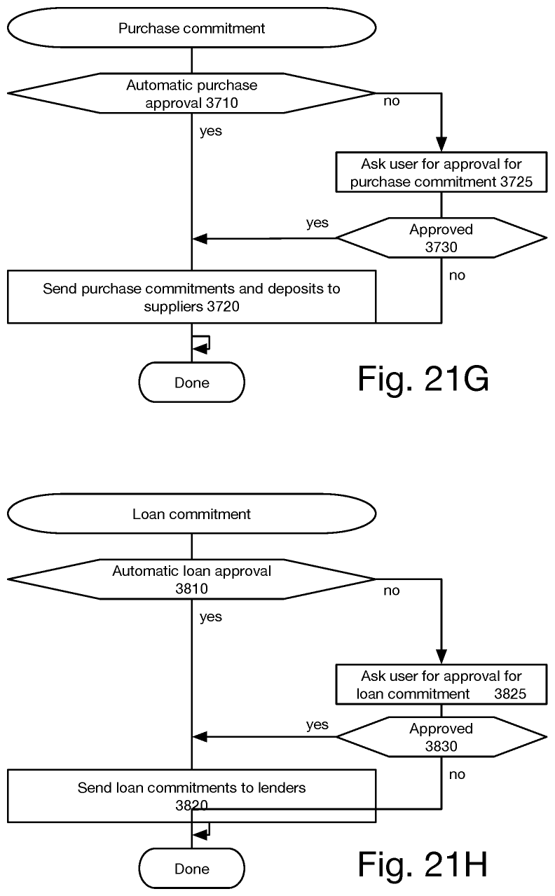

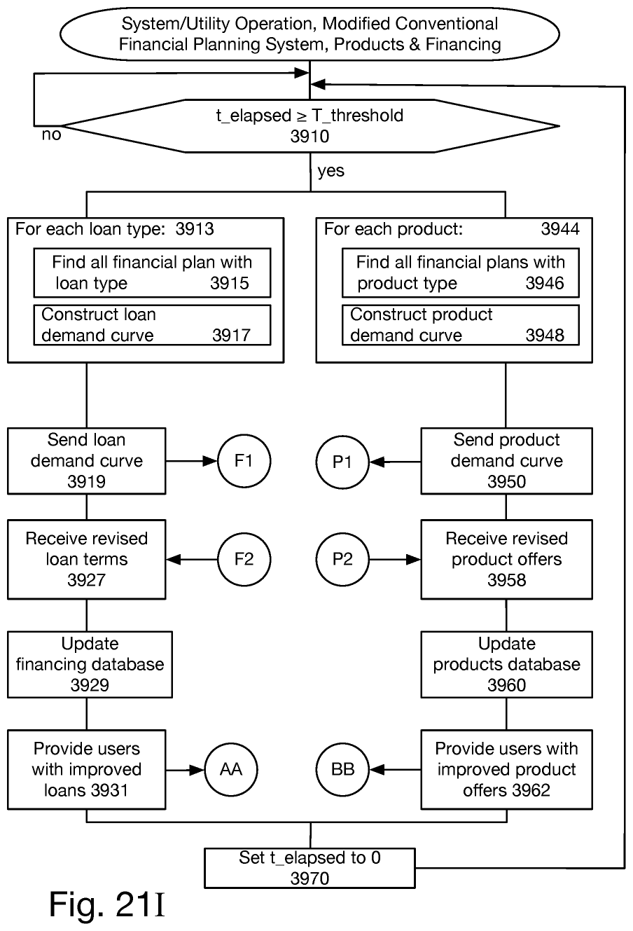

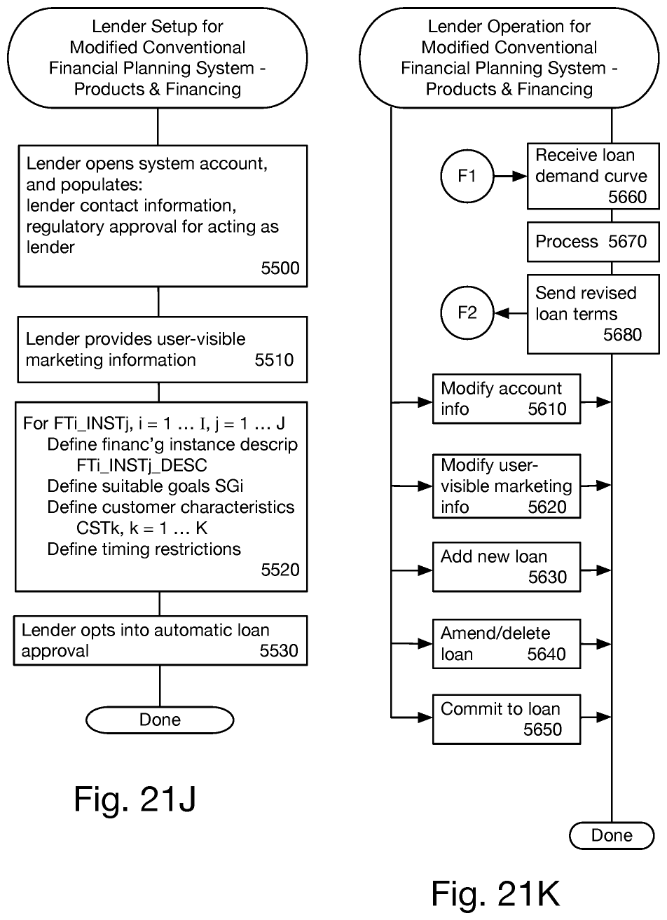

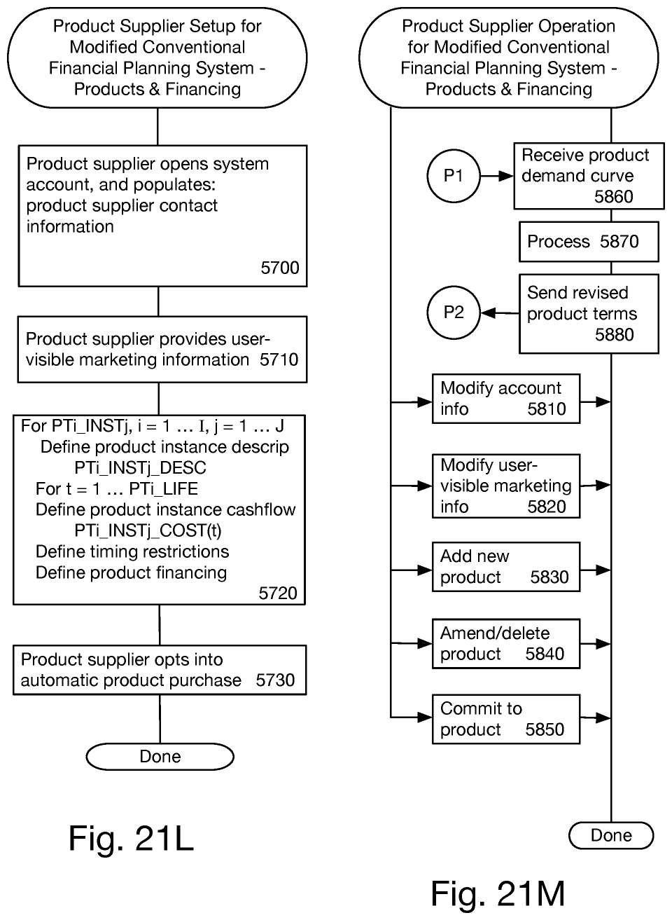

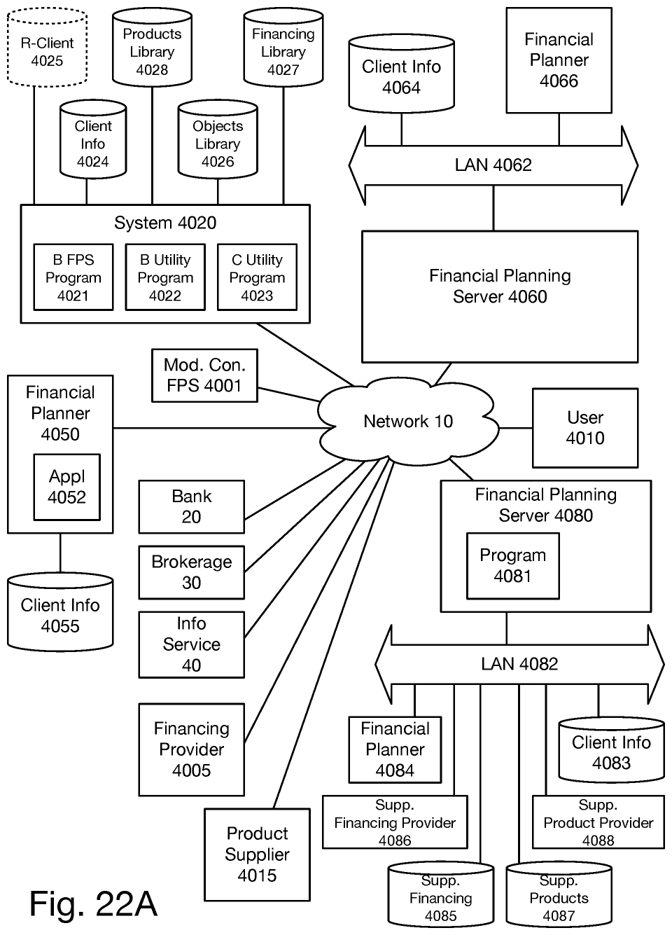

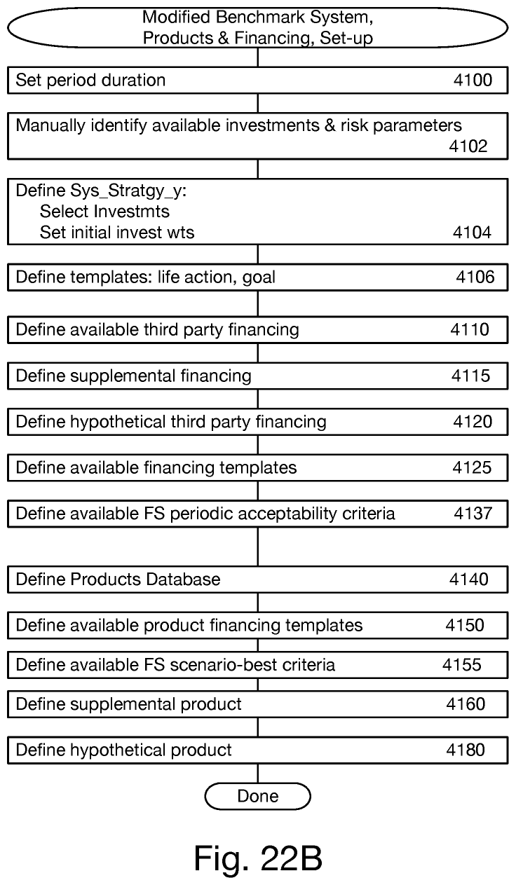

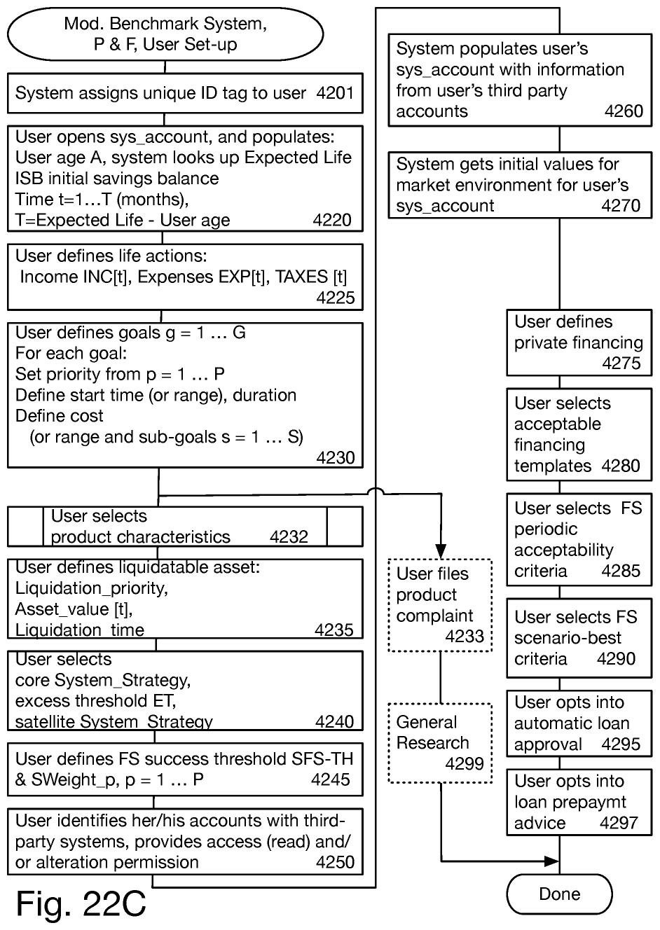

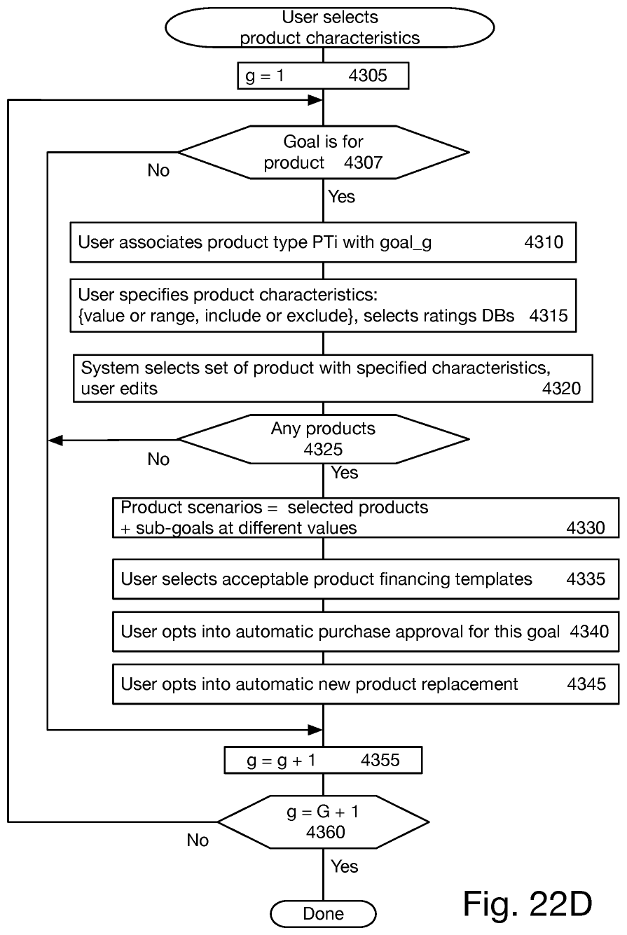

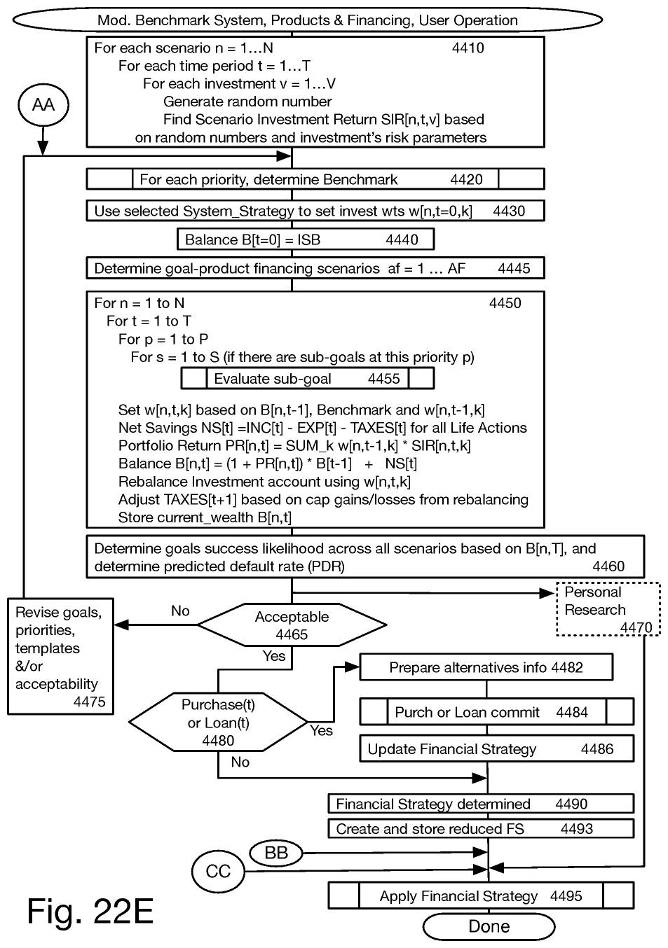

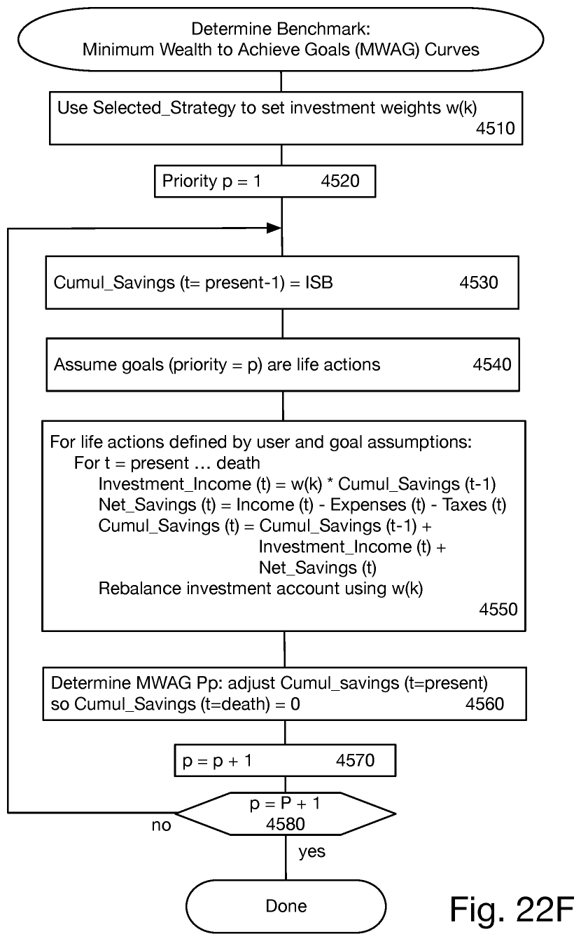

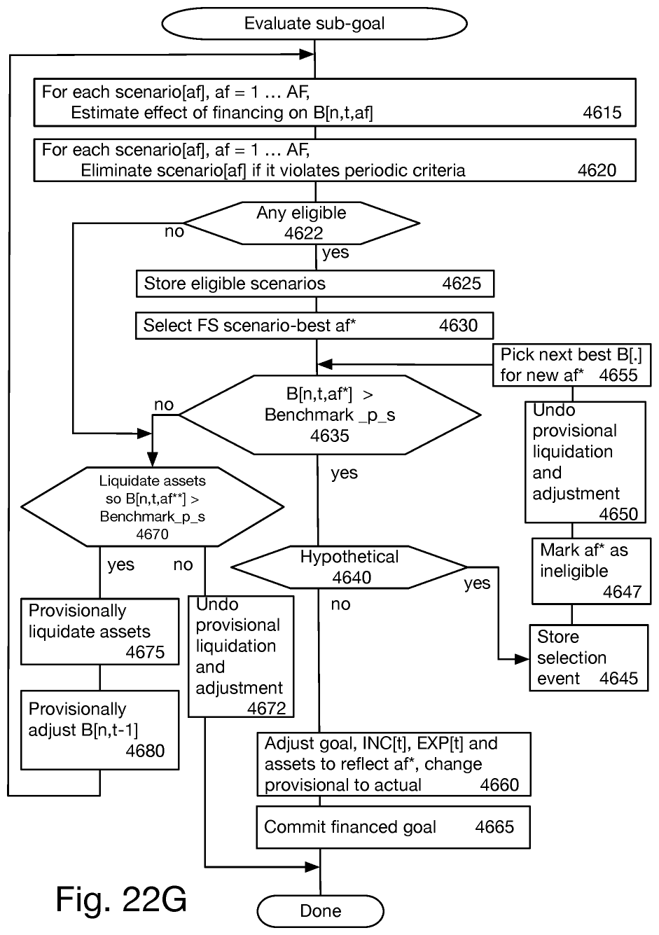

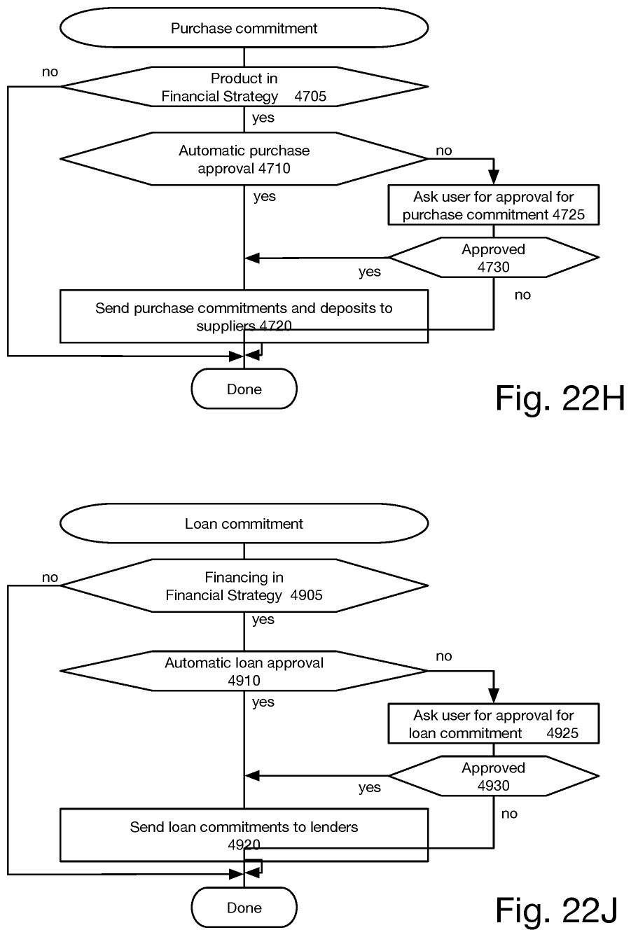

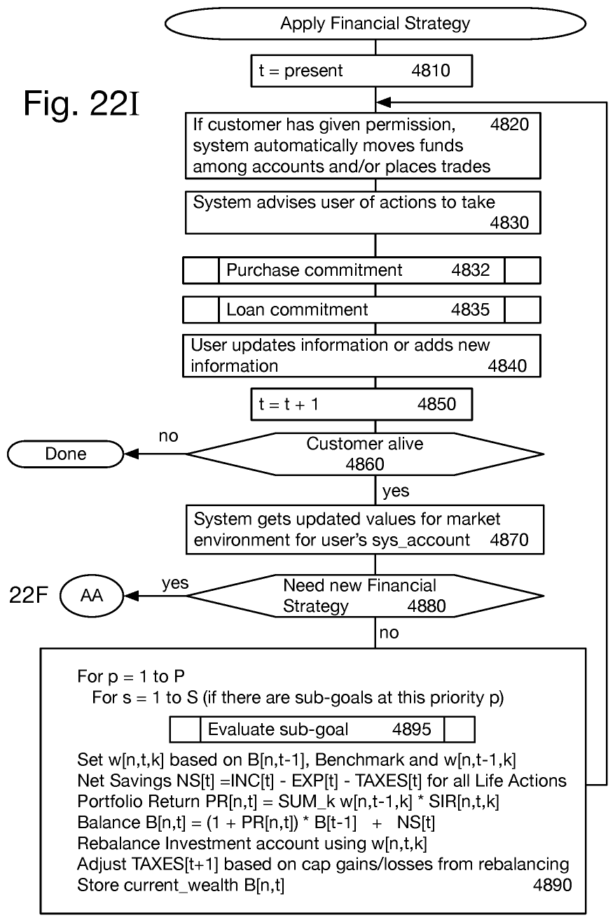

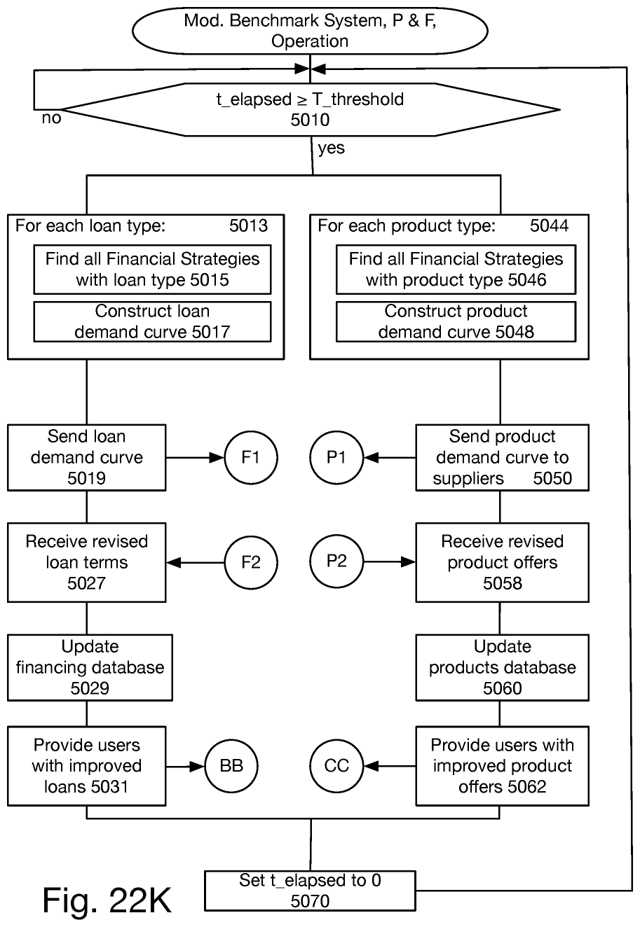

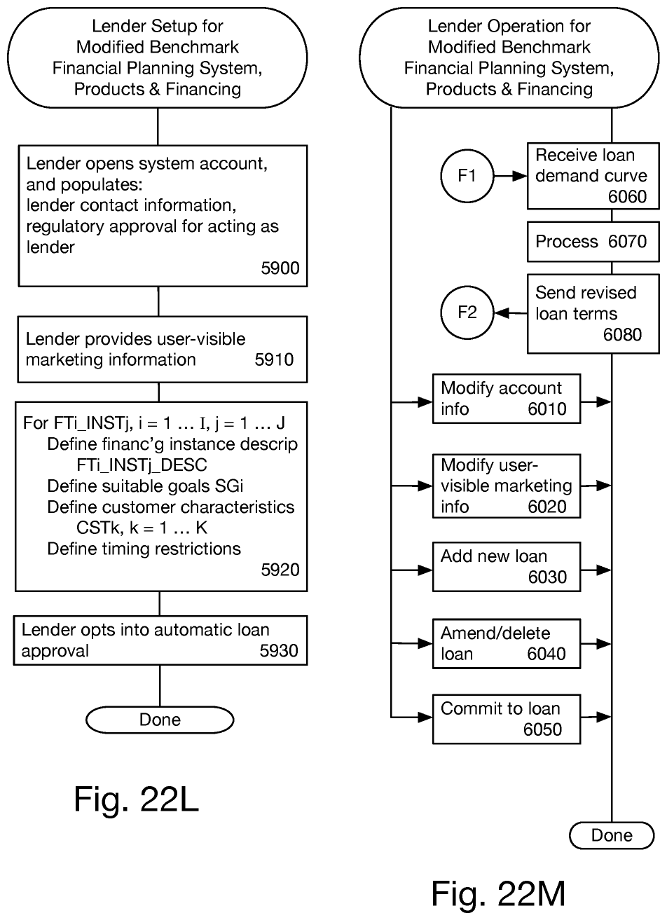

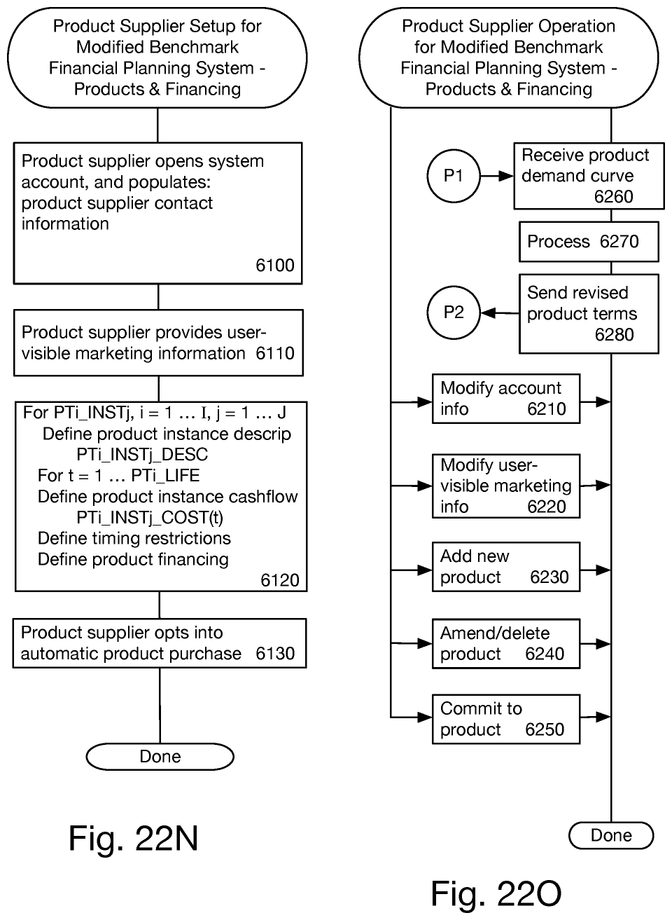

As used herein, “FIG. 16” collectively references FIGS. 16A-16I; “FIG. 17” collectively references FIGS. 17A-17K; “FIG. 21” collectively references FIGS. 21A-21M; and “FIG. 22” collectively references FIGS. 22A-22O.

The first column of Table 1.5 shows figures relevant to a conventional cash-flow based FPS.

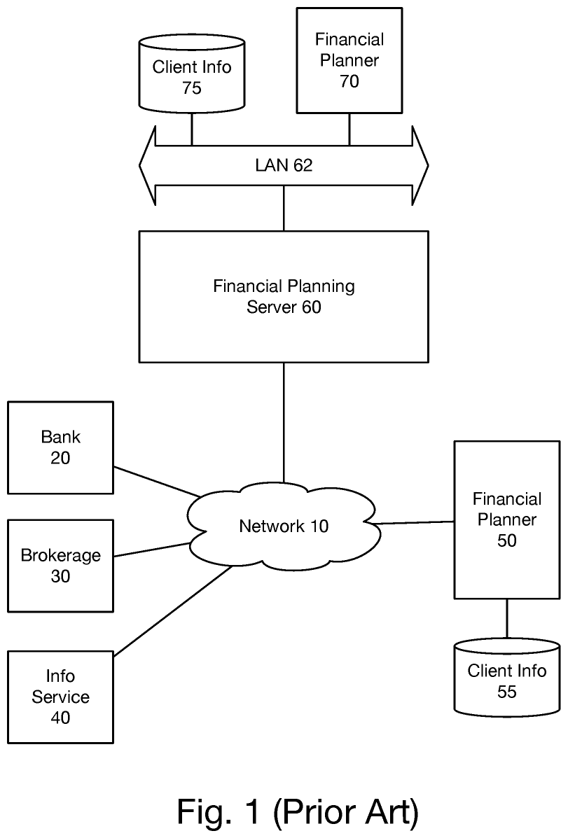

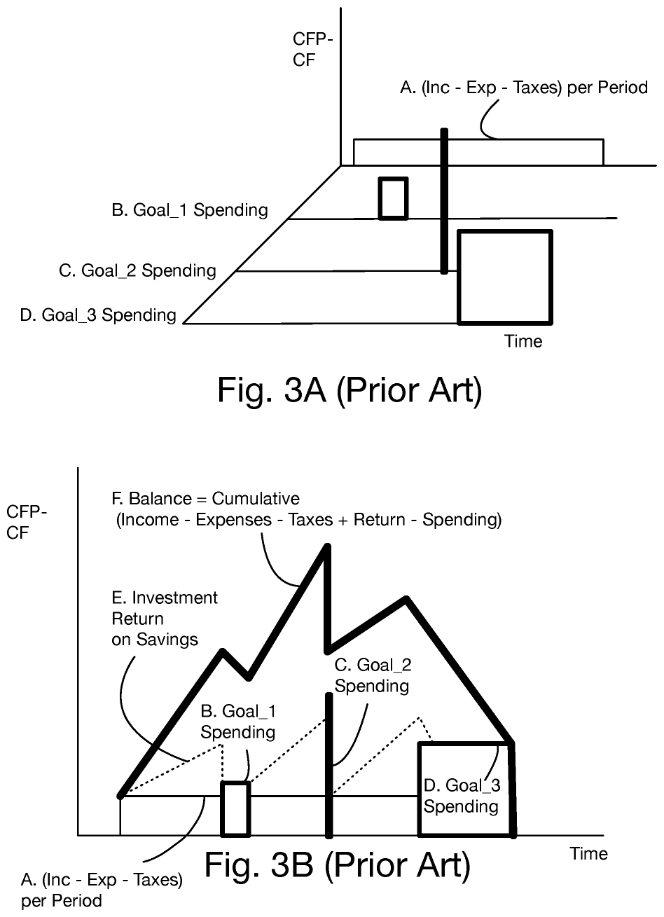

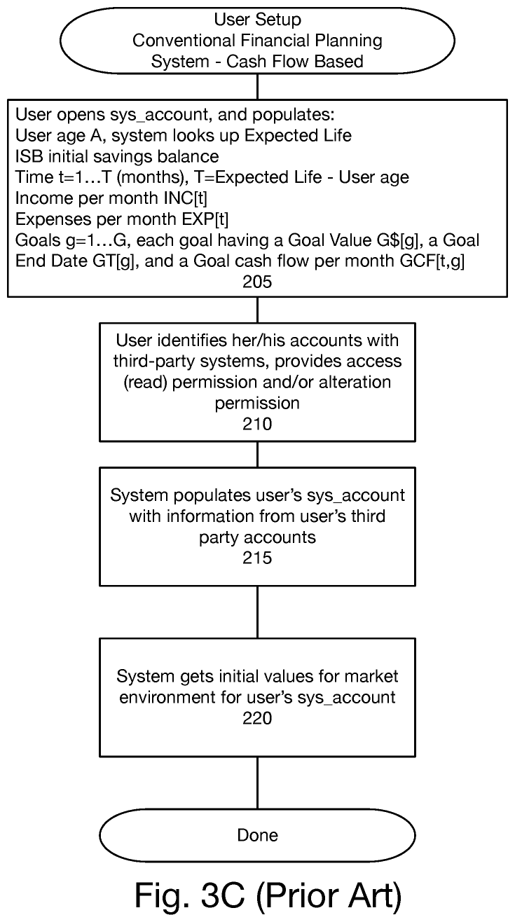

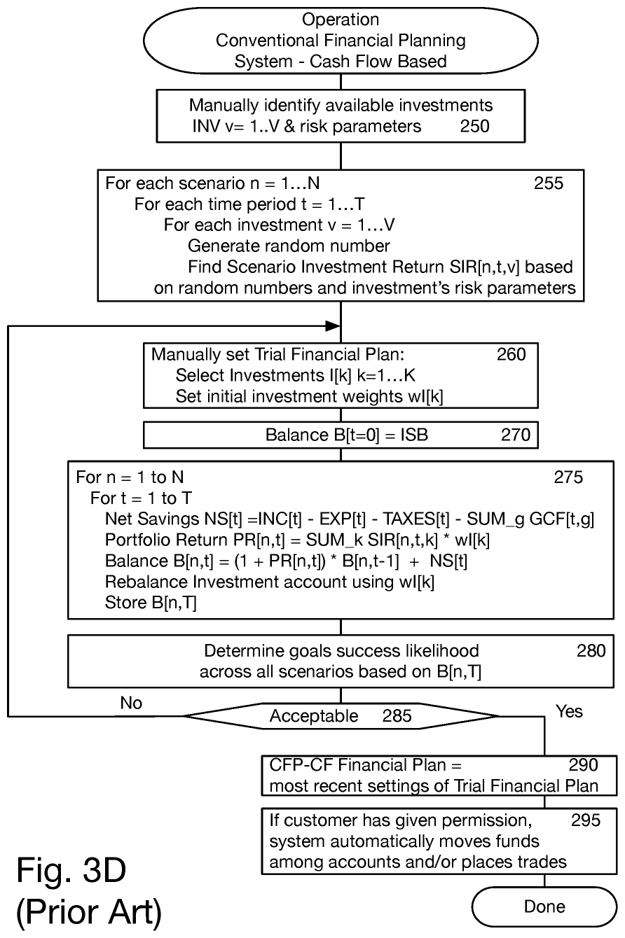

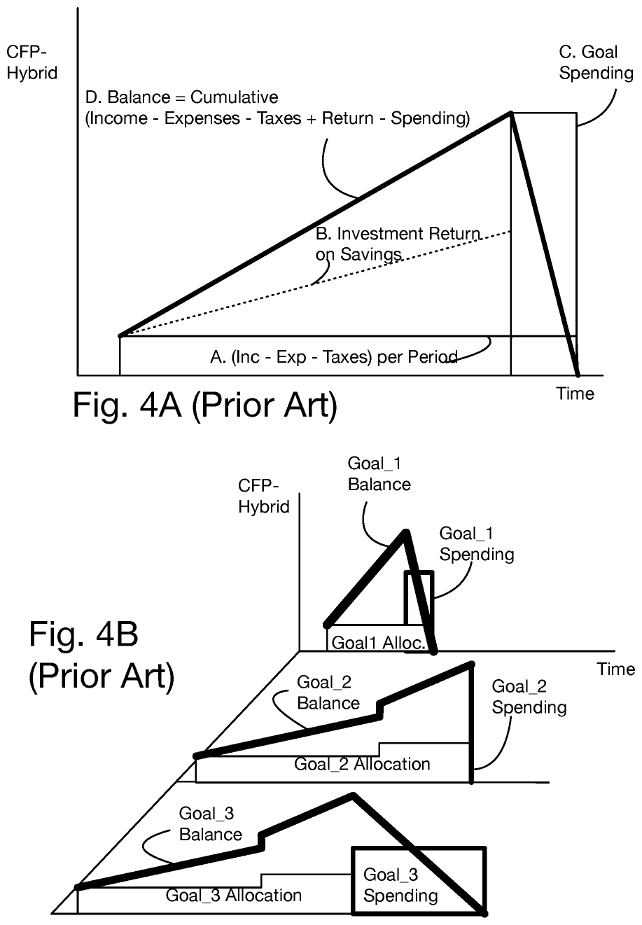

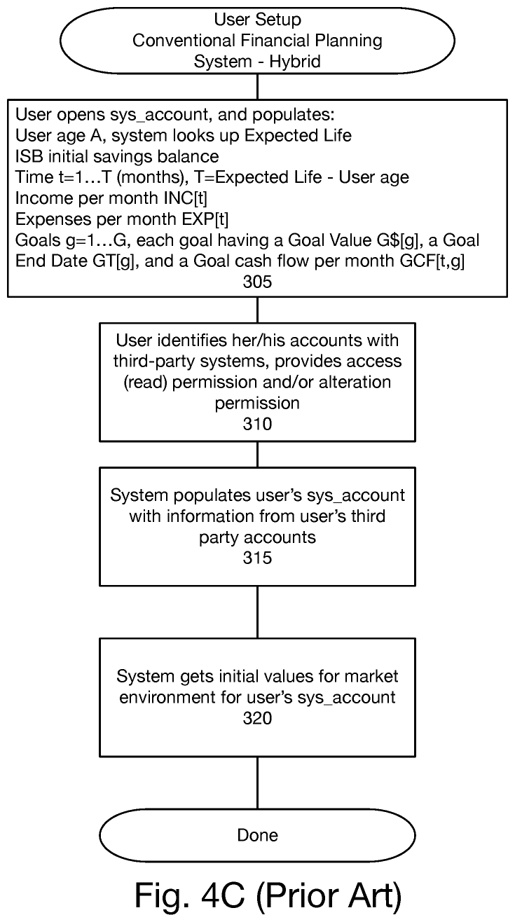

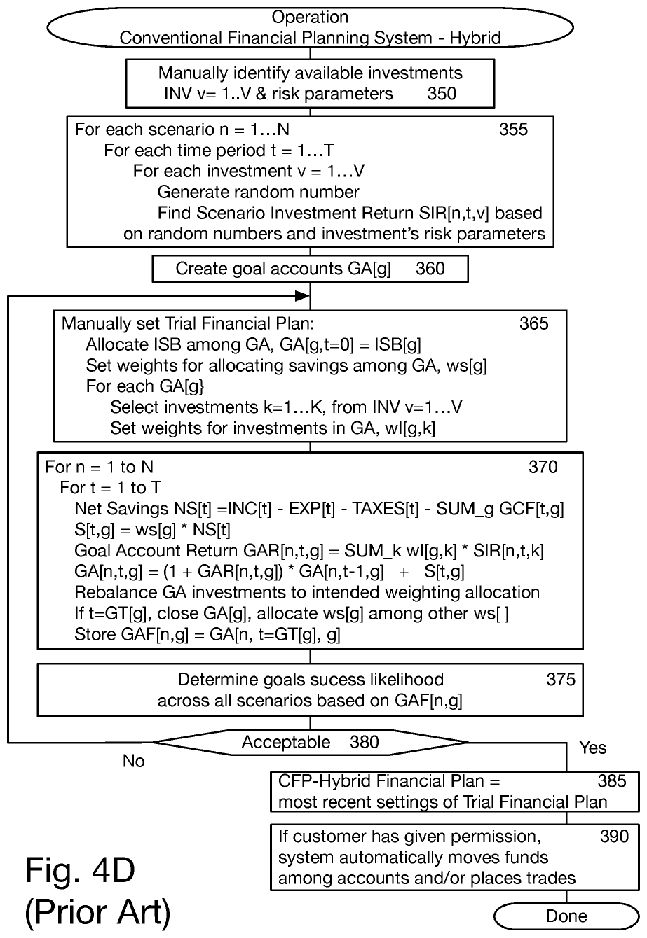

A financial plan (FP) is created by a conventional financial planning system (CFPS), see FIGS. 1 and 3A-3D.

A FP is a comprehensive statement of an individual's goals, particularly long-term in goals, and a detailed savings and investing election for achieving those goals. The FP is highly individualized to reflect the individual's personal and family situation, risk tolerance, and future expectations.

The outcome of a FP is a specification of how the individual's savings should be invested to achieve the individual's goals. Goal actions occur when specified by the user, as part of the goals. The conventional FP should be recomputed (updated) to reflect changes in the individual's situation and changes in the investment market.

The second column shows figures relevant to a modified conventional FPS with automatically selected financing. The changes include a system setup flowchart (FIG. 16B), automatic selection of financing (FIG. 16E), automatic loan commitment (FIG. 16F), and creating financing demand curves (FIG. 16G).

The embodiment of FIG. 16 is a modified conventional financial planning system (MCFPS) that supports a FP with automatically selected financing for the user's goals.

A utility system receives and stores financing offers from financing providers, and makes these offers available to the MCFPS.

Each MCFPS stores user-defined criteria for what makes a FP acceptable to the user, and user-selected financing templates. A conventional FPS does not use acceptability criteria because the user is constantly manually generating new FPs, and deciding when a FP is acceptable.

Based on the providers' financing offers and the user's financing templates, the MCFPS generates financing scenarios, and creates a FP for each financing scenario (“iteration plan”). The MCFPS chooses the iteration plan that best meets the user's acceptability criteria as the user's FP.

On behalf of the user, if authorized by the user, the MCFPS commits to the financing in the FP.

The MCFPS sends an anonymized and compacted (“reduced”) version of the FP to the utility system. As shown in the third use case at the end of this specification, a reduced FP is a subset of a user's FP. Periodically, the utility system reviews the reduced FPs, creates loan demand curves for different financing types, and sends the loan demand curves to the financing providers, to encourage them to provide financing offers suited to the goals of the FP users. The third column shows figures relevant to a modified conventional FPS with automatically selected products and financing. The changes include selecting product characteristics during user setup (FIG. 21D), automatic product selection (FIG. 21F), automatic product purchase commitment (FIG. 21G), and creating product demand curves (FIG. 21I).

The embodiment of FIG. 21 is a modified conventional financial planning system (MCFPS) that supports a FP with automatically selected products that meet the user's goals.

A utility system receives and stores product offers from product suppliers, and makes these offers available to the MCFPS.

Each MCFPS stores user-defined criteria for what makes a FP acceptable to the user, and user-selected product characteristics.

Based on the suppliers' product offers and the user's product characteristics, the MCFPS generates product scenarios, and creates a FP for each product scenario (“iteration plan”). The MCFPS chooses the iteration plan that best meets the user's acceptability criteria as the user's FP.

On behalf of the user, the MCFPS commits to purchase the product in the FP. The MCFPS sends an anonymized and compacted (“reduced”) version of the FP to the utility system. Periodically, the utility system reviews the reduced FPs, creates product demand curves for different product types, and sends the product demand curves to the product suppliers, to encourage them to provide product offers suited to the goals of the FP users.

The fourth column shows figures relevant to a benchmark FPS.

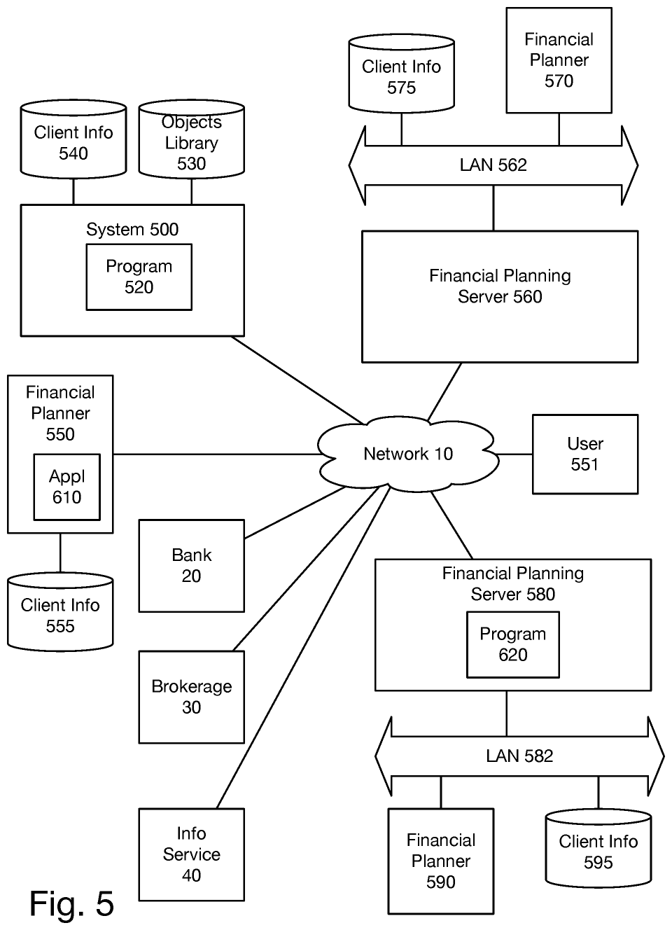

A financial strategy (FS) is created by a benchmark financial planning system (BFPS), see FIGS. 5-12. As a matter of terminology, a FP is created by a conventional FPS or a modified conventional FPS, while a FS is created by a benchmark FPS or a modified benchmark FPS.

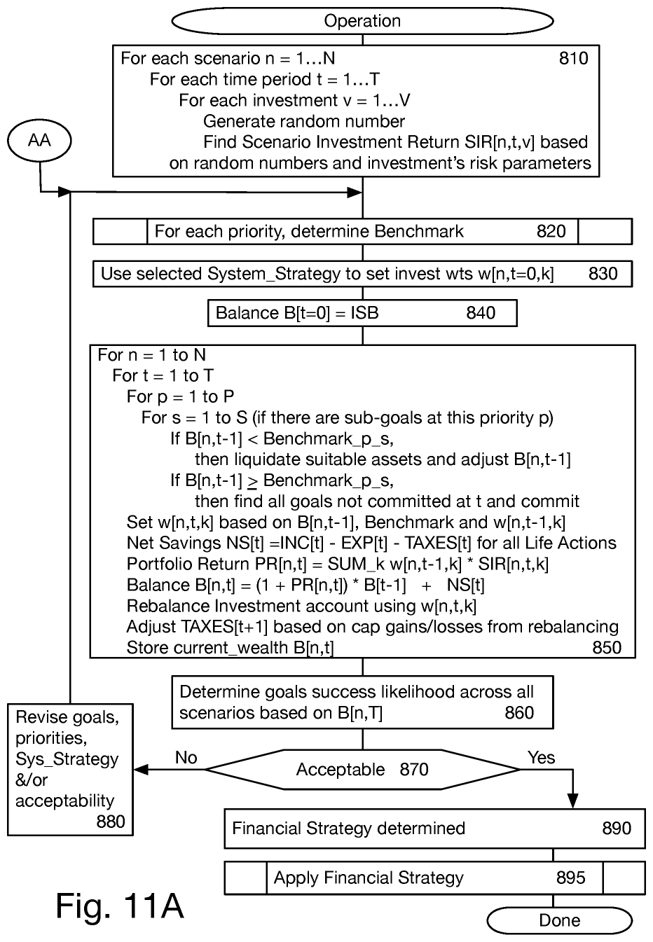

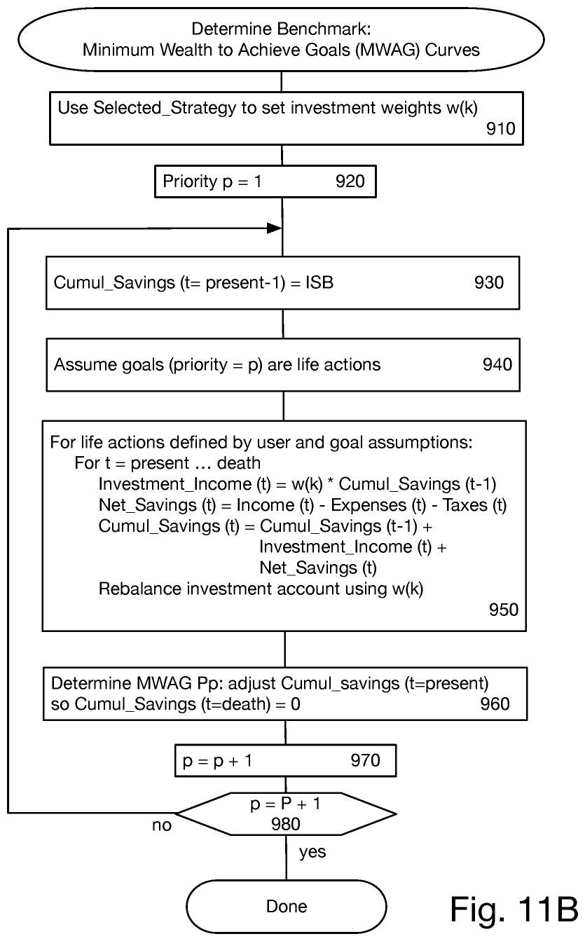

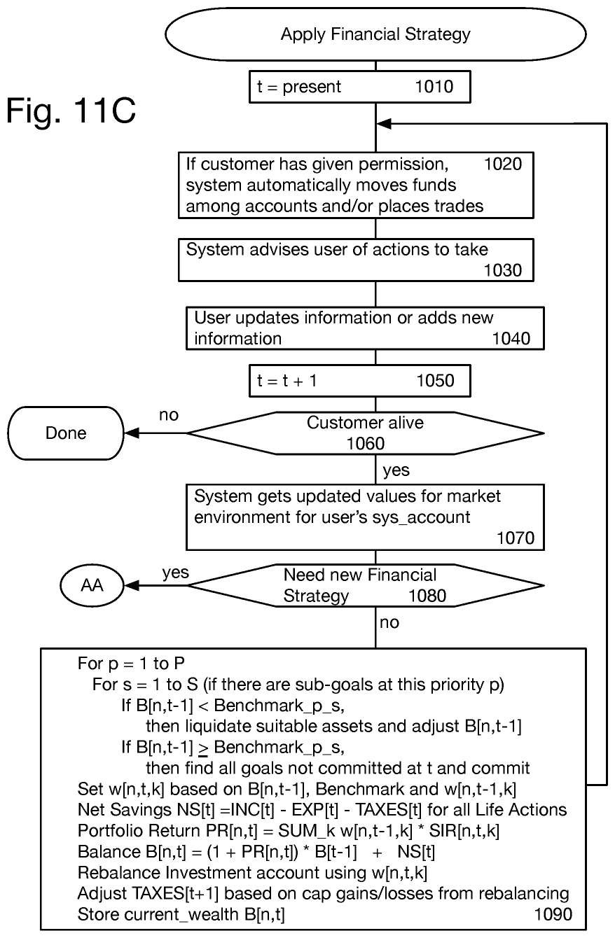

The FS can be thought of as a self-updating FP plus periodic advice, where the self-updates occur due to market changes and user actions: updating information or adding new information, see FIG. 11C step 1040. In contrast, a FP is not self-updating and is not associated with periodic advice.

At explained at FIG. 11A step 890, the FS comprises the parameters leading to goals success likelihood deemed acceptable at step 870. These parameters include the initial savings balance specified at step 720, the life actions specified at step 725, the goals and priority levels specified at step 730, the liquidatable assets specified at step 735, the System Strategies specified at step 740, the acceptability threshold specified at step 745, and the benchmark curves determined at step 820.

The outcome of a FS is, for each time interval, investment actions and goal actions to take, based on the individual's savings and goals, the individual's previously enacted (or simulated, if in the context of future simulations) investments and goal actions, and changes in the market environment in the previous time interval (see FIG. 11C steps 1020 and 1030).

The FS detects when it needs to be updated to reflect changes in the individual's situation and changes in the investment market, and automatically updates itself (see FIG. 11C step 1080).

The fifth column shows figures relevant to a benchmark FPS with automatically selected financing. The changes include automatic selection of financing (FIG. 17F), automatic loan commitment (FIG. 17H), and creating financing demand curves (FIG. 17I).

The embodiment of FIG. 17 is a modified benchmark financial planning system (MBFPS) that supports a FS with automatically selected financing for the user's goals.

A utility program receives and stores financing offers from financing providers, and makes these offers available to the MBFPS.

Each MBFPS stores user-selected financing templates. The MBFPS generates a benchmark curve to indicate when an action advised by a FS is acceptably meeting the user's goals.

Based on the providers' financing offers and the user's financing templates, the MBFPS generates financing scenarios, and estimates the user's wealth for each financing scenario. The MBFPS chooses the financing scenario that meets the benchmark curve and maximizes the user's wealth.

On behalf of the user, the MBFPS commits to the financing in the FP.

The MBFPS sends an anonymized and compacted (“reduced”) version of the FS to the utility program. Periodically, the utility program reviews the reduced FSs, creates loan demand curves for different financing types, and sends the loan demand curves to the financing providers, to encourage them to provide financing offers suited to the goals of the FS users.

The sixth column shows figures relevant to a benchmark FPS with automatically selected products and financing. The changes include selecting product characteristics during user setup (FIG. 22D), automatic product selection (FIG. 22G), automatic product purchase commitment (FIG. 22H), and creating product demand curves (FIG. 22K).

The embodiment of FIG. 22 is a modified benchmark financial planning system (MBFPS) that supports a FS with automatically selected products that meet the user's goals.

A utility program receives and stores product offers from product suppliers, and makes these offers available to the MBFPS.

Each MBFPS stores user-selected product characteristics. The MBFPS generates a benchmark curve to indicate when an action advised by a FS is acceptably meeting the user's goals.

Based on the suppliers' product offers and the user's product characteristics, the MBFPS generates product scenarios, and estimates the user's wealth for each product scenario. The MBFPS chooses the product scenario that meets the benchmark curve and maximizes the user's wealth.

On behalf of the user, the MBFPS commits to purchase the product in the FP. The MBFPS sends an anonymized and compacted (“reduced”) version of the FP to the utility program. Periodically, the utility program reviews the reduced FPs, creates product demand curves for different product types, and sends the product demand curves to the product suppliers, to encourage them to provide product offers suited to the goals of the FS users.

Note that during user setup, there is no selecting of financing characteristics, because it is assumed that the lowest interest rate available for the borrower's characteristics, and minimizing the interest paid are the desired characteristics. However, the invention is not limited to this choice of financing characteristics, and other financing characteristics may be desirable in other embodiments, such as establishing reliable repayment to create a good credit history so that future loans may be available at lower rates.

### Benchmark Financial Planning System

As used herein and in the claims, a “life action” is an event affecting the user's financial plan; a life action may have a one-time effect or a periodic effect or a combination thereof. Life actions represent the reality of a user's financial life. Examples of life actions include: a salary from a job, an expected inheritance in the future, rent payments to the user's landlord, rental income from the user's properties, and so on.

As used herein and in the claims, a “goal” is an uncommitted life action. Goals represent what the user wants. When a user commits to a goal in her financial plan, the goal becomes a life action. A goal has a cost or range of costs, and has a desired timeframe expressed as a particular start date and a particular duration, or as a range of start dates and a particular duration. Examples of goals include retirement, tuition for the user's child, home purchase, charitable gift or endowment, and so on. A “legacy goal” is a one-time cost that occurs at the user's death, such as leaving an inheritance.

As used herein and in the claims, a “life object” is either a “life action” or a “goal”.

One problem with prior art financial planning systems is that the system tries to fund all goals, which often leads to all goals being unfunded.

An advantage of the present invention is that the financial planning system is able to choose which goals to fund. This is a huge improvement, as it leads to outcomes having at least some successfully funded goals, instead of all goals being unfunded. This advantage ensues from the technique of having a user specify all of his or her goals, with associated priority. Initially, the system regards all goals as “uncommitted”. As the system decides that a goal is affordable, the system changes that goal to “committed”.

A goal is modelled as an initial cost, optionally followed by periodic recurring costs, possibly ending at a particular date. Each goal has a user-specified priority, with higher priority goals being funded before lower priority goals. At least one highest priority goal must be specified. The present system provides templates for modelling goals such as retirement, home purchase (initial, mortage payment, real estate tax payments, resale value or annual increase, percent used for business), vehicle purchase (vehicle cost, vehicle lifetime, initial payment, loan payments, insurance payments, operating cost payments, loan duration, annual decrease, percent used for business), vehicle lease, child's college, child's wedding, and a free-form template; the non-free-form templates automatically check “reasonableness” such as requiring that the start date precede the end date.

In some embodiments, a goal template can specify a relationship between this goal and another life object. For instance, the retirement template may identify a job life object and specify that the job ends when retirement begins.

Another problem with prior art financial planning systems is that all goals are the same priority, which forces the user to manually impose priority, such as by first running the system with highest priority goals, and only after these succeed, can the user move on to other goals. This is inefficient.

Another advantage of the present invention is that the user is able to assign priorities to goals, so the system automatically achieves goals in accordance with the user's priorities, and the user is saved from executing multiple iterations of the system to find out how many goals are achievable. In one embodiment, multiple goals can be specified at the same priority. In another embodiment, only one goal can be specified at each priority, forcing the user put his or her goals into a priority sequence. In some embodiments, temporal or value portions of a goal can be specified with different priority levels; the system then represents these as different goals.

A further problem with prior art financial planning systems is that goals can be specified only for a fixed duration, and for a particular cost. This is extremely inefficient for a user, since the user must manually figure out what is achievable for goals that can vary in time and/or cost, leading the user to multiple executions of the financial planning system.

A further advantage of the present invention is that the user is able to specify goals having a variable timeframe and/or a variable cost, so the system automatically can be lavish or frugal depending on a simulation outcome and/or a user's goal flexibility.

Yet another problem with prior art financial planning systems is that the investment allocation remains constant over the user's lifetime.

Yet another advantage of the present invention is that the investment allocation may change over a user's lifetime. In one embodiment, the desired investment allocation is defined independent of the user's life actions. In another embodiment, the desired investment allocation changes in response to one or more of the user's age, life actions and total wealth.

The present financial planning system calculates priority-level benchmarks, such as “minimum wealth to achieve goals” (MWAG), based on the goals at each priority level. The benchmarks are a family of curves, with one curve for each goal priority level. The lowest value curve corresponds to the highest priority goal spending. The second lowest value curve corresponds to the highest priority curve plus the second highest priority goal spending. The third lowest value curve corresponds to the second lowest level curve plus the third highest priority goal spending, and so on. In this embodiment, the minimum wealth to achieve goals benchmark assumes that, for a goal having a time range, the goal begins at the latest possible time; and assumes that, for a goal having a value range, the minimum value is used.

If a goal has a range of values, the range values are divided into sub-goals, with a minimum wealth to achieve goals curve for each sub-goal.

For each Monte Carlo scenario, corresponding to one possible future scenario of investment returns, the system chooses which goals to fund based on comparison of the current wealth with the minimum wealth to achieve goals: lower-priority goals are funded only when aggregate wealth is sufficient to fund all higher priority goals. Then, the likelihood of success for each goal is summed across all scenarios.

If these scenarios result in an acceptable plan, and if the user has given permission, the financial planning system then acts on this plan, such as by moving funds among accounts or placing securities trades.

If these scenarios do not result in an acceptable plan, then the user must change his or her goals, or income expectations. Advantageously, the user does not consume time running scenarios with re-ordered existing goals, as the system has already done the best that can be done with the existing goals.

The present system can be used for at least three purposes: asset management, money management, and consumption advice.

Asset management is useful for wealthy people, who seek a better investment outcome.

Money management is useful for day-to-day financial planning, indicating which streams of expenses should be adjusted or sequenced. Particularly, as goals are completed, the optimal asset allocation can change.

Consumption advice is useful for buying and selling items having significant financial value to the user, such as a home or vehicle. The present system helps ensure that the user buys something appropriate to their wealth: not too cheap and not too expensive.

FIG. 5 shows configurations for a financial planning system according to the present invention. Five configurations of the financial planning system are depicted.

Network 10 is any suitable communication network such as the Internet. Financial planning system 500, financial planner 550, financial planning servers 560, 580, bank 20, brokerage 30, information service 40 and user 551 are each coupled to network 10 via a suitable communication channel. Generally, financial planner 550 configures the financial planning system, and then uses the financial planning system on behalf of his client or customer, or enables his client or customer to use the financial planning system directly. User 551 is a client or customer of financial planner 550 that directly uses the financial planning system, as configured by financial planner 550. As used herein, “user” means either financial planner 550 and/or user 551, as will be apparent from context.

First, a solo financial planner may execute planning software 610 on her personal computer 550 having locally stored client information 555, and may use Internet 10 to access client accounts at banks 20 or brokerages 30. The financial planner may use information service 40 to obtain, e.g., quotes for current market valuation of client investments.

Second, in a client-server configuration, a solo financial planner having client planning program 610 (instead of a full planning system) executing on her personal computer 550, with locally stored client information 555, can use financial planning server 500 executing server planning program 520. In a variation, financial planning server 500 enables the financial planner to store her client's information in client information storage 540 coupled to financial planning server 500. Instead of a personal computer, the financial planner can use a tablet computer or a smartphone or other suitable device. Typically, personal computer 550 uses a public network, such as Internet 10, to communicate with server 500.

Life objects library 530 includes goal templates and life action templates. Each template provides fields for financial modelling of that type of goal or life object, including priority, date and cash flow. Examples of life objects include job (periodic salary, periodic bonus, social security earnings), trust fund income, alimony income, expected inheritance, social security payments and life insurance.

In some embodiments, the system suggests financing options such as vehicle loans, mortgage refinancing, good times to buy or sell lower priority life objects such as a second car to achieve higher priority goals.

Third, in a software-as-a-service (SaaS) configuration otherwise similar to the client-server configuration, a solo financial planner uses personal computer 550 has an operating system and browser, but lacks special software; client data can be stored in local storage 555 or in server client storage 540. Instead of a personal computer, the financial planner can use a tablet computer or a smartphone or other suitable device.

Fourth, an employee financial planner uses personal computer 590 on the premises of their employer, which operates financial planning server 580 executing financial planning program 620. Local area network (LAN) 582 provides the physical connection from personal computer 590 to financial planning server 580. The client information is stored in storage device 595 that is connected to LAN 582. Financial planning server 580 may use the Internet to access client accounts at banks or brokerages. Instead of a personal computer, the financial planner can use a tablet computer or a smartphone or other suitable device. Financial planning program 620 operates according to a SaaS configuration; in a variation, financial planning program 620 operates according to a client-server configuration.

In a further variation, the employee financial planner is not on her employer's premises, and uses Internet 10 to communicate with financial planning server 580 executing financial planning program 620.

Fifth, an employee financial planner uses personal computer 570 on the premises of their employer, which operates financial planning server 560. Local area network (LAN) 562 provides the physical connection from personal computer 570 to financial planning server 560. The client information is stored in storage device 575 that is connected to LAN 562. Financial planning server 560 may use the Internet to access client accounts at banks or brokerages. Instead of a personal computer, the financial planner can use a tablet computer or a smartphone or other suitable device.

Financial planning server 560 is essentially a proxy, so that the employee financial planner can use financial planning program 520 executing on financial planning server 500. Financial planning program 520 operates according to a SaaS configuration; in a variation, financial planning program 520 operates according to a client-server configuration, with the client program located at financial planning server 560 or financial planner computing device 570. In a variation, financial planning server 500 enables the financial planner to store her client's information in client information storage 540 coupled to financial planning server 500.

In a further variation, the employee financial planner is not on her employer's premises, and uses Internet 10 to communicate with financial planning server 560.

Each of personal computer 550, 570, 590 and server 500, 560, 580 is a general purpose computer programmed according to the present invention. Connections to Internet 10 may be wireline or wireless.

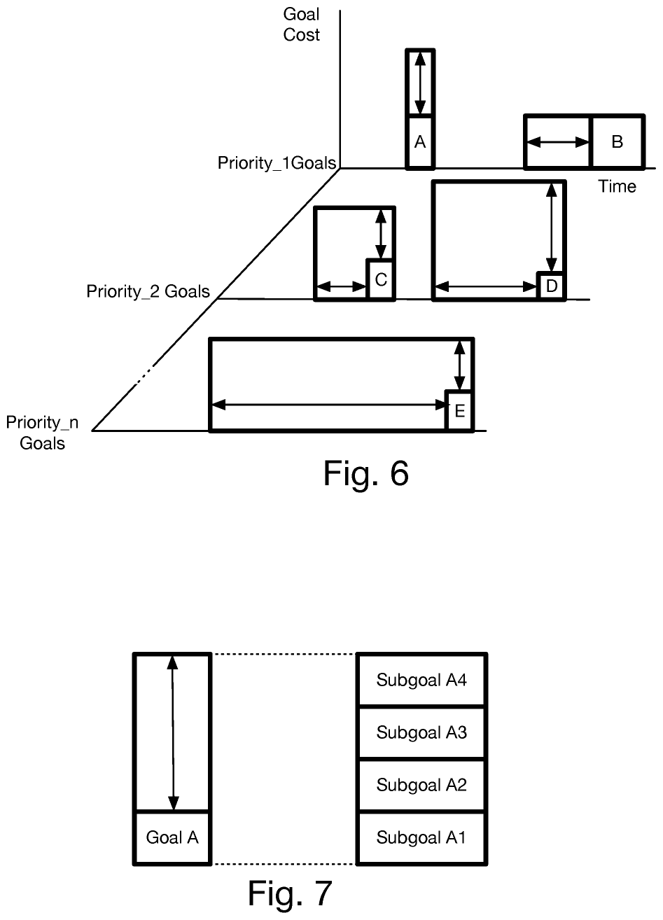

FIG. 6 is a chart showing prioritized goals with time and cost variability. Importantly, the present invention begins by automatically gathering more information from the user than prior art systems. The user can define as many goal priorities as she wishes, with at least one goal at each priority level. Priority 1 goals are the most important, and there must be at least one priority 1 goal.

Each goal has at least a start time, a duration of spending, and an amount spent. The financial planning system has a monthly granulation, that is, the Monte Carlo simulations are performed on a month-by-month basis, so the amount spent per goal can be specified per month of the duration. However, typically the user is interested in a lifetime plan, so the goal spending is specified per year. If the spending needs to change over the duration of the goal, the goal should be defined as two goals at the same priority level, preferably with no other goals at this priority level.

Additionally, the start time of a goal can be specified as a range, and/or the cost of a goal can be specified as a range.

FIG. 6 shows five exemplary goals.

At Priority 1, Goal A, such as college tuition for a child, has a duration of a few years, and a cost specified as a range, corresponding to (a) uncertainty as to future tuition cost and (b) uncertainty as to what percent of tuition that the parent will pay.

Also at Priority 1, Goal B, such as retirement, shows flexibility in start date, with a fixed annual cost.

At Priority 2, Goal C, such as a home downpayment, shows flexibility in start date and in cost, corresponding to the user's desire to own a home but not being picky about when or its type.

Also at Priority 2, Goal D, such as a charitable gift, shows flexibility in start date and in cost, corresponding to the user's desire to gift something appropriate for her future circumstances.

Goals at priorities 3 to (n−1) are not shown.

At Priority (n), Goal E, such as a boat, shows flexibility in start date and in cost. By specifying this as the lowest priority goal, the user indicates that she wants this goal only if she becomes unexpectedly wealthy.

Time variability in a goal will now be discussed.

When a goal has a time range specified for its start date, the benchmark calculation (such as a minimum wealth to achieve goals calculation) assumes that the latest time in the range is the start date of the goal. For each Monte Carlo simulation, time variable goal funding can occur according to different techniques. In one technique, as soon as the user's wealth exceeds the minimum wealth to achieve goals for that goal, it will be funded. In another technique, the latest start date of the goal is always used. A further technique, discussed below, may be used if the goal also has value variability.

Value variability in a goal will now be discussed.

FIG. 7 shows a goal with value variability split into discrete sub-goals. In one embodiment, the user specifies how many sub-goals should be associated with the goal, and the financial planning system evenly divides the range over the number of sub-goals. In another embodiment, the user specifies how many sub-goals and the value of each sub-goal. In a further embodiment, the financial planning system automatically divides each range into a predetermined number of sub-goals, such as three. Other techniques are used in other embodiments.

For each Monte Carlo simulation, variable value goal funding can occur according to different techniques. In one technique, as soon as the user's wealth exceeds the minimum wealth to achieve goals for the lowest value sub-goal, it will be funded. If the goal also has time variability, the following technique may be used: at the soonest time that the least value sub-goal can be funded, the financial planning system estimates the benefit of waiting until the latest time of funding, and if the expected benefit exceeds a predetermined threshold then the financial planning system waits until the earlier of (a) when the highest value sub-goal can be funded, and (b) the latest time of funding, to decide at what time and level to fund this goal.

Creation of benchmark curves will now be discussed.

As used herein and in the claims, a benchmark is a value at a particular time that indicates whether an objective is or is not achievable, with an objective being either one goal or a set of goals having the same priority. The present financial planning system uses benchmarks to choose which user goals to fund.

In this embodiment, a “minimum wealth to achieve goals” (MWAG) technique is used to determine the benchmark curves. In other embodiments, other techniques are used to determine the benchmarks.

A second benchmark technique is to assume the most conservative returns on all investments, then project all cash flows, and via trial and error, adjust the initial starting wealth to achieve the goals at the highest priority level. This process is repeated with goals at the highest and next-highest priority level to achieve the initial starting wealth for the next benchmark. This is repeated for all priority levels to achieve all benchmark curves.

A third benchmark technique is to re-run the entire set of Monte Carlo simulations so that the user's wealth at the time of death is zero.

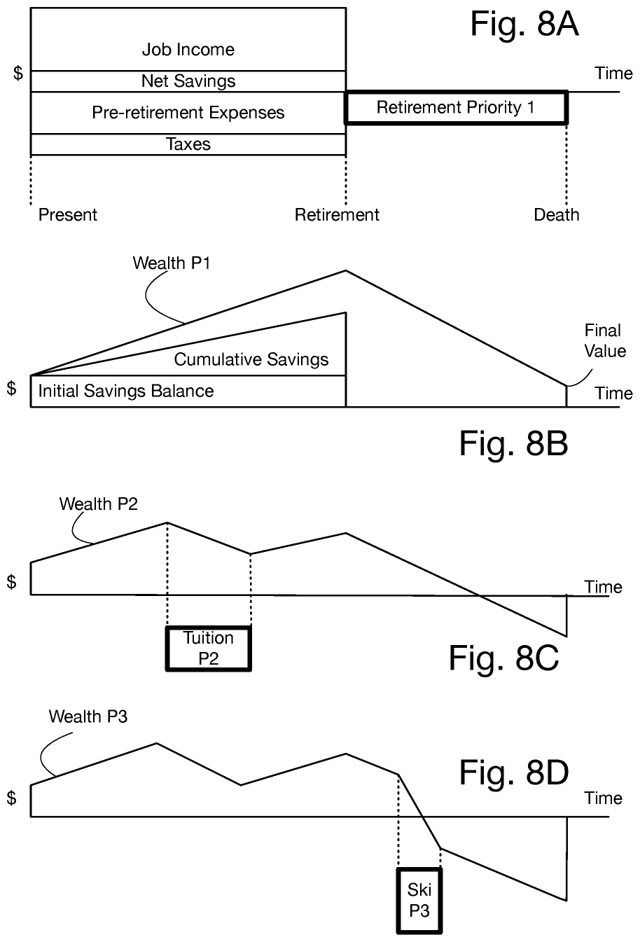

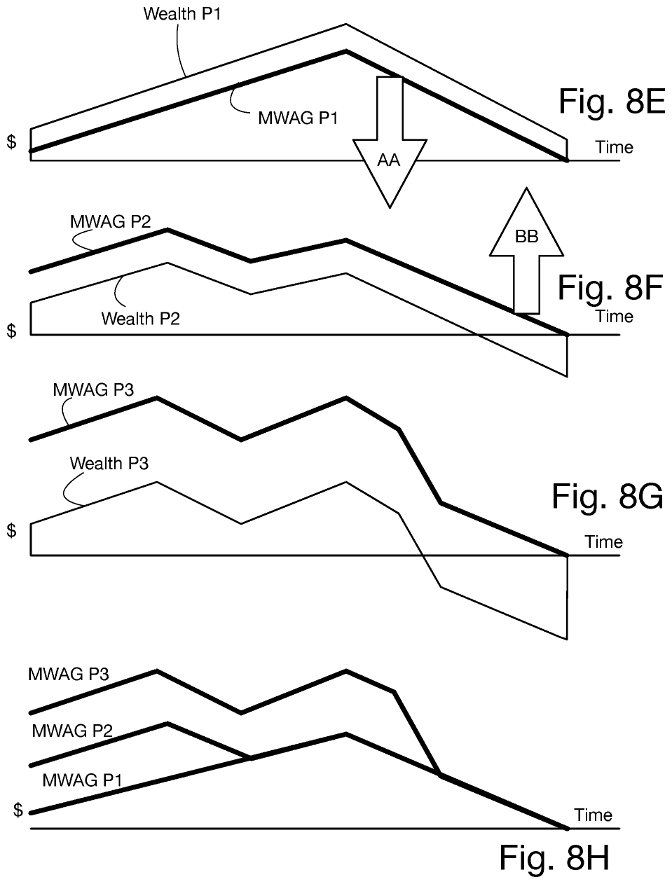

FIG. 8A-8H are graphs showing generation of MWAG curves. FIGS. 8A-8D represent the user's projected hypothetical financial activity, while FIGS. 8E-8H show how MWAG curves are obtained from the hypothetical financial activity.

Assume that the user has one priority 1 goal: retirement; one priority 2 goal: tuition for the user's only child; and one priority 3 goal: multi-country ski trip. During retirement, the user's only expenses are retirement expenses. Assume further that the user has income only from a job and investments.

FIG. 8A shows the user's life actions, and priority 1 goal of retirement, summed to yield total income, total expenses, total taxes and total savings over the user's financial life, beginning at the present and ending at the user's death:

Savings[t,p]=Income[t,p]−Expenses[t,p]−Taxes[t,p]

where t=Present . . . Death

p=priority level (equation 11)

FIG. 8B shows the user's initial savings balance (ISB), the user's cumulative savings, the user's investment income and the user's hypothetical Wealth over the user's financial life:

Cumulative_Savings[t,p]=Savings[t,p]=Σ_{t=Present}^{Death}Saving[t,p] (equation 12)

Invest_Income[t,p]=Invest_return*(ISB+Cumulative_Savings[t−1,p]) (equation 13)

Wealth[t,p]=ISB+Cumulative_Savings[t,p]+Invest_Income[t,p] (equation 14)

The hypothetical wealth includes investment income that assumes a fixed rate of return for the investments for the planning period, as in conventional financial planning systems. This fixed rate of return may represent the sum of the rates of return of several investments with respectively different rates of return.

In another embodiment, instead of a fixed rate of return for the investments, a set of investment rate of return Monte Carlo simulations is generated for the financial planning period, and the average simulated rate of return at each period is used for the investments.

Final Value[p] refers to the user's wealth at the time of death, Wealth[t=Death, p]. In this case, the ISB and Final Value[p=1] of the Wealth P1 are positive. However, in other cases, the ISB and/or Final Value may be negative. The ISB could be negative if the user owes money (e.g., student loans). The Final Value could be negative if the user is destitute or has her wealth in illiquid assets that are not included in Wealth as defined here.

FIG. 8C shows the effect of adding the priority 2 goals—child's college tuition—to the user's wealth incorporating priority 1 goals, yielding the user's wealth incorporating priority 1 and priority 2 goals, Wealth P2=Wealth P1+goals [p=2]. The user's wealth decreases due to spending on priority 2 goals, so that Final Value [p=2] becomes negative.

FIG. 8D shows the effect of adding the priority 3 goals—ski trip—to the user's wealth incorporating priority 1 and 2 goals, yielding the user's wealth incorporating priority 1, priority 2 and priority 3 goals, Wealth P3=Wealth P2+goals [p=3]. The user's wealth decreases due to spending on priority 3 goals, so that Final Value [p=3] becomes more negative than Final Value [p=2].

FIG. 8E shows MWAG P1 based on Wealth P1. The MWAG curve is approximately the Wealth curve slid up or down along the y-axis (value) such that the Final Value of the MWAG curve is zero. The sliding corresponds to adjusting the Initial Savings Balance, which also affects lifetime Investment Income, explaining why vertical sliding is only an approximation. Any suitable technique may be used to determine the ISB, such as the bisection method or the Newton method.

The bisection method bisects an interval, then selects a subinterval for further processing. In this example, the MWAG curve approximately results from sliding the Wealth curve down, so the bisection method begins with the interval defined by ISB of Wealth P1 and zero, and iterates, generating a “Wealth” curve at each iteration until the Final Value of the “Wealth” curve is within a predetermined threshold, such as 2% of the Final Value of Wealth P1, of zero, and then this “Wealth” curve is the MWAG P1 curve.

The Newton method finds successively better approximations based on adjusting an initial guess by subtracting a function of the initial guess divided by the first derivative of the function of the initial guess to yield a second guess, then iterating by adjusting successive guesses until the Final Value of the “Wealth” curve is within a predetermined threshold, such as 2% of the Final Value of Wealth P1, of zero, and then this “Wealth” curve is the MWAG P1 curve.

FIG. 8F shows the MWAG P2 curve based on the Wealth P2 curve. MWAG P2 is obtained from Wealth P2 in a similar manner as MWAG P1 was obtained from Wealth P1. Note that since the Final Value of Wealth P2 is negative, the Wealth P2 curve is approximately slid upwards to yield the MWAG P2 curve.

FIG. 8G shows the MWAG P3 curve based on the Wealth P2 curve. MWAG P3 is obtained from Wealth P3 in a similar manner as MWAG P1 was obtained from Wealth P1. Note that since the Final Value of Wealth P3 is negative, the Wealth P3 curve is approximately slid upwards to yield the MWAG P3 curve.

FIG. 8H shows the MWAG P1, P2, P3 curves from FIGS. 8E-8G on one graph. The initial point keeps rising, reflecting money needed for goals at successive priority levels. It will be understood that the shape of the MWAG curves is highly dependant on the user's financial activity, that is, life actions and goals.

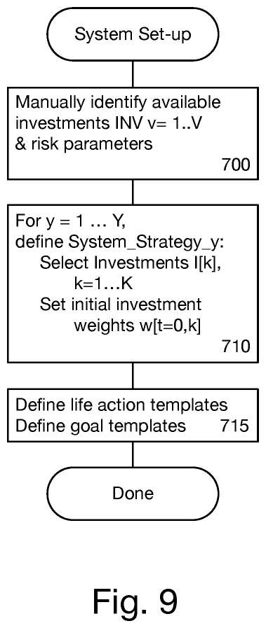

FIG. 9 is a flowchart showing system set-up in a financial planning system according to the present invention. The information created during set-up is stored in a suitable storage, such as client storages 540, 555, 575, 595 and objects library 530, shown in FIG. 5.

At step 700, the financial planner manually identifies the available investments v=1 . . . V and their associated risk parameters. This is similar to step 250 of FIG. 3D.

At step 710, the financial planner defines up to Y strategies. For each strategy y, y=1 . . . Y, the financial planner selects K investments, and sets the initial investment weights, that is, the portion of savings to be allocated to each investment. Each initial investment weight is a fraction between 0 and 1, with the total of the weights summing to 1.0. For example, if K=3, then the initial investment weights might be [0.33 0.33 0.34] for even weighting, or [0.2 0.2 0.6] for uneven weighting.

The present system enables the investment allocation to change over time. Typical strategies favor higher risk investments when the client is younger, and lower risk investments when the client is older. A conventional “target date fund” automatically changes the investment allocation of a portfolio based on the time remaining until the target date of the fund; investors are supposed to choose a target date close to their desired retirement. Prior art financial planning systems accommodate target date funds, if at all, via a bundle of predefined scenarios, such as about 50 scenarios, instead of Monte Carlo simulated scenarios.

The present financial planning system essentially customizes a target date fund to the user, rather than requiring the user to pick a fund closest to her needs. The user's retirement date can be flexible, whereas conventional target date funds lack time variability in the target date.

The present financial planning system accommodates target date funds via Monte Carlo simulated scenarios, such as about 1,000 scenarios, with the portfolio weights of investments varying over time, thereby better modelling risk. For instance, assume that the k=1 investment has high risk, the k=2 investment has medium risk and the k=3 investment has low risk, and that t indicates the year of the financial plan (t=0 is the initial condition). The following system investment strategy y(1) changes from high risk to low risk as the client ages: [t=0, 1.0 0 0], [t=10, 0.8 0.2 0], [t=20, 0.5 0.5 0], [t=30, 0.2 0.5 0.3], [t=40, 0 0.3 0.7]. The following system investment strategy y(2) changes from medium to low risk as the client ages: [t=0, 0.3 0.7 0], [t=10, 0.2 0.7 0.1], [t=20, 0.1 0.5 0.4], [t=30, 0 0.3 0.7], [t=40, 0 0 1.0].

In another embodiment, the desired investment allocation changes in response to one or more of the user's age, life actions (goal completion) and total wealth. For example, after the goal of paying for a child's college tuition is met, the user may be willing to assume more risk with their income that had gone towards tuition.

At step 715, the financial planner defines the life object templates, comprising the life action templates and goal templates, to be available to users. A goal template has a field for priority level. A life action template lacks a priority level. Usually, the financial planner selects from a library of life object templates. The financial planner may also create customized life object templates. The life object templates automatically check “reasonableness” such as requiring that the start date precede the end date.

A liquidatable asset is a type of life action.

Table 2 shows a general life object template; other fields may be added. The life object template has a row for each field. Each row includes a field number, a field status (required or optional), a field name, and a field value supplied by the template creator or by the user. Income fields 8A-8B are comparable to Cash Flow fields 9A-9E, that is, a template that uses Income does not use Cash Flow, while a template that uses Cash Flow does not use Income.

TABLE 2
General Life Object Template

| | | | |
|---|---|---|---|
| Field | | | |
| number | Field status | Field Name | Field Value |

| | | |
|---|---|---|
| 1 | Required | Life Object Template Name |
| 2 | Required | Life Object Template Number |
| 2A | Optional | Goal-inherent-priority-level |
| 3 | Optional | User-supplied Life Object Name |
| 4 | Optional | User-supplied free-form descriptive text |
| 5 | Optional | Goal-Priority level |
| 6 | Required | Start-date-fixed-date |
| | (pick 1 of 3) | Start-date-contingent-on-event |
| | | Start-date-open-date & Start-date-close-date |
| 7 | Required | End-date-fixed-date |
| | (pick 1 of 3) | End-date-contingent-on-event |
| | | Duration & t units (yrs/months/weeks/days) |
| 8A | Optional | Income-Initial-value-fixed |
| | (pick 1 of 2) | Inc-Init-val-min & Inc-Init-val-max & Inc-tiers |
| 8B | Optional | Income-Periodic-value-fixed & growth |
| | (pick 1 of 2) | Inc-Per-val-min & Inc-Per-val-max & Inc-tiers |
| 9A | Optional | Cash Flow Fields: Periodic (monthly, quarterly, |
| | (pick 1 of 3) | annual) cash flow amounts |
| 9B | Optional | Cash Flow Fields: Growth-rate amount and type |
| | (pick 1 of 2) | (Nominal or Percentage) |
| 9C | Optional | Cash Flow Fields: Growth cap amount and type |
| | (pick 1 of 2) | (Nominal or Percentage) |
| 9D | Optional | Cash Flow Fields: Variability amount and type |
| | (pick 1 of 2) | (Nominal or Percentage) |
| 9E | Optional | Cash Flow Fields: Tax Classification of cash |
| | (pick 1 of 5) | flow: For-positive-cash-flows(Taxable/Non- |
| | | taxable/Tax-deferred) and For-negative-cash- |
| | | flows(Deductible/Non-deductible) |
| 10A | Optional | Expense-Initial-value-fixed & growth |
| | (pick 1 of 2) | Exp-Init-val-min & Exp-Init-val-max & Exp- |
| | | tiers |
| 10B | Optional | Expense-Periodic-value-fixed |
| | (pick 1 of 2) | Exp-Per-val-min & Exp-val-max & Exp-tiers |
| 11 | Optional | Final-value-fixed |
| | (pick 1 of 2) | Value-increase/decrease-per-period & |
| | | fixed/pctge |
| 12A | Optional | Asset Fields: Market Value |
| 12B | Optional | Asset Fields: Cost Basis |
| 12C | Optional | Asset Fields: Appreciation/depreciation rate |
| 12D | Optional | Asset Fields: Income Cash Flows (periodic |
| | (pick 1 of 2) | amount and type nominal/percentage yield) |
| 12E | Optional | Asset Fields: Expenses Cash Flows (periodic |
| | (pick 1 of 2) | amount and type nominal/percentage yield) |
| 12F | Optional | Asset Fields: Liquidity Restrictions |
| | (pick 1 of 3) | (Illiquid/RestrictedTime/LiquidityHaircut) |
| 12G | Optional | Asset Fields: Liquidation Priority LPn (LPn |
| | | means allowed to liquidate only for funding of |
| | | goals of priority Pn or higher) |
| 13 | Optional | Tax-status-deductible/deferred/taxable/non- |
| | | taxable |
| 14 | Optional | Expected-Selling-duration-liquidity |
| 15 | Optional | Liquidation-for-goals-priority |
| 16 | Optional | Liquidity-restriction |
| 17 | Optional | Loan-type-amortizing/balloon/simple |
| 18 | Optional | Loan-interest-rate-fixed |
| | (pick 1 of 2) | Loan-interest-rate-reference & spread |
| 19 | Optional | Liability Fields: Notional Amount |
| 20 | Optional | Liability Fields: Type (Term Loan, Amortizing |
| | (pick 1 of 3) | Loan, Line of Credit) |
| 21 | Optional | Liability Fields: Maturity Date or Term to |
| | (pick 1 of 2) | Maturity |
| 22 | Optional | Liability Fields: Interest Rate (fixed rate or |
| | (pick 1 of 2) | floating spread over a reference benchmark rate) |
| 23 | Optional | Liability Fields: Prepayment Type |
| | (pick 1 of 3) | (disallowed/allowed/with penalty) |

Table 3 shows an expected inheritance life action represented in a life object template. Field 1 was supplied by the financial planner and indicates an expected inheritance of a thing. Field 2 was supplied by the financial planner and indicates the template number in a library, such as life actions library 530. The financial planner selected the other fields for this life action. The user provides the field values. Field 3 shows the user named this life action “Aunt Mary bequest”. Field 4 shows the user described this bequest as “Kahlo painting”. There is no priority level (no field 5), which means this is a life action not a goal. Field 6 shows that the user expects this inheritance to begin between Jan. 1, 2025 and Dec. 31, 2030 (whenever Aunt Mary dies), and field 7 shows that the user expects this inheritance to end on the same day. Field 8A shows that the user expects the inheritance to have a value of $800,000. Field 14 shows that the user expects it will take one year to sell this inheritance. Field 15 indicates that the user is willing to liquidate this asset to achieve goals of priority 1 or 2, but not lower priority goals. The user considers Aunt Mary's Kahlo painting to have some sentimental value, but is willing to liquidate the painting to achieve her high priority goals.

TABLE 3
Expected Inheritance Life Action

| Field | | | |
|---|---|---|---|
| number | Field status | Field Name | Field Value |
| 1 | Required | Life Object Template Name | Inheritance |
| 2 | Required | Life Object Template Number | 33 |
| 3 | Optional | User-supplied Life Object Name | Aunt Mary bequest |
| 4 | Optional | User-supplied free-form descriptive text | Kahlo painting |
| 6 | Required | Start-date-fixed-date | 20250101 & |
| | (pick 1 of 3) | Start-date-contingent-on-event | 20301231 |
| | | Start-date-open-date & Start-date-close-date | |
| 7 | Required | End-date-fixed-date | 1 day |
| | (pick 1 of 3) | End-date-contingent-on-event | |
| | | Duration & t units (yrs/months/weeks/days) | |
| 8A | Optional | Income-Initial-value-fixed | US$ 800,000 |
| | (pick 1 of 2) | Inc-Init-val-min & Inc-Init-val-max & Inc-tiers | |
| 14 | Optional | Expected-Selling-duration-liquidity | 1 year |
| 15 | Optional | Liquidation-for-goals-priority | 2 |

Table 4 shows a tuition goal represented in a life object template. Field 1 was supplied by the financial planner and indicates tuition. Field 2 was supplied by the financial planner and indicates the template number in a library, such as life actions library 530. The financial planner selected the other fields for this life action. The user provides the field values. Field 3 shows the user named this life action “Juliet tuition”. Field 5 shows the user gave this goal a priority of “2”. Field 6 shows that the user expects this goal to begin between Sep. 1, 2024 (Juliet may graduate from high school in three years) and Sep. 1, 2026 (Juliet may graduate from high school in four years then take a year off). Field 7 shows that this goal has a duration of four years. Field 10B shows that this goal has a value range of 30,000 per year to 120,000 per year, corresponding to the user's uncertainty over whether Juliet will live at home and attend a state school, or will attend an elite university and live there, or something in-between. Field 10B also shows that this goal has three tiers, meaning that the user is effectively specifying tutition at 30,000 per year; 75,000 per year (midpoint of lowest and highest values); or 120,000 per year, as priority 2 goals.

TABLE 4
Tuition Goal

| Field | | | |
|---|---|---|---|
| number | Field status | Field Name | Field Value |
| 1 | Required | Life Object Template Name | Tuition |
| 2 | Required | Life Object Template Number | 212 |
| 3 | Optional | User-supplied Life Object Name | Juliet tuition |
| 5 | Optional | Goal-Priority level | 2 |
| 6 | Required | Start-date-fixed-date | 20240901 & |
| | (pick 1 of 3) | Start-date-contingent-on-event | 20260901 |
| | | Start-date-open-date & Start-date-close-date | |
| 7 | Required | End-date-fixed-date | 4 years |
| | (pick 1 of 3) | End-date-contingent-on-event | |
| | | Duration & t units (yrs/months/weeks/days) | |
| 10B | Optional | Expense-Periodic-value-fixed | 30,000 & 120,000 |
| | (pick 1 of 2) | Exp-Per-val-min & Exp-val-max & Exp-tiers | & 3 |

Alternatively, the user might specify tuition at 30,000 per year as a priority 2 goal; tuition at 75,000-30,000=45,000 as a priority 3 goal; and tuition at 120,000-75,000=45,000 as a priority 4 goal; this scenario corresponds to the user wanting to pay some tuition as a priority 2 goal, but pay all of the most expensive tuition only if all other goals at priorities 2 and 3 are satisfied. Perhaps Juliet will need student loans or a job, if the user has other goals.

Table 5 shows a student loan life action represented in a life object template.

TABLE 5
Student Loan Life Action

| Field | | | |
|---|---|---|---|
| number | Field status | Field Name | Field Value |
| 1 | Required | Life Object Template Name | TermLoanAmortizing |
| 2 | Required | Life Object Template Number | 154 |
| 3 | Optional | User-supplied Life Object Name | Student Loan |
| 4 | Optional | User-supplied free-form descriptive text | MBA Tuition |
| | | | Payment |
| 6 | Required (pick 1 | Start-date-fixed-date | 20150101 |
| | of 3) | | |
| 7 | Required (pick 1 | Duration & t units | 10 years |
| | of 3) | (yrs/months/weeks/days) | |
| 9E | Optional (pick 1 | Cash Flow Fields: Tax Classification of | Taxable/Non- |
| | of 5) | cash flow: For-positive-cash- | deductible |
| | | flows(Taxable/Non-taxable/Tax-deferred) | |
| | | and For-negative-cash- | |
| | | flows(Deductible/Non-deductible) | |
| 19 | Optional | Liability Fields: Notional Amount | $120,000 |
| 20 | Optional (pick 1 | Liability Fields: Type (Term Loan, | Amortizing Loan |
| | of 3) | Amortizing Loan, Line of Credit) | |
| 21 | Optional (pick 1 | Liability Fields: Maturity Date or Term to | 10 years |
| | of 2) | Maturity | |
| 22 | Optional (pick 1 | Liability Fields: Interest Rate (fixed rate or | 6% |
| | of 2) | floating spread over a reference | |
| | | benchmark rate) | |
| 23 | Optional (pick 1 | Liability Fields: Prepayment Type | Allowed |
| | of 3) | (disallowed/allowed/with penalty) | |

Table 6 shows a rental property life action represented in a life object template.

TABLE 6
Rental Property Life Action

| Field | | | |
|---|---|---|---|
| number | Field status | Field Name | Field Value |
| 1 | Required | Life Object Template Name | RentalProperty |
| 2 | Required | Life Object Template Number | 123 |
| 3 | Optional | User-supplied Life Object Name | Apartment Rental |
| 4 | Optional | User-supplied free-form descriptive text | Investment Property |
| 6 | Required | Start-date-fixed-date | 20150101 |
| | (pick 1 of 3) | | |
| 7 | Required | Duration & t units (yrs/months/weeks/days) | 30 years |
| | (pick 1 of 3) | | |
| 9E | Optional | Cash Flow Fields: Tax Classification of cash | Non-deductible |
| | (pick 1 of 5) | flow: For-positive-cash-flows(Taxable/Non- | |
| | | taxable/Tax-deferred) and For-negative-cash- | |
| | | flows(Deductible/Non-deductible) | |
| 12A | Optional | Asset Fields: Market Value | $1,000,000 |
| 12B | Optional | Asset Fields: Cost Basis | $700,000 |
| 12C | Optional | Asset Fields: Appreciation/depreciation rate | 2% |
| 12D | Optional | Asset Fields: Income Cash Flows (periodic | 3% rental yield |
| | (pick 1 of 2) | amount and type nominal/percentage yield) | |
| 12E | Optional | Asset Fields: Expenses Cash Flows (periodic | −$850/mo nominal |
| | (pick 1 of 2) | amount and type nominal/percentage yield) | maintenance cost |
| 12F | Optional | Asset Fields: Liquidity Restrictions | Illiquid |
| | (pick 1 of 3) | (Illiquid/RestrictedTime/LiquidityHaircut) | |
| 12G | Optional | Asset Fields: Liquidation Priority LPn (LPn | LP2 |
| | | means allowed to liquidate only for funding of | |
| | | goals of priority Pn or higher) | |

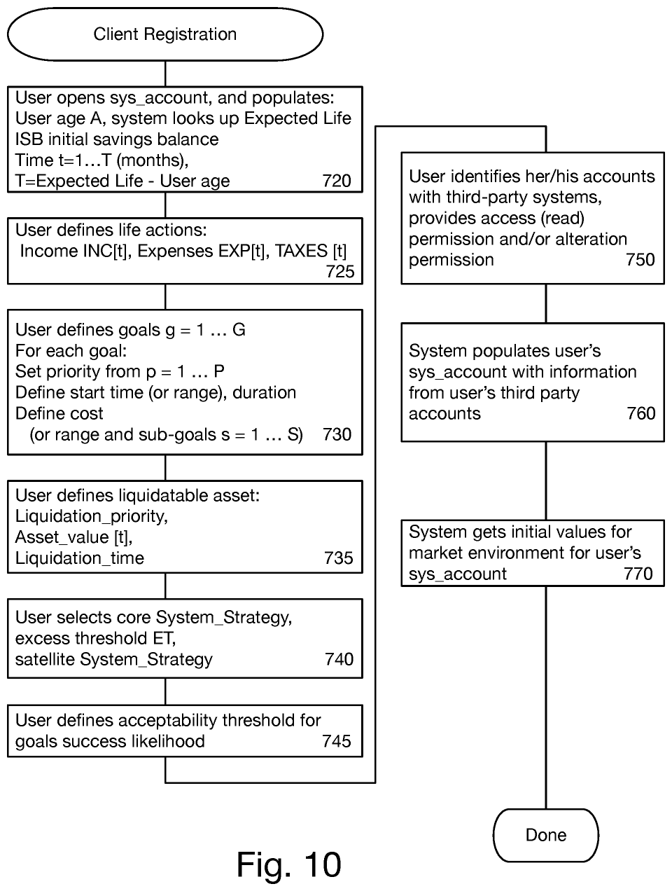

FIG. 10 is a flowchart showing client registration in a financial planning system according to the present invention. The person performing the steps is referred to as the user, and can be the financial planner or the client herself. The information created during client registration is stored in a suitable storage, such as client storages 540, 555, 575, 595 shown in FIG. 5.

At step 720, the user creates an account for herself and populates it with user descriptive information, including the user's present age, initial savings balance ISB (which can be negative if the user has outstanding loans such as student loans and/or a home mortgage). In this embodiment, the financial planning system then looks up the user's expected life from a stored table, and enables the user to adjust her expected life. The financial plan will be for a duration of T months, with T=12*(Expected Life (years)−Current Age (years)).

At step 725, the user specifies her life actions resulting in income, expenses or taxes for the duration of the financial plan, using the life action templates defined at step 715. Life actions are things that the user has already committed to, such as repaying the user's student loans.

At step 730, the user defines her goals using the goal templates defined at step 715. Goals are things that the user would like to commit to if affordable.

At step 735, the user defines her liquidatable assets, using the life action templates defined at step 715. For instance, the user may already own a home, and be willing to liquidate this upon retirement. In some embodiments, steps 725 and 735 are combined.

At step 740, the user selects her core System_Strategy from the strategies defined at step 710, defines her excess threshold ET, and selects her satellite System_Strategy from the stragies defined at step 710. The system uses the core System_Strategy until the user's excess wealth exceeds the excess threshold, at which point the system switches to the satellite System_Strategy. The default is to use the core System_Strategy for wealth up to the excess threshold, and then use the satellite System_Strategy for wealth exceeding the excess threshold; however, in some embodiments, the user may specify that the satellite System_Strategy is used for all wealth.

In some embodiments, the user specifies a first core System_Strategy, and then after ET is reached, specifies a second core System_Strategy in lieu of the first for wealth up to ET, and then a third System_Strategy for wealth exceeding ET. For example, the user may select a first medium risk strategy as her core System_Strategy, such as an equity index investment, and then after excess wealth exceeds ET, switch to a low risk strategy as her core System_Strategy for her wealth up to ET, such as a government bond fund, and a high risk strategy for excess wealth exceeding ET, such as a foreign country small cap equities investment.

In some embodiments, the user can specify multiple excess thresholds ET_1, ET_2, ET_3, . . . with respective System Strategies.

In some embodiments, the financial planning system suggests System Strategies based on the value of the excess threshold. For instance, for an excess wealth threshold of $3 million, the system might suggest a bitcoin investment, or for an excess wealth threshold of $10 million, the system might suggest original artwork or other investment having a relatively unpredictable return.

At step 745, the user defines her scenario acceptability threshold. This pre-defined acceptability enables the financial planning system to automatically decide whether a financial plan is acceptable, whereas conventional financial planning systems leave that decision to the user, expecting the user to iterate for awhile. For example, the user may define acceptability as Acceptability=[p1 80%, p2 60%, p3 40%] meaning a financial plan is acceptable if it has at least an 80% chance of achieving priority 1 goals and at least a 60% chance of achieving priority 2 goals and at least a 40% chance of achieving priority 3 goals.

If the user is concerned with having all of her goals met, then goals success likelihood is defined as at step 280 of FIG. 3D and acceptability is the minimum chance of achieving all of her goals that the user is comfortable with, such as 0.85, that is, an 85% chance that she will achieve all of her goals. Alternatively, the user can specify that goals of up to a particular priority level pAccept must be met for acceptability, so that goal success likelihood considers only those priority levels, while goals at less important priority levels are ignored for acceptability:

Goal_success_likelihood=N⁻¹*Σₙ₌₁^{N}1(B[n,T]>Benchmark_{pAccept}) (equation 15)

In other embodiments, other techniques for defining acceptability are used.

At step 750, the user identifies the client's accounts with third-party systems, such as banks or brokerages, and provides access (read) and/or alteration permission.

At step 760, the financial planning system populates the client's account with information from the client's third-party accounts.

At step 770, the financial planning system gets initial values for the market environment for the client's account.

FIGS. 11A-11C are a flowchart showing operation in a financial planning system according to the present invention. One embodiment is shown; other embodiments are contemplated. The information created during operation is stored in a suitable storage, such as client storages 540, 555, 575, 595, shown in FIG. 5.

Step 810 is similar to step 255 of FIG. 3D. Typically, about N=1,000 Monte Carlo simulations are performed, but any number may be used as long as it is large enough so that the statistical distribution across scenarios is realistic, such as N being at least around 100. The market rates for future times are projected using the Monte Carlo simulations created at this step. The market rates m=1 . . . M correspond to respective rates typically used in finance, such as the Fed Funds rate, inflation, the US 5 year borrowing rate, the US 10 year borrowing rate, the Prime rate, or the 11th District Cost of Fund Index (COFI).

At step 820, for each priority level, the benchmark curves are determined. In one embodiment, MWAG curves based on hypothetical wealth, discussed with respect to FIGS. 8A-8H, are used as the benchmark curves.

FIG. 11B is a flowchart showing generation of MWAG curves as the benchmark curves.

At step 910, the investment weights w(k) are selected. The investment weights do not vary with time, and the rate of return of each investment also does not vary with time. Typically, the core System_Strategy from step 740 is used as the Selected Strategy for determining w(k), with the fixed return for each investment being the most conservative expected return.

At step 920, the current priority level is set to “1”.

At step 930, Cumulative Savings is initialized to the ISB from step 720.

At step 940, all of the goals at the current priority level are converted to life actions. If the goal has a time range, the latest start date is used. If the goal has a value range, it is split into sub-goals, so that a MWAG curve will be generated for each sub-goal.

At step 950, the user's wealth (Cumulative_Savings) is calculated for each period of the financial plan, thereby generating a Wealth curve for the current priority level.

At step 960, the financial planning system determines the MWAG curve corresponding to the Wealth curve for the current priority level.

At step 970, the current priority level is incremented by one.

At step 980, the financial planning system checks whether the current priority level exceeds the maximum priority level P defined at step 730. If not, processing returns to step 930. If so, processing is complete, that is, the benchmark curves have been determined.

Returning to FIG. 11A, at step 830, the System_Strategy y(i), typically the core System_Strategy selected at step 740, specifies the initial investment weights. The strategy enables the user to change her investment allocation over the duration of the financial plan. In contrast, a conventional financial plan uses the same investment allocation for the duration of the financial plan, as shown at step 260 of FIG. 3D.

At step 840, the financial planning system sets the initial account balance B[t=0] to be the ISB defined at step 720.

At step 850, the financial planning system creates the N scenarios based on the selected system investment strategy, the benchmark curves, the user's goals and life actions, and the Scenario Investment Return SIR[n,t,v] from the Monte Carlo simulations.

For each scenario n, for each time period t, for each priority level p, and for each subgoal s (if any goal has value variability represented as sub-goals):
The financial planning system first determines whether the user's current savings balance B[n,t−1] is less than the benchmark curve for this priority level, that is, whether the user cannot afford all goals at this priority. If so, the system determines whether asset liquidation is available at this priority level, at this time, and would result in the user's current savings balance exceeding the benchmark curve; any such assets are “suitable assets” and are automatically liquidated by the system. The fact of asset liquidation, and the date it occurs, form part of the financial plan. Conventional financial planning systems are unable to automatically decide when and whether to liquidate assets.
Next, the financial planning system determines whether the user's current savings balance B[n,t−1], with any adjustments from asset liquidation, is at least equal to the benchmark curve for this priority level, that is, whether the user can afford any goals at this priority. If so, the system converts such goals to life actions, sometimes referred to as “commits” such goal. The fact of goal commitment, the date it occurs, and the value of the goal (if the goal was specified with a value range) form part of the financial plan. Conventional financial planning systems are unable to automatically decide when and whether to commit to goals, as such systems assume all goals are required. The present financial planning system is far more efficient from a user's viewpoint than conventional financial planning systems because it obeys the user's goal preferences, expressed as goal priorities, in automatically deciding which goals are achievable based on the user's situation.
Next, the investment weights w[n,t,k] for this period are automatically determined based on the current savings balance B[n,t−1], the benchmark curve, and the weights for the selected strategy y(i) at this time. The core System_Strategy provides the investment weights until the user's “excess wealth”, defined as (B[n,t−1]−Benchmark) exceeds the excess threshold ET defined at step 740, at which point the satellite System_Strategy provides the investment weights. For instance, when minimum wealth to achieve goals is used as the benchmark, then the value of the curve for the least important priority goal is subtracted from the current wealth to yield the excess wealth. When the excess wealth exceeds the excess threshold ET, the System_Strategy changes to the satellite System_Strategy.
Then the financial planning system system computes the Net Savings NS[t] for all life actions:

N=INC[t]−EXP[t]−TAXES[t] (equation 16)

where

INC[t]=Σₖ₌₁^{K}LA_INC[k,t,n] (equation 17)

EXP[t]=Σₖ₌₁^{K}LA_EXP[k,t,n] (equation 18)

TAXES[t]=Σₖ₌₁^{K}LA_TAX[k,t,n] (equation 19)
Then the financial planning system computes the scenario's Portfolio Return PR[n,t], similar to step 275 of FIG. 3D:

PR[n,t]=Σₖ₌₁^{K} SIR[n,t,k]*wI[k] (equation 20)

and computes the account balance B[n,t] similar to step 275 of FIG. 3D:

B[n,t]=(1+PR[n,t])*B[n,t−1]+NS[t] (equation 21)
The financial planning system rebalances the goal account investments to conform to the weighted allocation in the selected System_Strategy. It will be recalled that since different investments may experience different growth, the portfolio needs to be rebalanced.
The financial planning system determines whether rebalancing would result in any trades that incurred capital gains or losses, and if so, adjusts the user's tax liability for the next period t+1 accordingly. Conventional financial planning system do not do this.
At the conclusion of the scenario, the financial planning system stores the account balance B[n,t=T], also referred to as the wealth or the cumulative savings.

At step 860, the financial planning system determines the goals success likelihood across all scenarios. As used herein and in the claims, for a goal to be successful, the financial planning system must commit that goal, and successfully fund that goal. Successful funding generally corresponds to the user's wealth remaining above the MWAG curve for the duration of the goal.

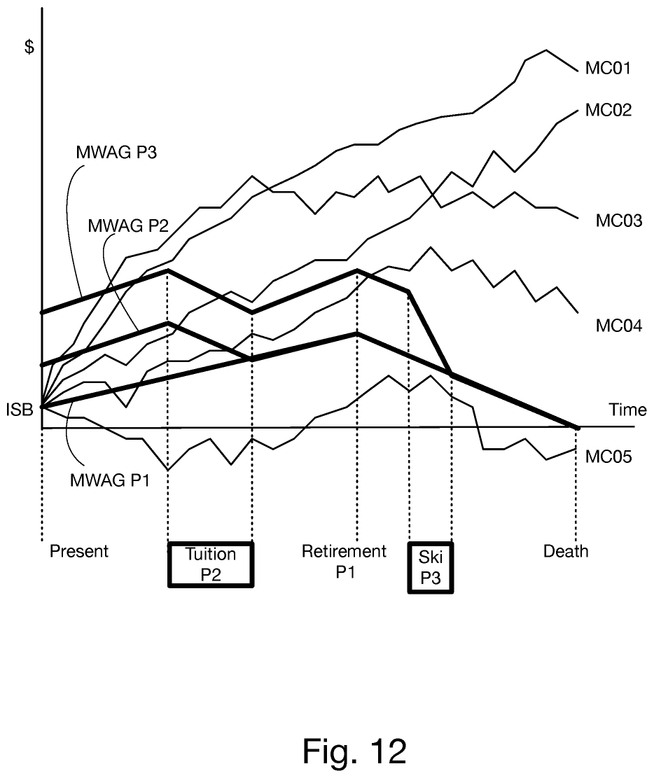

An example of determining goals success likelihood will now be discussed with reference to FIG. 12, showing five wealth simulation scenarios MC01 . . . MC05, with Monte Carlo simulations used to determine investment performance, along with the MWAG curves of FIG. 8H.

The sole priority 1 goal in this example is retirement, corresponding to the MWAG P1 curve. At the start of the retirement goal, indicated as a vertical dashed line, four of the five simulation scenarios are above the MWAG P1 curve, so the probability that the retirement goal will be achieved is 4/5=80%.

The sole priority 2 goal in this example is tuition, corresponding to the MWAG P2 curve. At the start of the tuition goal, indicated as a vertical dashed line, two of the five simulation scenarios are above the MWAG P2 curve, so the probability that the tuition goal will be achieved is 2/5=40%.

The sole priority 3 goal in this example is a ski trip, corresponding to the MWAG P3 curve. At the start of the ski trip goal, indicated as a vertical dashed line, four of the five simulation scenarios are above the MWAG P3 curve, so the probability that the ski trip goal will be achieved is 4/5=80%.

Generally, it is desirable that priority 2 goals have a higher success likelihood than priority 3 goals. However, in the scenario of FIG. 12, the priority 3 goal was more successful due to timing: it occurred much later in the user's life than the priority 2 goal, by which time the user was able to save enough for the priority 3 goal.

At step 870, the financial planning system decides whether the Financial Plan is acceptable in accordance with step 745. If so, processing continues at step 890. For example, if the user's acceptability threshold is Acceptability=[p1 80%, p2 60%, p3 40%], then the example of FIG. 12, wherein goals success=[p1 80%, p2 40%, p3 80%] is unacceptable because the p2 goal likelihood is 40% but the p2 acceptability threshold is 60%.

If the Financial Plan is not acceptable, at step 880, the user revises goals and/or priorities and/or investment allocation strategies and/or acceptability threshold and processing returns to step 820. At step 880, the financial planning system may suggest strategies or investments to the user, with the suggestions based on the user's wealth and goals. Exemplary suggestions made by the financial planning system may be:
asset liquidation beyond what the user has deemed acceptable liquidation priority when defining the asset;
obtaining a loan to fund the user's goals; and/or
choose a riskier core System_Strategy in the hope of higher returns; and/or
adjust acceptability threshold.
   As a further example, in one embodiment, a unique “inherent priority level” field is added to each goal template defined by the financial planner, see Table 1 field 2A; and at step 880, the financial planning system suggests altering the priority of the goal in accordance with its inherent priority level.

At step 890, the financial planning system defines the user's Financial Strategy as the parameters leading to goals success likelihood deemed acceptable at step 870. These parameters include the initial savings balance specified at step 720, the life actions specified at step 725, the goals and priority levels specified at step 730, the liquidatable assets specified at step 735, the System Strategies specified at step 740, the acceptability threshold specified at step 745, and the benchmark curves determined at step 820.

Conventional financial planning systems produce a financial plan, possibly misleading the user into false certainty regarding goal achievement. In contrast, the present financial planning system produces a financial strategy with success likelihoods for the goals, more accurately representing future uncertainty to the user.

At step 895, the financial planning system implements or applies the Financial Strategy deemed acceptable at step 870, as shown in FIG. 11C.

Turning to FIG. 11C, at step 1010, the financial planning system synchronizes the present time with the time t=1 of the Financial Strategy deemed acceptable at step 870.

At step 1020, if the customer, also referred to as the user or the client, has given permission, the financial planning system automatically moves funds among accounts, and/or places trades in accordance with the Financial Strategy. Fund movement occurs when the ISB is allocated among accounts, when the monthly savings is allocated among accounts, and when accounts are rebalanced to conform to the financial plan.

At step 1030, for those actions specified by the Financial Strategy that cannot be automatically accomplished, the financial planning system notifies the customer of what actions to take. For instance, if an asset such as a painting is to be liquidated, the customer is notified. At step 1040, the user optionally updates information or adds new information.

Examples of updating information are: changing the parameters of life actions or goals, or deleting life actions or goals. Examples of adding new information are: adding new life actions, adding new goals or financial accounts.

At step 1050, the financial planning system determines that sufficient time has elapsed so that the next period t+1 of the Financial Strategy has arrived. Typically, at step 720, the financial period is defined as a month, but in some cases it may be a week, a bi-week, a quarter-year, a year or other suitable timeframe.

At step 1060, the financial planning system checks whether the user is still alive, or whether another condition at the end of the Financial Strategy has occurred. If so, processing is complete. If not, processing continues to step 1070.

At step 1070, similar to step 770, the financial planning system gets current values for the market environment for the client's account.

At step 1080, the financial planning system determines whether a new financial strategy is needed. Generally, a new financial strategy is needed when at least one of the following events has occurred, as specified by the user, indicating a change to wealth over time:
changes in life actions,
changes in goals,
changes in System_Strategy,
changes in acceptability threshold,
new user account information, particularly a new type of account such as a 401(k) account.
   If none of the above events has occurred, that is, no events or only events indicating a change to the status of the wealth, such as updating the current wealth or the liquidation value of a life action, then a new financial strategy is not needed, and processing continues at step 1090. If a new financial strategy is needed, processing returns to step 820 in FIG. 11A, except with the initial savings balance reset to the current wealth, that is, ISB=B[t].

At step 1090, only the period t+1 of the existing Financial Strategy is computed, reflecting the current market environment from step 1070 and any changes to current position made by the user at step 1040. Processing at step 1090 is similar to processing at step 850, but for only n=reality (instead of one of N simulation scenarios) and only t=t+1 (instead of t=1 to T), and will not be discussed in detail for brevity. Step 1090 comprises implementing the acceptable financial strategy by determining actions period-by-period. Then, processing continues at step 1020.

An advantage of the present financial planning system is that if there have been no material changes in the user's circumstances since the last period, only the current period needs to be computed at step 1090; in contrast, a conventional financial planning system gives only a plan for one period, and needs to be completely re-run at a next period. The present financial planning system needs to be completely re-run only in a period where there have been material changes in the user's circumstances (the “yes” branch from step 1080 to step 820, indicated by AA in a circle).

### FPS with Automated Selection of Financing

The effect of financing on an object will now be discussed.

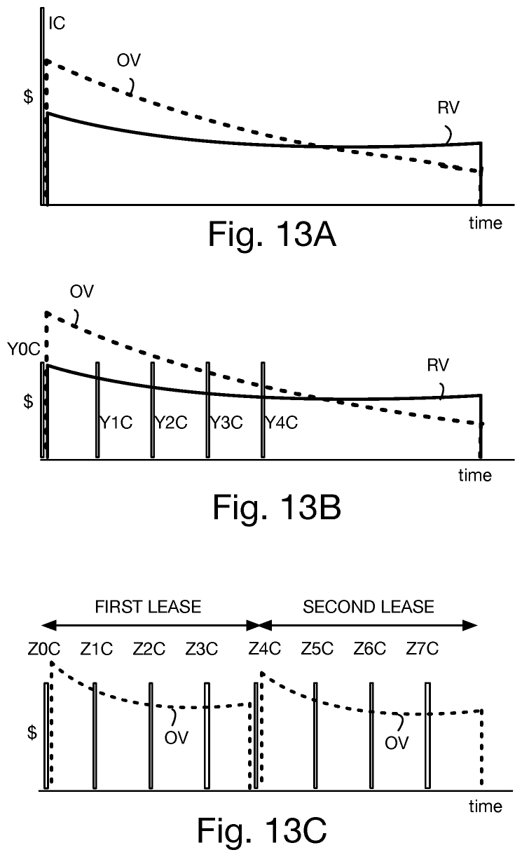

FIG. 13A shows one scenario of initial cost IC, resale value RV and ownership value OV. Other scenarios are possible, e.g., if the object is a “collectible” its value might increase as time passes. The object is assumed to be a consumption object having a predetermined useful life. For a typical unfinanced object, IC is a relatively high payment, RV gradually declines over the lifetime of an object, and OV gradually declines over the lifetime of the object. People often keep objects even when their resale value is greater than their ownership value, because of transactional inertia, possibly resulting in suboptimal performance relative to their FP or FS.

FIG. 13B shows the effect of loan financing. RV and OV are unchanged. However, IC is spread over some time period, rather than all incurred initially. As shown, the cost is a series of five payments Y0C, Y1C, Y2C, Y3C, Y4C. Generally, the deferred payments including financing (Y0C+Y1C++ Y4C) exceed the unfinanced one-time cost (IC) due to interest paid to the financing provider. For the moment, tax implications are ignored.

FIG. 13C shows the effect of lease financing. Leasing operates similarly to a loan, except that the lifetime of the object runs with the lifetime of the lease so that multiple sequential leases may be needed to achieve the duration of object use provided by purchase of the object. In other words, a leased object has no residual value (RV), since it is not owned by the borrower.

A third-party financing provider defines its financing product by parameters, such as:
dollar amount of financing per object, ex: up to $30,000;
amount of financing per object by percentage, ex: 80% financeable indicates that the financing provider requires that the owner make an initial (non-financed) downpayment of 20% of the value of the object;
acceptable loan durations, ex: for 5, 10 or 15 years;
interest rate possibly based on duration and borrower creditworthiness, where creditworthiness is determined based on conventional parameters such as borrower's expected income, assets, FICO score, presence of co-signer, and possibly on novel unconventional parameters such as:
   the borrower's history of adherence to a FP or FS;
   simulated expectations of a successful FP or FS including financing; or
   a predictive score generated by the present system.
repayment frequency, ex: monthly;
repayment composition, ex: bullet loan (interest only and principal due at termination), or equal payments comprising interest plus amortized principal;
whether a security interest in the object is required, ex: yes or no.

An individual can define private financing available to the individual, on a goal-by-goal basis. For instance, the individual's family may volunteer to give the individual a no-interest loan of $15,000 to be repaid over 10 years, for use only on the downpayment for a car. The parameters for private financing are otherwise similar to the parameters for third-party financing, discussed above.

We now turn to the issue of when financing is appropriate.

A very conservative person buys an object only when s/he has saved sufficient funds to afford the object. However, this is not necessarily an optimal strategy when possession of the object would enable improvements in the person's life. For instance, a car enables a person to work further from home, transport food, transport their family to events, and so on. Thus, financing an object may improve a person's life sufficiently to be worth the cost of financing.

A user may accept financing in several ways. One way is on a goal-by-goal basis: the user to designates a goal as finance-able, possibly indicating restrictions in the amount of financing tolerable by percent of value or absolute amount or financing cost or date or financing provider (private or third party). Another way is globally for all goals: the user designates financing of any goal as acceptable, possibly with restrictions as mentioned; possibly also by priority level, e.g., financing of priority 1 and 2 objects is acceptable but not if the priority is lower; and/or possibly by goal value, e.g., goals costing at least $20,000 are financeable. A further way is by whether the goal has an asset that can be used as collateral. Yet another way is by the type of financing, e.g., private financing as defined by the user is acceptable, but third party financing is not acceptable. Other acceptance strategies for financing can be accommodated.

An example of a financing strategy is: for object=car, financing is acceptable if year is 2021 or later and interest rate is under 5%. This strategy causes the present system to select all loan provider offerings that meet this criteria, then see if the borrower meets the financing provider's criteria.

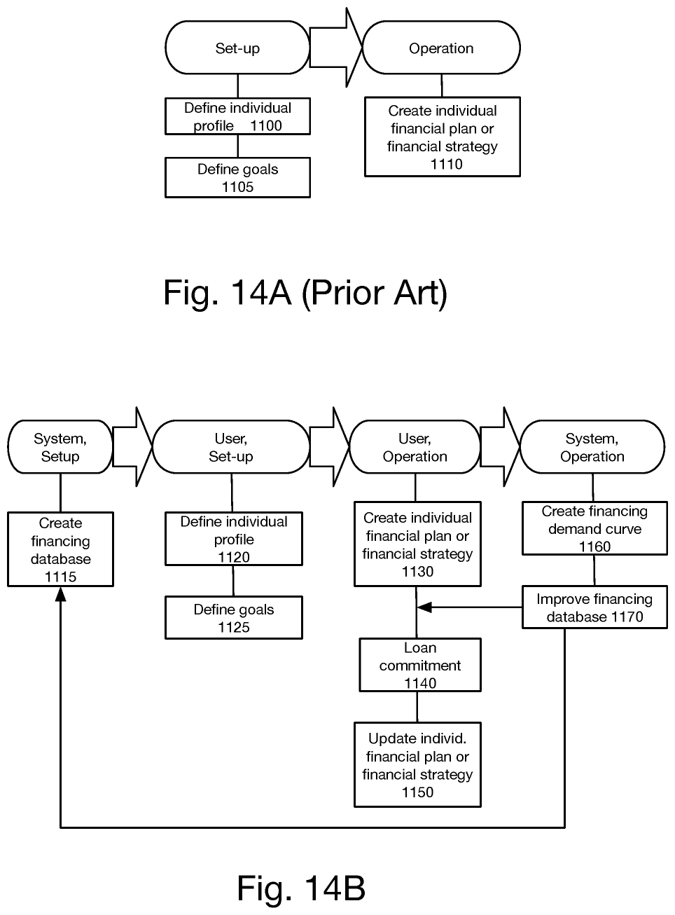

FIG. 14A is a chart showing the conventional process of financial planning. User set-up comprises steps 1100 and 1105. At step 1100, an individual's profile, comprising descriptive information and preferences specific to the user, is defined typically during registration. At step 1105, the user's goals for their financial plan are defined. During operation, at step 1110, the FPS creates the FP or FS, as discussed above with respect to a conventional FPS and a benchmark FPS.

FIG. 14B is a chart showing financial planning with automatically selected financing.

At step 1115, a financing database is created comprising offers to provide financing according to various terms, for borrowers who meet the lenders' criteria. Financing providers specify whether they will automatically agree to make loans automatically selected by the FPS.

During user setup, a user's willingness to accept financing is specified. In one embodiment, financing is assumed to be acceptable, and the user can override this globally or by goal. In another embodiment, the user must “opt in” to financing, either globally or by goal. The user also specifies whether s/he wishes to automatically accept financing selected by the FPS. Otherwise, steps 1120 and 1125 of user set-up are similar to steps 1100 and 1105 of FIG. 14A. Loans can be more effectively used in benchmark FPS than in conventional FPS, as the user, in specifying goal priorities, provides information relating to the desirability of loans.

During user operation, at step 1130, generally similar to step 1110 of FIG. 14A, the FPS creates the user's FP or FS, except now the FPS uses the financing database to evaluate whether the user is eligible for loans, and if so, to select the best loan for the user. Financing helps a user to achieve goals earlier in life. At step 1140, if the user has agreed to automatically accept the automatically selected financing, then the FPS “takes out a loan” for the user with the financing provider. At step 1150, the FPS updates the user's FP or FS.

In some embodiments, there is a “system operation” phase, typically at periodic intervals such as weekly or monthly, wherein at step 1160, the FPS creates financing demand curves (discussed below) based on the users' FPs or FSs and sends these curves to the financing providers. Then at step 1170, the FPS receives the financing providers' responses, if any: either changes to existing loan offers, such as changes to borrower criteria, or entirely new loan offers. The FPS updates the financing database with these updated or new financing offers. The FPS also notifies relevant users of these updated or new financing offers. Generally, a relevant user is one who has financing in their FP or FS, and for whom the updated or new financing offers might result in a better outcome. At step 1140, each user then determines whether or not to accept the updated or new financing offer, thereby possibly refinancing their loan.

Users following a FP or a FS are more likely to repay their loans, so better loan terms may be available from financing providers for such users.

Financing demand curves will now be discussed.

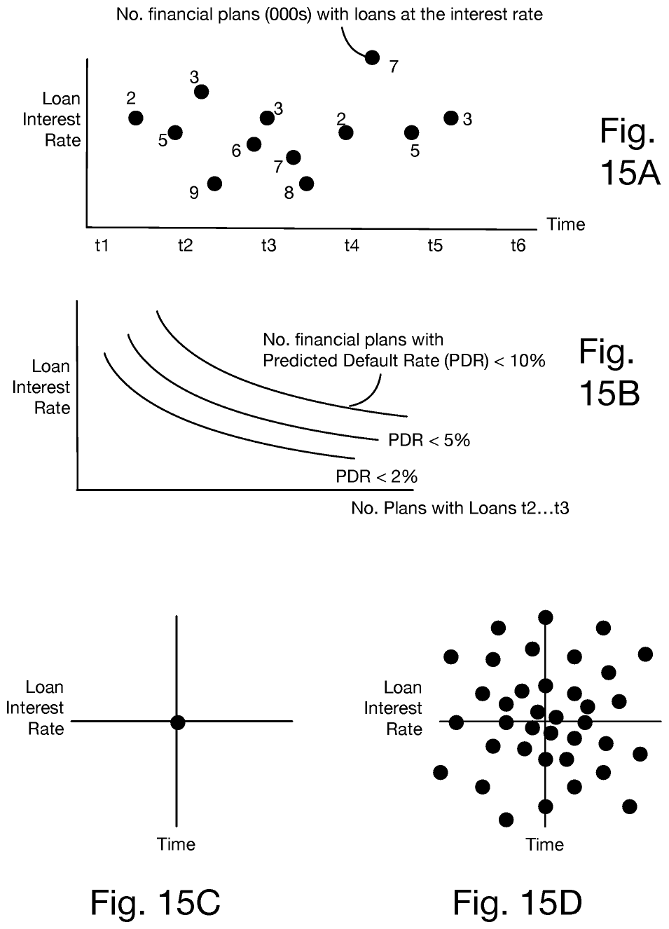

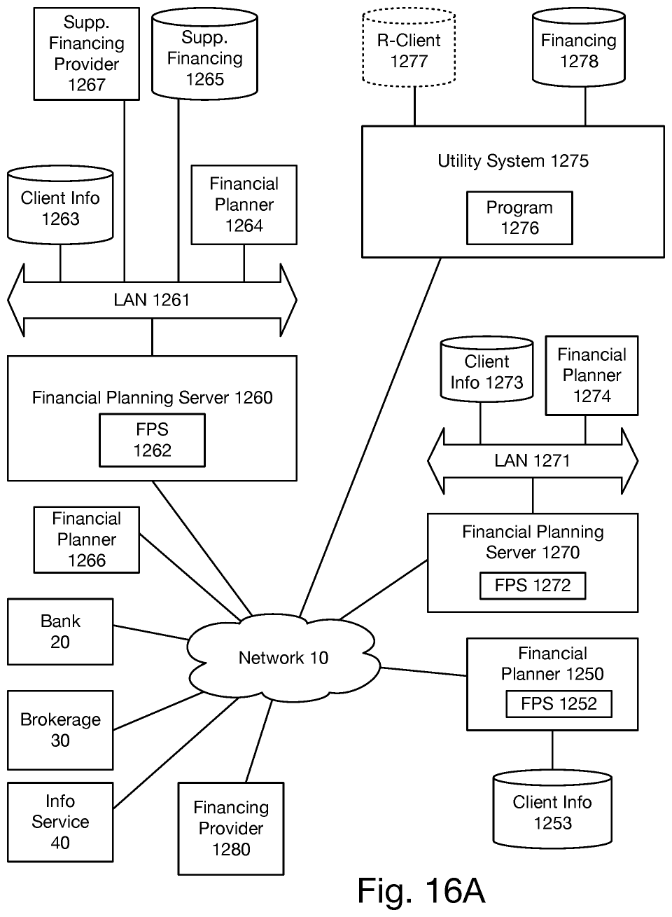

FIG. 15A is a graph showing the number of loans of a particular type taken by users by time, which is a precursor to a financing demand curve. At step 1160 of FIG. 14B, at periodic intervals, the FPS creates this graph by examining all stored FPs or FSs and seeing which assume this type of loan, at which time.

Lenders are concerned with loans to users of different creditworthiness. A user's creditworthiness is conventionally represented by a credit score, showing how a user has managed their use of credit in the past. A FPS permits consideration of how a user will manage their credit in future via a new metric: predicted default rate. A family of curves showing the number of FPs or FSs at different PDRs can be constructed, to show lenders the market size as the lenders change their creditworthiness requirements.

Predicted default rates (PDRs) will now be discussed.

For a conventional FPS, a default is defined narrowly as having zero in all cash and investment accounts, i.e., expenses cannot be paid without asset liquidation. A conventional FPS is usually unable to automate asset liquidation decisions, so this is an appropriately narrow definition.

For a benchmark FPS, a default is defined more broadly as the user's net wealth dropping below zero, meaning that assets can be liquidated to pay expenses. The benchmark FPS automates asset liquidation decisions, so this is an appropriately broad definition.

Conventionally, financing providers base their decision to lend mainly on the potential borrower's income and assets, and on the “credit history” of a potential borrower, that shows how timely an individual has repaid other of their debts to prior lenders such as banks, credit card companies, collection agencies, and governments. Many financing providers use risk-based pricing, their loan rates depend on the borrower's credit history.

An advantage of a FP or FS is that it shows the likelihood of a borrower being able to repay in future, which is arguably more/ant than the borrower's credit history, particularly for younger individuals that have not taken out any or few loans. A FP or FS can be thought of as a future credit history. Thus, a FP or FS is valuable information to a financing provider, as it illuminates the personal risk of a borrower, while the Monte Carlo (MC) simulations used in the FP or FS simulate default risk along with exogenous market risk effects.

For a FP, the predicted default rate, PDR, is defined as in equation 22:

PDR=(no. simulations where user defaults)/total no. simulations (equation 22)

For a FP, the PDR gives the likelihood of default over the lifetime of the financial plan, which is better than no informationabout the future, but does not inform a financing provider as to when the default might occur. Generally, a financing provider is concerned about borrower default only if it occurs during the term of the loan provided by the financing provider.

A FS is “date aware”, i.e., the times of the defaults based on the MC simulations are easily visible. Thus, a FS permits computation of a date-aware PDR, i.e., a PDR for a given time period t1 to t2 of the FS, as in equation 23:

$$PDR during period t 1 to t 2 = \frac{{\sum }_{n = 1}^{N} \begin{matrix}number of defaults \\ during t 1 to t 2 \end{matrix} }{{\sum }_{n = 1}^{N} \begin{matrix}number of FS \\ with financing\end{matrix} } \qquad ( equation 23 )$$

The date-aware PDR is exactly what a risk-based lender wants to know: what is the likelihood of the borrower defaulting during the loan repayment period.

FIG. 15B is a graph showing financing demand curves for different PDR rates, that is, the number of FPs or FSs at different PDRs. Beginning with the graph in FIG. 15A, the FPS isolates the time of interest, such as from t2 to t3. Then, the FPS plots the loans according to the PDR of the users. A lender who is good at managing risk might be willing to offer higher-rate loans to higher PDR borrowers, thus enabling a user to get a loan at all. Similarly, a lender who is good at managing risk might be willing to offer lower-rate loans to lower PDR borrowers.

FIG. 15C is a chart showing the deterministic nature of a modified conventional financial planning system, illustrating that the outcome is a FP where each term of the FP is definite.

Thus, FIG. 15A is an accurate depiction of the result of creating many Monte Carlo scenarios for a modified conventional financial planning system.

FIG. 15D is a chart showing the probabilistic nature of a benchmark financial planning system, illustrating that the outcome is a FS where each term of the FS is best modelled as a density function over an area, as the Monte Carlo scenarios result in different F Ss for different scenarios, as shown in FIG. 12.

Thus, FIG. 15A, for a benchmark financial planning system, should be understood as having density functions instead of point values as for a modified conventional financial planning system.

As is conventional in patent drawings, when only one instance of an item is shown for brevity, it will be understood that many instances of that item are possible and operate similarly.

Section 1. Modified Conventional Financial Planning System with Financing

FIG. 16A shows a modified configuration for a conventional financial planning system; this figure is similar to FIG. 1 and for brevity, only differences are discussed.

Financial planning servers 1260, 1270 and financial planner 1250 respectively execute modified conventional financial planning system software 1262, 1272, 1252. The modifications are as described below, including an application programming interface (API) to program 1276 executed by utility system 1275. Generally, financial planner 1250 is a solo or small entity, server 1260 is a large entity, and system 1270 is associated with a sophisticated small entity, a mid-size entity or a large size entity.

Financial planner 1266 is a remote user of financial planning server 1260 or 1270.

Reduced client database 1277 contains reduced (anonymized) financial plans and associated information—such as hypothetical offer acceptances (discussed below)—created by financial planning servers 1260, 1270 and financial planner 1250, sufficient for creation of financing demand curves, for updating of the reduced financial plans by their creators and for sending new and updated loan offers to the owners of the reduced financial plans.

Financing database 1278 contains registration profiles for lenders 1280. Financing database 1278 contains offers to provide financing for various goals according to various terms, for borrowers who meet the lenders' criteria. For instance, if the product is tangible, the lender may be willing to provide a cheaper rate if the lender has a security interest in the product. The lender also indicates whether they are willing to commit to future financing for an individual based on the individual's current circumstances and financial plan. For instance, an individual who has followed their plan for several years may be considered a lower risk; such that the individual's performance, as verified by a financial planner, can be relied upon in addition to a third party credit score.

In financing database 1278, financing providers 1280 specify whether they will automatically agree to make loans automatically selected by the FPS, such as by selecting from
(a) automatically commit to any loan satisfying lender's criteria, sometimes referred to as “anonymous commitment”,
(b) same as (a) but requires independent confirmation of borrower's information and possibly automated additional information gathering such as a borrower's credit score, (c) commitment to any loan only after manual review or additional information gathering, such as a borrower's credit report (including a credit score), or
(d) automatically commit to loans where borrower meets predefined automatic commitment criteria, require manual review for loans where borrower is outside predefined automatic commitment criteria.

Financing database 1278 also contains financing demand curves created by program 1276.

Financing database 1278 also includes a library of predefined financing strategies, discussed below, that borrowers can indicate their willingness to use.

Financing provider 1280 is a third-party provider of loans, i.e., a lender. Lender 1280 indicates types of loans it is willing to provide along with parameters describing acceptable loans and characteristics of acceptable borrowers.

Utility system 1275 executes program 1276 that stores the descriptions of loans from third-party lenders 1280 in its financing database 1278. It is a single storage point for loan offers from lenders 1280. Via the API supported by program 1276:
lenders 1280 populate financing database 1278 with loan offers;
financial planning servers 1260, 1270 and financial planner 1250 populate reduced client database 1277 with reduced financial plans;
financial planning servers 1260, 1270 and financial planner 1250 query financing database 1278 to find loans that an individual is eligible for;
financial planning servers 1260, 1270 and financial planner 1250 send automatic loan commitments to lenders 1280;
financing demand curves are distributed to lenders 1280; and
new and updated financing offers relevant to existing financial plans are distributed to financial planning servers 1260, 1270 and financial planner 1250.
Financial planning server 1260 is coupled to supplemental financing database 1265.

Supplemental database 1265 is similar to financing database 1278, except that supplemental database includes loan offers available only to customers of financial planning server 1260. These supplemental loan offers may include proprietary loans offered by the owner of server 1260, exclusive loans offered by business partners of the owner of server 1260, and curated loans offered by third parties to customers of the owner of server 1260.

Supplemental financing provider 1267 represents the owner of server 1260, business partners of the owner of server 1260, and third parties offering financing to customers of the owner of server 1260.

For instance, if the owner of server 1260 is Bank of Atlantis, then supplemental database 1265 may include loan offers to customers of Bank of Atlantis at better rates than the loan offers for non-customers in financing database 1278 provided by Bank of Atlantis, acting as a lender 1280.

FIG. 16B shows system setup for the configuration of FIG. 16A.

After the conventional setup activities occur, as shown by the vertical dotted line, at step 1310, financing database 1278 is defined.

At step 1312, a system administrator (not shown) at utility 1275 defines the types of financing. Table 7 shows a sample list of financing types.

TABLE 7
Sample Financing Types FTi

| | |
|---|---|
| 01 | Secured Loan, Property |
| 02 | Secured Loan, Chattel |
| 03 | Unsecured Loan |
| 04 | Income-variable Loan (repayment based on income) |

At step 1314, the system administrator of utility 1275 defines the primary features of each of the financing types, such as description, characteristics, and lifetime in months. Then, lenders 1280 populate financing database 1278 with loan offers, see FIG. 16H.

For example, for financing type 01 Secured Loan, Property, there may be instances as shown in Table 8.

TABLE 8
Sample 01 Secured Loan, Property Instances

| | |
|---|---|
| 01 | 30 year fixed mortgage, conventional, stand-alone |
| | home |
| 02 | 30 year fixed mortgage, conventional, multi-family |
| | home |
| 03 | 30 year fixed mortgage, conventional, condominium |
| 04 | 15 year fixed mortgage, conventional, stand-alone |
| | home |
| 05 | 15 year fixed mortgage, conventional, multi-family |
| | home |
| 06 | 15 year fixed mortgage, conventional, condominium |
| 07 | 30 year fixed mortgage, FHA, stand-alone home |
| 08 | 30 year fixed mortgage, FHA, multi-family home |
| 09 | 30 year fixed mortgage, FHA, condominium |
| 10 | 15 year fixed mortgage, FHA, stand-alone home |
| 10-01 | . . . Bank of America |
| 10-02 | . . . Citibank |
| 10-03 | . . . Wells Fargo Bank |
| 11 | 15 year fixed mortgage, FHA, multi-family home |
| 12 | 15 year fixed mortgage, FHA, condominium |
| 13 | Adjustable mortgage, conventional, stand-alone home |
| 14 | Adjustable mortgage, conventional, multi-family home |
| 15 | Adjustable mortgage, conventional, condominium |
| 16 | Adjustable mortgage, FHA, stand-alone home |
| 17 | Adjustable mortgage, FHA, multi-family home |
| 18 | Adjustable mortgage, FHA, condominium |
| 19 | VA Mortgage |
| 20 | USDA/RHS Mortgage |

In some embodiments, the system administrator defines general instances of a financing type, such as “01-10 15 year fixed mortgage, FHA, stand-alone home”. Then, lender 1280 works with the product supplier to define specific instances corresponding to the supplier's products, such as “01-10-01 Bank of America 15 year fixed mortgage, FHA, stand-alone home”, “01-10-02 Citibank 15 year fixed mortgage, FHA, stand-alone home”, “01-10-03 Wells Fargo Bank 15 year fixed mortgage, FHA, stand-alone home”.

At step 1320, the owner of each financial planning server 1260 populates supplemental financing database 1265, in similar manner as financing database 1278 is populated. The financing offers in supplemental database 1265 may include hypothetical offers, discussed below.

At step 1330, the system administrator of utility server 1275 and/or lenders 1280 populate financing database 1278 with hypothetical financing offers, similar to step S120 of FIG. 16H.

A hypothetical financing offer is a way of testing market acceptance of a new loan product. A hypothetical loan offer can be defined by a system administrator (not shown) of utility system 1275, or by a financing provider. Generally, a hypothetical loan offer is the same as a non-hypothetical loan offer, except that the hypothetical loan offer includes a field showing it is hypothetical. As explained below, if the FPS would have selected the hypothetical loan offer, this event is recorded, then the hypothetical loan offer is marked as temporarily ineligible, forcing the FPS to choose a non-hypothetical loan offer for the financial plan. The event of selecting the hypothetical loan offer is stored in reduced database 1277, so that when financing demand curves are created, the demand for the hypothetical loan can be assessed.

At step 1340, the system administrator of utility server 1275 defines available financing templates. For example, the predefined financing templates may All Cash, Major Purchases, Specified Goal, Private Only and Private Supplemental, as shown in Table 9. Generally, the financing templates specify when a type of financing is acceptable to the user. As explained below, since some types of financing can be combined, as a convenience to the user, the FPS first combines the templates to determine the general financing scenarios, and then selects specific financing offers to create the set of financing scenarios to evaluate for the user.

TABLE 9
Financing Templates for Modified Conventional Financial Planning System

| Short Name | Parameters | Financing Template Description |
|---|---|---|
| All Cash | None | No financing is acceptable. |
| Major | THRESHOLD | Financing acceptable only for purchases exceeding |
| Purchases | | $THRESHOLD |
| Specified | Goal g | Financing is acceptable only for a specified goal (may be |
| Goal | | selected multiple times for multiple goals) |
| Private Only | Various | Only private financing is acceptable with user defined |
| | | parameters |
| Private | Various | Private financing with user defined parameters is acceptable as |
| Additional | | additional to third-party financing; third-party financing |
| | | includes supplemental |

At step 1350, the system administrator of utility server 1275 defines available financial plan acceptability criteria so that FPS 1252, 1262, 1272 will present a financial plan for manual review by the user. In a conventional FPS, success is usually considered to be achieving goals while remaining solvent. For instance, financial plan success can be defined as the financial plan's PDR being less than PDR-Threshold, where PDR-Threshold is a value defined by the user such as 10%.

At step 1360, the system administrator of utility server 1275 defines available lifetime acceptability criteria, also referred to as “financial plan optimality criteria”, so that FPS 1252, 1262, 1272 can model what is important to a user.

For instance, some users may want to maximize the amount of financial wealth (cash and investments) they have at the end of their lives, corresponding to a criteria of “maximize wealth at end of life” even if the user has debt at end of life.

Other users may wish to maximize the value of the goals they achieve during their life, corresponding to criteria of “Maximize Value of Goals Achieved” regardless of debt at end of life.

Other users may wish to achieve only the goals they can afford, corresponding to a criteria of “maximize goals subject to minimizing debt at end of life”.

Other acceptability criteria are possible.

Note that availability of financing can change how many goals are achievable, and can change the value of goals achieved. Examples of lifetime acceptability criteria are shown in Table 10.

TABLE 10
Optimality (lifetime acceptability) criteria, Modified Conventional FPS

| Short Name | Parameters | Lifetime Acceptability Criteria Description |
|---|---|---|
| Max ending wealth | BT-Threshold | B[T] must exceed BT-Threshold |
| Max no. goals | GoalNo-Threshold | The number of goals achieved must be at least |
| | | GoalNo-Threshold |
| Max goal value | — | Maximize SUM(goal values) |
| Minimize PDR | — | Choose the financial plan with the lowest PDR |

For instance, if a user specifies GoalNo-Threshold=3 at step 1440 of FIG. 16C, system 2500 will require that the user's financial plan achieves at least three goals.

Note that financial plan acceptability criteria of PDR<PDR-Threshold defines a ceiling on the acceptable PDR, thereby defining which financial plans are eligible, while optimality criteria of Minimize PDR results in choosing the eligible financial plan with the lowest PDR.

FIG. 16C shows user setup for modified conventional software 1252, 1262, 1272; this figure is similar to FIG. 3C and for brevity, only differences are discussed. FPS 1252, 1262, 1272 perform all steps of FIG. 16C, except for step 1450.

For convenience, the following description refers to “software 1252, 1262, 1272” in the sense that each of software 1252, 1262, 1272 is capable of executing the functions as described, but only the one of software 1252, 1262, 1272 associated with the user actually executes the functions as described.

At step 1401, software 1252, 1262, 1272 assigns a unique ID tag to the user, intended to be unique across FIG. 16A. The user's reduced (anonymized) FP is stored with this unique ID tag (see step 1585 of FIG. 16D) so that a new financing offer, motivated by a financing demand curve based on reduced client database 1277 and relevant to this user, can be sent to this user while maintaining the user's anonymity (see step 1865 of FIG. 16G).

After conventional steps 1405, 1410, 1415, at step 1425, the user defines private financing available to that user, and the order of selecting financing. Private financing represents gifts or loans that friends and family members, and possibly employers, are willing to provide to a user. Usually, the terms of private financing, such as rate and repayment flexibility, are much better for a user than the terms of third-party financing, so it is preferable to use private financing before third party financing. Private financing is defined similarly to the parameterized descriptions of loans of each financing provider 1280 defined at step 1310 of FIG. 16B and stored in financing library 1278, except that private financing is stored in client info 1253, 1263, 1273 in association with the user's profile.

The default order of selecting financing for software 1252, 1262, 1272, assuming that all other characteristics of the financing are equal, in order of preference, is: private, supplemental, hypothetical, third-party. The user can change this ordering.

At step 1430, the user selects acceptable financing templates from the financing templates defined at step 1340 of FIG. 16B.

At step 1435, the user selects financial plan acceptability criteria from the available criteria defined at step 1350 of FIG. 16B, used at step 1630 of FIG. 16E At step 1440, the user selects from among the available lifetime criteria defined at step 1360 of FIG. 16B, used at step 1670 of FIG. 16E.

At step 1445, the user decides whether to opt into automatic loan approval. Software 1252, 1262, 1272 has a default of no automatic loan approval, which can be changed by the user.

Step 1450, providing a general research interface, is shown with dotted lines to indicate that it is optional, and is performed by utility program 1276, with software 1252, 1262, 1272 merely routing traffic between the user and utility program 1276.

The general research interface is typically a graphical user interface (GUI) that presents a start page with a menu such as in Table 11.

TABLE 11
General Research GUI, Modified Conventional FPS, Financing
General Research

Help
Data structure of financing offers
Statistics for financing offers
Lender information
Financing offers

The user can access the General Research GUI after s/he has sufficiently provided registration information. The General Research GUI is a user-friendly way to browse the contents of financing database 1278. The user positions his/her cursor over an item on the start page and clicks on it, to get to another page. The menu items function as follows:
Help—provides information on how to use the General Research GUI;
Data structure of financing offers—lets the user browse the financing structure defined in step 1310 of FIG. 16B, to get a map of the information available at the “Financing offers” menu item;
Statistics for financing offers—lets the user see statistics for commensurate financing offers in financing database 1278. For each type of financing (home mortgage, car, college, general secured, general un-secured etc.), statistics can be viewed such as:
   number of financing offers in financing database 1278,
   interest rate: average, median, minimum, maximum,
   term (maximum time periods): average, median, minimum, maximum,
   maximum loan amount: average, median, minimum, maximum,
   minimum borrower credit score: average, median, minimum, maximum,
   maximum borrower PDR: average, median, minimum, maximum.
Lender information—lets the user browse user-visible marketing information about financing providers 1280 optionally provided by the financing providers 1280 in financing database 1278, when the lenders registered as financing providers 1280 (see FIG. 16H step S110). Typically, financing provider 1280 populates its user-visible marketing information when it is prepared to communicate directly with users, such as to provide more details about its financing offers or, on a case-by-case basis, consider whether to extend its financing offer to a user that does not meet its customer criteria in database 1278;
Financing offers—lets the user browse the financing offers available in financing database 1278, which software 1252, 1262, 1272 can select among for the user. Typically, the user quickly gets overwhelmed in trying to manually compare the financing offers, and is then far more appreciative of the convenience of using software 1252, 1262, 1272. Generally, the user selects a financing type from among the financing types specified at step 1312 of FIG. 16B, then selects values or value ranges for the financing characteristics defined at step 1314 of FIG. 16B, and utility program 1276 responds with the financing instances, of the types defined at step 1316 of FIG. 16B.

Conventional FPS often provide an interactive interface for the user including the ability to query additional set-up information and view the set-up information provided by the user, but these interfaces vary among FPS and are outside the scope of this invention. The API for utility system 1275 accommodates receiving queries directly from a user of FPS 1250, 1260, 1270, and receiving queries from FPS 1250, 1260, 1270 so that FPS 1250, 1260, 1270 can provide an integrated GUI to the user, if the maker of FPS 1250, 1260, 1270 so desires.

FIG. 16D shows operation of software 1252, 1262, 1272; this figure is similar to FIG. 3D and for brevity, only differences are discussed.

After the SIR[n,t,v] values are generated at step 1520, at step 1530, software 1252, 1262, 1272 determines the acceptable financing scenarios based on the user's selections of acceptable financing templates at step 1430 of FIG. 16C. The terms of each financing offer include a maximum loan amount, and creating the set of financing scenarios includes selecting the loan amounts in each of the financing scenarios. The third use case, below, shows an example of determining financing scenarios.

One financing template may correspond to several suitable financing offers. So, software 1252, 1262, 1272 combines the templates as appropriate to create different structures for financing scenarios. Cash-only financing is always evaluated as the first financing scenario. This step is necessary because the user is permitted to select multiple financing templates. In embodiments where the user is permitted to select only one financing template, this step is not needed, but the set of eligible financing templates is much larger.

Then, software 1252, 1262, 1272 evaluates specific financing offers according to the structures of the financing scenarios. The borrower criteria for each financing offer are examined, and the financing offer is discarded if the borrower does not meet the borrower criteria; retention of only financing offers that the borrower is eligible for is akin to “credit pre-approval”. The acceptable financing scenarios are the user-eligible financing offers that satisfy the user's financing templates.

In some embodiments, software 1252, 1262, 1272 adjusts the user's financial plan acceptability threshold, PDR-Threshold define at step 1435 of FIG. 16C, so that the user's PDR meets the lender's borrower criteria. Continuing with the example of Table 9, assume that at step 1430, the user selected the following as acceptable templates: All Cash, Major Purchases, Private Only and Private Additional. At step 1530, software 1252, 1262, 1272 determines that there are five financing scenarios, F=5:
(1) all cash scenario, corresponding to “All Cash” template,
(2) third-party provides financing for major purchases scenario, corresponding to “Major Purchases” template,
(3) only private financing scenario, corresponding to “Private Only” template,
(4) third-party financing plus private financing scenario, corresponding to “Private Additional” template, and
(5) supplemental financing plus private financing scenario, corresponding to “Private Additional” template.
   In particular, note that the selection of “Private Additional” generated two financing scenarios (4) and (5).

Step 1535 causes an iteration of software 1252, 1262, 1272 for each financing scenario to create an Iteration Plan, also referred to as a “draft financial plan” (draft FP), then selects the Iteration Plan in accordance with the lifetime (optimality) criteria selected by the user at step 1440 in FIG. 16C. Step 1535 is shown in detail in FIG. 16E.

As an example of the first technique of scenario evaluation, when there are five financing templates as above, the first All Cash template results in the first Iteration Plan being substantially the same as the financial plan resulting from the conventional financial planning system; differences may occur from setting I[k] and wI[k] automatically instead of manually, i.e., the financing strategy can affect the investment strategy.

For the second template, Major Purchases, assume that the user specified the THRESHOLD parameter for major purchases as $20,000, and that the only user goals exceeding $20,000 are a house and a car. Software 1252, 1262, 1272 searches for the best (lowest rate) third party financing for the house, then searches for the best (lowest rate) third-party financing for a car. Software 1252, 1262, 1272 then adjusts the user's goals to reduce Goal Value G$[g,f] by the financed amount, and increase Goal cash flow per month GCF[t,g,f] by the loan repayment amounts. Then, with the adjusted goals, the best financial plan is determined in the conventional way as the second Iteration Plan.

In some embodiments, instead of selecting the best financing as simply the lowest rate, software 1252, 1262, 1272 first selects the different loan terms, then selects the best financing for each loan term, then creates additional strategies such as Major Purchases with 5 year loan, Major Purchases with 10 year loan, Major Purchases with 30 year loan. This illustrates how a financing strategy gives rise to multiple financing scenarios.

In some embodiments, software 1252, 1262, 1272 considers the best overall financing, for instance, if a user has a car loan, the user may not qualify for a mortgage.

For the third template, Private Only, software 1252, 1262, 1272 determines which goals have private financing available, and adjusts their G$[g,f] and GCF[t,g,f] parameters as above. Then, with the adjusted goals, the best financial plan is determined in the conventional way as the third Iteration Plan.

For the fourth template, Third-Party with Private Additional, software 1252, 1262, 1272 first adjusts the goal values and cash flow to reflect private financing, as above, then searches for the best third party financing for the house, then searches for the best third-party financing for a car, and again adjusts the goal values and cash flow to additionally reflect third-party financing. Then, with the fully adjusted goals, the best financial plan is determined in the conventional way as the fourth Iteration Plan.

For the fifth template, Supplemental with Private Additional, only software 1262 can execute this, because only software 1262 has access to supplemental financing 1265. Software 1262 first adjust the goal values and cash flow to reflect private financing, as above, then searches for the best supplemental financing for the house, then searches for the best supplemental financing for a car, and again adjusts the goal values and cash flow to reflect supplemental financing. Then, with the fully adjusted goals, the best financial plan is determined in the conventional way as the fifth Iteration Plan.

At the end of step 1535, software 1252, 1262, 1272 compares the five Iteration Plans and selects the best according to the user's lifetime (optimality) criteria.

If the second technique of scenario evaluation was used, the first financing scenario (all cash) translates to one financing scenario, while the other financing scenarios can each translate to multiple scenarios depending on the number of suitable stored financing offers.

In another embodiment, instead of comparing all Iteration Plans, software 1252, 1262, 1272 determines the first Iteration Plan and sets that to be the best Iteration Plan. After determining each subsequent Iteration Plan, software 1252, 1262, 1272 sets that to be the best Iteration Plan only if the new Iteration Plan is an improvement over the existing best Iteration Plan.

The modified conventional financial planning system described above operates in a generally iterative manner.

At step 1540, software 1252, 1262, 1272 presents the financial plan, i.e., the selected Iteration Plan, to the user for a manual determination of acceptability as at step 285 of FIG. 3D. Users accustomed to manually inspecting conventional financial plans can continue to interact with software 1252, 1262, 1272 in a way they are used to. In some embodiments, the user can examine the set of financing scenarios generated at step 1530 and their associated PDRs as determined at step 1625. If acceptable, processing proceeds to step 1550.

If the Iteration Plan is not acceptable, or if there was no acceptable Iteration Plan, at step 1545, the user manually revises his/her goals, financing strategy and/or acceptability criteria, and processing returns to step 1530.

Steps 1550 and 1560 operate conventionally, corresponding to steps 290 and 295 of FIG. 3D.

At step 1570, software 1252, 1262, 1272 determines whether to automatically commit to a loan, as shown in detail in FIG. 16F.

At step 1580, software 1252, 1262, 1272 updates the individual's financial plan, if needed, and stores it in client database 1253, 1263, 1273, respectively.

At step 1585, software 1252, 1262, 1272 stores a reduced (anonymized) form of the financial plan in reduced client database 1277 with the unique ID tag assigned at step 1401 of FIG. 16C.

FIG. 16E shows details of determining a financial plan for the modified conventional financial planning system with automatically selected financing, partially corresponding to FIG. 3D. An Iteration Plan, also referred to as a draft FP, is a tentative financial plan corresponding to a possible financing scenario. The best of the Iteration Plans is automatically chosen as the financial plan in accordance with the user's optimality criteria.

At step 1600, software 1252, 1262, 1272 receives and stores manually set investments I[k] and investment weights wI[k] as a trial financial plan, corresponding to step 260 of FIG. 3D.

At step 1605, software 1252, 1262, 1272 selects the first financing scenario determined at step 1530 of FIG. 16D, typically, all cash (no financing).

At step 1610, software 1252, 1262, 1272 adjusts the user's goals to reflect the financing, if any. For financing scenario f=1, all cash, no adjustment occurs.

Typically, the MCFPS determines an interest rate at the start of the financing, and uses that same rate throughout the term of the financing. In contrast, the MBFPS, discussed below, automatically determines a variable interest rate at the proper time in each simulation.

Step 1615 corresponds to step 270 of FIG. 3D.

Step 1620 corresponds to step 275 of FIG. 3D, except that the calculated items depend on the financing scenario.

Step 1625 corresponds to step 280 of FIG. 3D, except that the predicted default rate is also calculated at step 1625 according to Equation 22.

At step 1630, software 1252, 1262, 1272 evaluates the draft FP using the acceptability criteria selected by the user at step 1435 of FIG. 16C, such as PDR<PDR-Threshold. Software 1252, 1262, 1273 also double-checks that, for any financing in the draft FP, the user satisfies the lender's criteria for borrowers. Step 1630 is a test that automatically determines whether an Iteration Plan corresponding to financing scenario f is minimally acceptable. If the Iteration Plan is minimally acceptable, processing proceeds to step 1650.

If the Iteration Plan was not minimally acceptable, at step 1635, software 1252, 1262, 1272 determines whether the investment weights wI[k] can be adjusted. Generally, adjustment can occur at the first execution of step 1635, but after repeated executions, adjustment may not be possible. If adjustment is not possible, processing proceeds to step 1645.

At step 1640, software 1252, 1262, 1272 uses a suitable adjustment technique such as varying investment weights wI[k] between 0 and 1 using an optimization procedure as taught in Chapter 10 of Numerical Recipes: The Art of Scientific Computing, 3rd edition, Press et al., Cambridge University Press, 2007, pages 487-562. Generally, software 1252, 1262, 1272 does not automatically vary the investments I[k] selected in step 1600, but in some embodiments, the software can automatically vary the investments if there are similar risk-level other investments I[k] available. Processing returns to step 1615.

At step 1645, software 1252, 1262, 1272 determines that no draft FP can be created for this financing scenario, and processing proceeds to step 1655.

At step 1650, software 1252, 1262, 1272 stores the investments I[k], the investment weights wI[k], the ending wealth B[n,T,f] for n=1 . . . N, the goals success likelihood (GSL) and the PDR as the Iteration Plan for this financing scenario.

At step 1655, software 1252, 1262, 1272 checks whether this financing scenario is the last financing scenario F. If so, processing proceeds to step 1670.

If this was not the last financing scenario F, at step 1660, software 1252, 1262, 1272 increments to the next financing scenario f.

At step 1665, software 1252, 1262, 1272 resets to the Trial Financial Plan specified at step 1600, and processing continues at step 1610.

At step 1670, software 1252, 1262, 1272 selects the financial plan from among the eligible Iteration Plans based on the lifetime (optimality) criteria specified at step 1440 of FIG. 16C. Step 1670 is a test that automatically determines which Iteration Plan (draft FP) is best. At the first execution of step 1670, the Iteration Plan, for each financing scenario that produced an Iteration Plan, is considered eligible. If multiple Iteration Plans equally satisfy the lifetime (optimality) criteria, then software 1252, 1262, 1272 selects the one of the equally optimal Iteration Plans with the maximum expected final wealth B[.]. Other secondary lifetime criteria, used for tie-breaking, are also possible, such as minimum PDR or maximum default-risk-adjusted expected final wealth B[.] *(1−PDR).

At step 1675, software 1252, 1262, 1272 checks whether the selected Iteration Plan includes hypothetical financing. If not, processing is complete, and the selected Iteration Plan is deemed to be the chosen financial plan.

If the selected Iteration Plan includes hypothetical financing, then at step 1680, software 1252, 1262, 1272 stores the event that hypothetical financing was selected in reduced client database 1277. This event is valuable information, it shows that the hypothetical financing offer would be useful to this individual. The event of selecting a hypothetical offer is akin to an automated focus group approval. It will be appreciated that hypothetical offers are a quick and inexpensive way to get reliable sales projections for the hypothetical financing.

At step 1685, software 1252, 1262, 1272 marks this Iteration Plan as ineligible because it contains an ineligible (hypothetical) financing offer, and processing returns to step 1670 to select the next-best among the eligible Iteration Plans.

In a variation, instead of returning directly to step 1670, processing flags the hypothetical financing as ineligible, recalculates the financing scenario based on other available financing, if any, and returns to step 1670 with a different Iteration Plan for financing scenario f.

FIG. 16F shows automated loan commitment processing for the modified conventional financial planning system with automatically selected financing

At step 1710, software 1252, 1262, 1272 checks whether the user and the lender have both authorized automatic loan commitment. If no, processing continues at step 1725.

If the user and lender have authorized automated loan commitment, at step 1720, software 1252, 1262, 1272 sends loan commitments to the appropriate lenders (see FIG. 16I step S250), and processing is complete.

In some embodiments, a loan commitment specifies how binding it is, depending on the preferences of the lender and borrower. Loan commitment “binding-ness” is one of the financing characteristics, see step 1314 of FIG. 16B. For instance, a loan commitment can be in one of three “binding-ness” flavors:
indication of interest—the lender can stop offering this type of loan at any time, and the borrower can change his/her mind at any time;
most favored nation—the lender will give the borrower at least thirty days notice if it decides to stop offering this loan, and the borrower will give the lender at least fifteen days to match a better financing offer from another lender;
binding—the lender and the borrower each agree to a financial penalty if they will not enter into the loan.
   When a lender creates a loan offer at step S120 of FIG. 16H, the lender can specify acceptable commitment “binding-ness” flavors. When an individual receives a new loan offer, such as at bubble “AA” in FIG. 16D that came from step 1865 in FIG. 16G, software 1252, 1262, 1272 considers the “binding-ness” of the existing loan in deciding whether to replace (refinance) the existing loan with the new loan.

If the lender has authorized automated loan commitment, but the user has not authorized automated loan commitment, at step 1725, software 1252, 1262, 1272 asks the user if s/he wishes to commit to a selected loan, and receives the user's response.

At step 1730, software 1252, 1262, 1272 checks whether the user has approved committing to the loan. If not, processing is complete. If the user has approved, processing proceeds to step 1720.

FIG. 16G shows creation of financing demand curves for the modified conventional financial planning system with automatically selected financing.

At step 1810, utility program 1276 checks whether it is time to create loan demand curves, such as by comparing a timer of the current elapsed time t elapsed to a threshold T_threshold. If it is not yet time, utility program keeps checking while utility program 1276 keeps incrementing t elapsed as time passes. Eventually, it will be time, and processing proceeds to step 1815.

At step 1815, for each type of loan, as defined at step 1314 of FIG. 16B, at step 1820, utility program 1276 retrieves the financial plans from reduced storage 1277 that include this type of loan and also retrieves the events where hypothetical loans of this type would have been chosen. These financial plans can be depicted in a chart as in FIG. 15A.

At step 1830, utility program 1276 then constructs a loan demand curve, as in FIG. 15B, based on the retrieved financial plans. Generally, utility program 1276 creates the following loan demand curves and distributes as follows:
Without hypotheticals (based only on actual FP information), distributed to all lenders 1280;
Hypotheticals defined by system administrator of utility system 1275, distributed to all lenders 1280; and
Hypotheticals defined by a specific lender 1280, distributed only to the lender that created the hypotheticals.
   Comparing a hypothetical offer with the non-hypothetical offers lets a lender quickly determine how popular the hypothetical offer would be. This is an extremely quick and inexpensive form of market research for a lender.

At step 1835, utility program 1276 sends the various types of loan demand curves to those of lenders 1280 that either offer this type of loan, or have indicated interest in offering this type of loan, see FIG. 16I step S260.

If an entity offering supplemental financing, such as the owner of FPS 1260, wishes to see the loan demand curves for third-party loans, it must register as an instance of lender 1280 and indicate interest in offering this type of loan.

At step 1855, utility program 1276 receives the revised and new loan products, if any, see FIG. 16I step S280.

At step 1860, utility program 1276 updates financing database 1278 with the revised or new loan products.

At step 1865, utility program 1276 notifies the software, selected from software 1253, 1263, 1273, associated with the relevant financial plans, i.e., the financial plans retrieved at step 1820, of the revised or new loan terms. FIG. 16D indicates that, at step 1530, the notice from step 1865 causes software 1263, 1263, 1273 to revise an existing financing scenario or determine a new financing scenario, and if appropriate, at step 1580, update the financial plan.

At step 1870, utility program 1276 sets the timer t elapsed to zero, and processing returns to step 1810.

In some embodiments, software 1262 executes steps 1810, 1815, 1845, 1860, 1865, 1870 for the financial plans in client database 1263, to produce supplemental loan demand curves for its customers. These supplemental loan demand curves are proprietary to the owner of FPS 1260.

FIG. 16H shows setup for lender 1280.

At step S100, lender 1280 opens an account with utility system 1275, provides contact information and demonstrates its authorization to act as a lender (if needed), along with optional information such as the total amount and/or number of loans it is willing to make via system 1275, the total daily amount and/or number of loans it is willing to make via system 1275.

At step S110, lender 1280 provides user-visible marketing information, such as address, customer service telephone number, and why a user should feel comfortable getting a loan from lender 1280. Lender 1280 can also designate some or all of the information it provides at step S120 as being user-visible.

At step S130, for each financing instance (loan offer), lender 1280 defines its features, such as description, product (goal) applicability and required customer characteristics. Customer characteristics are selected from:
information maintained by FPS 1250, 1260, 1270 for each customer, such as income and assets,
information computed by FPS 1250, 1260, 1270 for each customer, such as percent of income devoted to other loan payments, and predicted default rate (FIG. 16E step 1625);
and
information that lender 1280 obtains from information service 40, such as a FICO score.

In embodiments where the FPS permits identification of its user via the API with utility system 1275, system 1275 can obtain this third-party information on behalf of lender 1280.

At step S130, lender 1280 can optionally opt into automatic loan approval for loans where borrowers meet all its criteria, and the loans are within the daily and lifetime limits, if any, defined at step S100. In some embodiments, automatic loan approval can be conditioned on additional information, such as different thresholds for customer characteristics. For example, a lender may be willing to lend to someone with an income of at least $30,000, and be willing to automatically lend to someone having (income—other loan payments) of at least $100,000.

FIG. 16I shows operation for lender 1280.

At step S210, lender 2180 can modify the information it provided at step S100 of FIG. 16H.

At step S210, lender 2180 can modify the information it provided at step S110 of FIG. 16H.

At step S230, lender 2180 can add a new loan product. When this occurs, system 1275 automatically distributes (not shown) information about this new loan product to users whose financial plans include a similar type of loan, similar to step 1865 of FIG. 16G.

At step S240, lender 2180 can amend the terms of an existing loan product or delete the loan product entirely. When this occurs, system 1275 automatically distributes (not shown) information about this new loan product to users whose financial plans include this loan product, similar to step 1865 of FIG. 16G.

At step S250, if lender 1280 has opted into automatic loan approval at step S130 of FIG. 16H, system 1275 informs lender 1280 that lender 1280 has just agreed to make a loan (see FIG. 16F step 1720).

At step S260, the appropriate ones of lender 1280 receive the loan demand curve from utility program 1276 at step 1835 of FIG. 16G.

At step S270, each lender 1280 decides whether to offer revised or new loan products based on the loan demand curve. Usually, a loan manager employed by lender 1280 reviews the loan demand curve, and decides how to respond.

At step 1850, if lender 1280 has decided to offer a revised or new loan product, lender 1280 sends the loan product terms to utility program 1276 at step 1855 of FIG. 16G. Or, lender 1280 can separately offer revised or new loan products via steps S230 and S240.

U.S. Pat. No. 7,366,694 (Lazerson) discloses a computer system that receives a borrower's personal and financial information, and reasons for wanting a loan, and also receives and stores loan package data from lenders. Lazerson calculates a borrower credit grading distinct from a credit score, and presents a spreadsheet-like display of suitable loans, and possibly products and services relevant to the purpose of the loan. Telling the borrower of his/her credit grading reduces the chances that the borrower will be taken advantage of by a predatory lender.

Lazerson was invalidated as reciting patent-ineligible claims in Mortgage Grader, Inc. v. First Choice Loan Services Inc., 811 F.3d 1314, 117 USPQ.2d 1693 (Fed. Cir. 2016). The Court held that the claims were directed to the abstract idea of “anonymous loan shopping”, and recited steps that could be performed entirely in the human mind, thus reciting a basic tool of technological work that cannot be reserved exclusively via a patent claim. The Court said that the claims lacked an “inventive concept”, merely reciting generic computer components such as an “interface”.

The invention of FIG. 16 cannot practically be performed entirely in the human mind due to the need for simulation of a user's financial future in a statistically significant way, that is, requiring at least about 100 simulations of different possible financial futures.

The invention of FIG. 16 does not monopolize the abstract idea of loan shopping, because it is limited to automatic selection within the context of a financial plan. Further, the invention of FIG. 16 relies on a specific technique involving acceptability criteria and optimality criteria; other techniques are possible, showing that the invention of FIG. 16 presents a specific way to improve financial planning technology, and other ways are possible.

The embodiment of FIG. 16 provides at least the following advantages to a borrower, relative to a conventional financial planning system:
automatically evaluating financing for the user's financial plan, i.e., improving financial planning technology, often enables the user to achieve more goals than is possible if only savings are available, to achieve goals sooner during their life, and/or to afford better goals;
using financial plan criteria for loan evaluation, i.e., improving loan selection technology, such as an acceptability test (e.g., maximum PDR), and an optimality test (e.g., lifetime criteria), is an inventive concept that improves the suitability of a loan for the user's life relative to just picking the cheapest loan among loan offers with different terms;
enabling the user to lock-in special financing deals by determining when they are useful for the user's goals;
enabling the user to specify private financing available only to that user, that can be combined with third-party financing, enables the financial plan to better model the user's reality, i.e., helpful family, friends and/or employer;
automatically choosing the amount of financing consistent with (i) the amount of the goal, (ii) the amount the lender is willing to lend per loan and based on borrower characteristics, and (iii) different types of financing available to the user, saves the user from a lot of analysis work;
comparing financial plans based on different financing, according to user-specified criteria, is more meaningful for a user than merely comparing terms of different financing offers, because obtaining financing is a means to achieving a user's goal, that is, obtaining financing in isolation is never a user's goal.

The invention of FIG. 16 provides at least the following advantages to a lender, relative to a conventional financial planning system:
making the lender's products available via a financial planning system exposes the lender's products to a larger market, specifically, people who lack sufficient numerical literacy and sophistication to know how and when to use financing;
enabling a lender to be a third-party lender for all users, and/or a supplemental lender for users associated with a financial planning system, lets the lender control its distribution channels;
using predicted default rate of borrower financial plans to evaluate borrower desirability efficiently provides a lender with future information about potential borrowers, thus reducing the risk of lending to borrowers, and increasing the market size of eligible borrowers beyond the market defined by historical information such as credit score;
lender can better forecast demand by offering lock-in terms (commit now, for use within a predetermined future time range);
loan demand curves representing aggregate demand for financing spur and/or justify product innovation;
hypothetical loan offers are an economical way to do market research.

Section 2. Modified Benchmark Financial Planning System with Financing

FIG. 17A shows the system of FIG. 5 modified to choose the best financing for a FS. For brevity, only differences between FIG. 17A and FIG. 5 are discussed.

User 2001 is an individual who uses FPS 2020 directly, such as via a smartphone or computer.

Financing provider 2005 is similar to financing provider 1280 of FIG. 16A, discussed above.

Financing library 2027 is similar to financing library 1278 of FIG. 16A, discussed above.

Reduced client database 2025 is similar to reduced client database 1277 of FIG. 16A, discussed above.

Supplemental financing provider 2086 is similar to supplemental financing provider 1267 of FIG. 16A, discussed above.

Supplemental financing database 2085 is similar to supplemental financing database 1265 of FIG. 16A, discussed above.

Modified conventional financial planning system 2015 represents financial planning systems 1250, 1260, 1270 of FIG. 16A, discussed above.

FPS 2020 includes the functions of system 500 of FIG. 5, and the functions of utility system 1275 of FIG. 16A.

Benchmark FPS program 2021 is used by user 2010, and provides a modified benchmark financial planning system thereto.

Benchmark utility program 2022 is used by FPS 2050, 2060, 2080 in similar manner as utility program 1276 of FIG. 16A is used by FPS 1250, 1260, 1270. However, the API is somewhat different as a FS has more detail than a FP. Benchmark utility program is also used by financing provider 2005 to populate financing database 2027.

Conventional utility program 2023 is used by modified conventional financial planning systems 2015, and corresponds to utility program 1276 of FIG. 16A, discussed above. Program 2023 makes financing database 2027 available to modified conventional FPS 2015.

In other embodiments, the utility functions of system 2020 operate in a separate system than the benchmark FPS functions of system 2020.

FIG. 17B shows the setup for the configuration of FIG. 17A; this figure is similar to FIG. 9 and for brevity, only differences are discussed.

At step 2100, a system administrator of system 2020 selects the time period that system 2500 will use for simulation, usually monthly, but weekly, biweekly, quarterly, semi-annually and annually are also possible.

Steps 2105, 2110, 2115 are similar to steps 700, 710, 715 of FIG. 9, discussed above.

Steps 2118, 2120, 2130, 2140 are similar to steps 1310, 1320, 1330, 1340 of FIG. 16B, discussed above.

At step 2118, the financing offers may be based on the future market rates simulated at step 2310 of FIG. 17D.

Note that there is no need for a step corresponding to step 1350 of FIG. 16B, “define financial plan acceptability criteria”, because the acceptability for the benchmark system is based on suitable periodic decision criteria such as but not limited to comparing current wealth with a benchmark curve.

At step 2150, the system administrator of FPS 2020 (not shown) defines available FS periodic acceptability criteria for the period defined at step 2100, to assist in modeling what is important to a user. The FS periodic acceptability criteria are similar to the FP acceptability criteria of FIG. 16B step 1350, but are evaluated at each period of the FS, instead of for the FP as a whole. In some embodiments, the FS periodic acceptability criteria can change during the FS, as the user's interests change, such as appetite for risk. In this embodiment, only one FS periodic acceptability criteria can be selected, but in other embodiments, multiple FS periodic acceptability criteria can be simultaneously selected. Examples of FS periodic acceptability criteria are shown in Table 12.

TABLE 12
Financial strategy periodic acceptability criteria

| Short Name | Parameters | Description |
|---|---|---|
| None | — | Rely on the benchmark curve alone, do not eliminate |
| | | any financing scenarios |
| Liquidity cushion | m | Require cash cushion of m months of expenses, with |
| | | expenses based on average for current and previous |
| | | years |
| Loan affordability | fp | Sum of user's loan payments must be less than fp % of |
| v. paycheck | | user's monthly paycheck |
| Loan affordability | fa | Sum of user's loan payments must be less than fa % of |
| v. disposable | | user's entire annual income less housing payments, if |
| income | | any |
| Minimum savings | sp | User's savings from income must be at least sp % of |
| percent | | user's income |
| Minimum savings | sam | User's savings from income per month must be at |
| amount per month | | least sam |

For instance, if a user selects (liquidity cushion, m=12), system 2020 will require that the user's FS has at least 12 months of expenses available as cash.

At step 2160, a system administrator of system 2020 defines different criteria that are available to select a FS financing scenario af* as the best of several acceptable scenarios. This step is akin to step 1360 of FIG. 16B, “define FP optimality criteria”, except that the af* criteria are applied by time period while the optimality criteria are applied to an entire FP. For example, the following criteria may be available:
Maximize Current Wealth—select the scenario af for which B[n,t,af] is maximum. This choice will select the least-cost goal or sub-goal;
Maximize Goal Value—select the scenario af for which the goal-value is maximum, B[n,t,af] exceeds the benchmark curve, and if there is a tie, maximize B[n,t,f]. This choice will show which sub-goals are possibly affordable.
   Other criteria may be defined. Note that the af* criteria enables selection of the best financing for the user's FS, which is more meaningful than comparing financing offers in isolation of the user's circumstances, and without regard to using multiple financing offers to achieve a goal.

FIG. 17C shows the user registration for system 2500; this figure is similar to FIG. 10 and for brevity, only differences are discussed. Steps 2220-2240 of FIG. 17C are similar to steps 720-740 of FIG. 10. The steps of FIG. 17C are performed by the appropriate one of benchmark FPS program 2021 of system 2020, financial planner 2050, financial planning server 2060 and financial planning server 2080 (henceforth collectively referred to as “FPS 2021”), except for step 2299.

At step 2201, FPS 2021 assigns a unique ID tag to the user, for use in the reduced FS.

At step 2245, the user selects FS acceptability criteria: a success of financial strategy threshold (SFS-TH), and success weights SWeightp for each priority level p=1 P, used to automatically determine whether a FS is acceptable. The success weights must sum to 1.0. For example, if the user has only high and low priority goals, then SWeight_high+SWeight low=1. At FIG. 16D step 1540, the MCFPS relies on the user to manually determine whether to accept a FP, while at FIG. 17D step 2370, the MBFPS uses SFS-TH and SWeightp to automatically determine whether to accept a FS.

Steps 2250-2270 of FIG. 17C are similar to steps 750-770 of FIG. 10.

Steps 2275, 2280 are similar to steps 1425, 1430 of FIG. 16C, discussed above. Private financing may be defined with repayments based on one of the market rates simulated at FIG. 17D step 2310.

At step 2285, the user selects from among the available FS periodic acceptability criteria defined at step 2150 of FIG. 17B and provides parameters as needed.

At step 2290, the user selects from among the available FS scenario-best criteria defined at step 2160 of FIG. 17B.

Step 2295 is similar to step 1445 of FIG. 16C, discussed above. Note that loans that the user might wish to commit to prior to when they are needed according to the user's FS, such as to obtain an improved rate available only for a limited time, require the user to manually commit, i.e., such loans cannot be automatically approved. Automatic commitment applies only to loans without acceptance time constraints, see step 2380 of FIG. 17D.

At step 2297, the user selects whether s/he wants to be advised of loan prepayment opportunities, and if so, selects a threshold PPAY-TH. See FIG. 17G step 2630.

Step 2299 is performed by benchmark utility program 2022 or modified conventional utility program 2023, and is similar to step 1450 of FIG. 16C, except that the “More data structure” and “Your financial plan set-up information” from the Personal Research GUI of step 2372 of FIG. 17D is also available in the General Research GUI of step 2299.

FIG. 17D shows the operation of FPS 2021; this figure is similar to FIG. 11A and for brevity, only differences are discussed.

Step 2310 corresponds to step 810 of FIG. 11A. As at step 810, at step 2310, for each time period, the market rates for future times are projected using the Monte Carlo simulations created at this step. The market rates m=1 M correspond to respective rates typically used in finance, such as the Fed Funds rate, inflation, the US 5 year borrowing rate, the US 10 year borrowing rate, the Prime rate, or the 11th District Cost of Fund Index (COFI). For the third party financing offers in financing database 2027 and the supplemental financing offers in supplemental financing database 2085, all the reference rates, such as the Prime rate, are simulated so that the effects of loan repayments depending on these rates can be estimated at FIG. 17F step 2515.

Step 2320, determining the benchmark, is shown in FIG. 17E.

Step 2345, determine available financing scenarios, uses the financing templates selected at step 2280 of FIG. 17C, and the financing offers stored in financing database 2027, to generate suitable financing scenarios of =1 . . . AF. These financing scenarios are used at step 2515 of FIG. 17F. This step is generally similar to step 1530 of FIG. 16D. Note that because the benchmark FPS permits variability in goal timing and value, one goal may correspond to several financing scenarios. For example, a goal that has value variability corresponds to sub-goals having respective values. The financing of each sub-goal is a separate scenario. The fourth use case below provides an example of how two financing templates and five financing offers result in multiple financing scenarios.

At step 2350, evaluation of a sub-goal in the (n, t, p, s) innermost loop is shown in FIG. 17F. Period income INC[t] and period expenses EXP[t] include the financing, if any, incorporated in the FS at FIG. 17F step 2560.

At step 2360, the goal success likelihood GSL_pfor each goal priority level p is determined, and the date-aware PDR is determined according to Equation 23. Consistent with FIG. 10 step 745, GSL_p is the likelihood over all simulations that the wealth at the last simulation period T exceeds the benchmark for that priority level, see Equation 15A, a modified form of Equation 15 that shows a variation of the BFPS acceptability test, where the function 1(·) has value 1 if true and 0 if false:

$$GSL\_p = \frac{1}{N} * {\sum }_{n = 1}^{N} 1 ( B [ n , T ] > Benchmark\_p ) \qquad ( equation 15 A )$$

At step 2370, FPS 2021 determines whether the FS is acceptable by comparing the success of a financial strategy (SFS) metric with the threshold SFS-TH defined at step 2245 of FIG. 17C, i.e., checks whether SFS>SFS-TH, where SFS is the weighted average of the GSL for the goals at each priority level p=1 . . . P, with the weight depending on the priority level, as shown in Equation 24.

$$SFS = {{\sum }_{p = 1}}^{P} ( {SWeight\_p}^{*} \frac{1}{N} * {\sum }_{n = 1}^{N} 1 ( B [ n , T ] > Benchmark\_p ) ) \qquad ( equation 24 )$$

In the BFPS described above, FS acceptability requires a specified acceptability likelihood at each priority level, that is, the user specifies a vector of FS acceptability thresholds Acceptability p, p=1 . . . P. In this MBPFS, instead of a vector of FS acceptability thresholds, the user specifies one FS success threshold SF S-TH and goal success likelihood weights for each priority level, SWeight_p, p=1 . . . P. In other embodiments, FS acceptability is determined differently. Step 2370 is a test that automatically determines acceptability of the FS. If the FS is not acceptable, processing continues at step 2375. If the FS is acceptable, processing continues at step 2380.

General acceptability can be defined as a grand function of all information generated during the simulation, a “general utility function” GU(*). SFS is a particular embodiment of GU. Other possible embodiments include for example value-weighted SFS, which also incorporates the value of the goals and not only their success likelihoods GSL (an example of which is shown later in the Wellness Score discussion). Yet another embodiment may be related to a notion of expected path-wise utility PU(n) set equal to aggregate consumption achieved along a given simulation path, averaged over all Monte Carlo paths.

Step 2372, occurring after the FS is determined, for providing a personal research interface, is similar to step 2299 of FIG. 17C, except that the user can also query information relating to his/her FS, provided by FPS 2021.

The personal research interface is typically an interactive graphical user interface (GUI) that presents a start page with a menu such as in Table 13.

TABLE 13
Personal Research GUI, Benchmark FPS with Financing
Personal Research

Help
Data structure of financing offers
Statistics for financing offers
Lender information
Financing offers
More data structure

```
  Investments and risk parameters
  System strategies (selected investments and weights)
  Life Action templates
  Goal templates
  Financing templates
Lifetime acceptability criteria
Periodic acceptability criteria
```

Your financial strategy set-up information

```
  Account information
  Life Actions
  Goals
  Liquidatable Assets
  System strategies
  Financial plan acceptability criteria
  Accounts with third party systems
  Private financing
  Financing templates
  Periodic acceptability criteria
  Automatic loan approval
```

Your financial strategy

```
Financial strategy
  Benchmark
  Financing offers that you were eligible for, by goal
  Financing offers that you were not eligible for, by goal
  Financing comparison
  Assets liquidated to achieve financial strategy
  Goals success likelihood
  Predicted default rate
  Success weights, Success threshold, Success of Financial Strategy
```

Dual Goal Sensitivity Analysis
Single Goal Sensitivity Analysis

Other than the first five menu items that function as described with respect to step 1450 of FIG. 16C, the menu items function as follows:
More data structure—lets the user examine the information provided at steps 2105-2115 and 2140-2170 of FIG. 17B;
Your financial strategy set-up information—lets the user examine the information provided by the user and FPS 2021 in FIG. 17C;
Your financial strategy—lets the user examine the following:
   Financial strategy—the financial strategy created at step 2350 and its metrics for each period such as liquidity cushion (minimum, maximum, average, median across the N simulations);
   Benchmark—the benchmarks for each priority determined at step 2320;
   Financing offers that you were eligible for, by goal—the financing offers for the eligible scenarios of step 2525 of FIG. 17F;
   Financing offers that you were not eligible for, by goal—the financing offers identified at step 2345 of FIG. 17D but not included in step 2525 of FIG. 17F, with an explanation of why the user was ineligible, such as the financing violated the user's periodic criteria, or the user failed to satisfy the lender's user criteria with the unmet criteria identified;
   Financing comparison—if the user wishes, the FPS generates a table comparing financial offers selected by the user;
   Assets liquidated for financial strategy—the assets confirmed for liquidation for each period across the N simulations at step 2560 of FIG. 17F;
   Goals success likelihood—as determined at step 2360;
   Predicted default rate—as determined at step 2360;
   Success weights, Success threshold, Success of Financial Strategy—as used and determined at step 2370;
Dual Goal Sensitivity Analysis—lets the user plot goal likelihoods against each other for two goals, as described below. This is particularly useful when a FS is not acceptable, for manually tweaking at step 2375;
Single Goal Sensitivity Analysis—lets the user how the likelihood of achieving a goal will change as the cost of the goal is varied, see below. This is also helpful for manual tweaking at step 2375.
   The Personal Research GUI also lets the user save and retrieve (not shown) his/her FS information, sensitivity analyses and goal sensitivity analyses.

In some embodiments, the “More data structure” and “Your financial strategy set-up information” is also available in the General Research GUI of step 2299 of FIG. 17C.

In embodiments of FIG. 16A, where the API for utility program 1276 supports transferring individual user information from FPS 1250, 1260, 1270, the “More data structure” and “Your financial plan set-up information” is also available in the General Research GUI of step 1450 of FIG. 16C.

Dual Goal Sensitivity Analysis will now be discussed.

A dual goal sensitivity analysis report is a chart that shows the likelihood of achieving two goals, as one variable for each of the goals is varied. For instance, one goal may be retirement, with the varied value being the age of the individual at which retirement begins, and the other goal may be a product purchase, with the varied value being the cost of the purchase given a particular purchase date, as shown in FIG. 19A, or the varied value may be the purchase date given a particular purchase cost, as shown in FIG. 19B. A sensitivity analysis report is helpful for determining whether a user can afford something better or more expensive. Generally, a sensitivity analysis report includes likelihoods from 1% to 99%, rather than 0% to 100%, as a reminder that there is always a small possibility that something unlikely could happen, and there is no guarantee that even a highly likely event will happen.

Table 14 shows metacode for generating a dual goal sensitivity analysis report. This metacode is repeatedly executed, once for each sensitivity analysis report that the user desires.

TABLE 14
Generate Dual Goal Sensitivity Analysis Report

| | |
|---|---|
| 1 | Receive x-axis goal XG |
| 2 | Receive x-axis param XGp = XP1 to XPN |
| 3 | Receive x-axis non-varying parameter(s) |
| 4 | Receive y-axis goal YG |
| 5 | Receive y-axis param YGp = YP1 to YPN |
| 6 | Receive y-axis non-varying parameters |
| 7 | Display axes of chart |
| 8 | For XG_i = XP1 to XPN |
| 9 | For YG_i = YP1 to YPN |

| | |
|---|---|
| 10 | Apply Monte Carlo simulations |
| 11 | Compute likelihood of XGp at YGp |
| 12 | Save likelihood of XGp at YGp |

| | |
|---|---|
| 13 | Make chart of saved likelihoods XG at YG |

At lines 1-3, the user specifies the goal that the user wishes to see plotted on the x-axis of the sensitivity analysis report, along with the goal parameter that is to be varied and the range of variation, XP1 to XPN, and possibly the units (e.g., calendar year or age of user), and then specifies fixed parameters for the goal. Typically, the specification is done via drop-down menus populated based on the user's profile.

At lines 4-6, the user specifies the goal that the user wishes to see plotted on the y-axis of the sensitivity analysis report, the parameter that is to be varied and the range of variation, YP1 to YPN, and possibly the units (e.g., calendar year or age of user), and then specifies fixed parameters for the goal. Typically, the specification is done via drop-down menus populated based on the user's profile.

At line 7, the benchmark FPS displays a chart showing the axes as specified by the user with the ranges set forth, but with no values in the cells defined by the ranges.

At lines 8-11, for each cell, that is for the abscissa goal XG_i=XP1 to XPN and for the ordinate goal YG_i=YP1 to YPN, the financial planning system executes steps 2320-2360 of FIG. 17D, using the Monte Carlo simulations of step 2310 of FIG. 17D.

At line 12, the benchmark FPS saves the calculated cell value: the likelihood of achieving the goals at the parameter values XG_i and YG_i.

At line 13, the benchmark FPS uses the saved likelihoods to make the requested sensitivity analysis report.

The user then can save this chart, and if desired, create another chart.

In some embodiments, FPS 2021 automatically selects the best goals to tweak and prepares sensitivity analyses for these goals. The actual goal adjustment is done by the user at step 2375.

To automatically adjust goals that are “underachieving” and “overachieving” relative to acceptability of a financial scenario, a goal-value-weighted metric called a “Wellness Score” is defined. The components of the Wellness Score, by goal, are examined to see which are below average (underachieving) and which are above average (overachieving). By reducing the value of the overachieving goal, and increasing the value of the underachieving goal, the Wellness Score is improved.

First, define the Wellness Score, WScore, and the Wellness Score Contribution, WScoreC_i. Let
g_k be the kth goal of a user, k=1 . . . G, from step 2230 of FIG. 17C;
Prob(g_k) be the probability of achieving g_k, i.e., the goal success likelihood for g_k determined at step 2360 of FIG. 17D;
Amount(g_k) be the cost of the kth goal of the user;
CW(priority(g_k)) be the contribution weight of g_k to the Wellness Score, with priority(g_k) being the priority of goal g_k from step 2230 of FIG. 17C, and high, medium, low priority having a CW of 0.8, 0.6, 0.2, respectively;
   then the Wellness Score, WScore, is defined as in Equation 25:

$$WScore = \frac{{{\sum }^{G}}_{k = 1} \begin{matrix}Prob\_k * Amount ( g\_k ) * \\ CW ( Priority ( g\_k ) )\end{matrix}}{\begin{matrix}{{\sum }^{G}}_{k = 1} Amount ( g\_k ) * \\ CW ( Priority ( g\_k ) )\end{matrix}} \qquad ( equation 25 )$$

the Wellness Score Contribution, WScoreC_i, of the ith goal, g_i, i=1 . . . G, is defined as in Equation 26:

$$WScoreC\_i = \frac{\begin{matrix}Prob\_i * Amount ( g\_i ) * \\ CW ( Priority ( g\_i ) )\end{matrix}}{\begin{matrix}{{\sum }^{G}}_{k = 1} Amount ( g\_k ) * \\ CW ( Priority ( g\_k ) )\end{matrix}} \qquad ( equation 26 )$$

Next, for each priority level, average the WScoreC_i for that priority level to give the Wellness Level Average, WScoreLA_p, p=1 P, where P is the number of priority levels for which the user has defined goals, as in Equation 27:

$$WScoreLA\_p = \frac{\begin{matrix}\sum WScoreC\_i for \\ goals with Priority ( g ) = p\end{matrix} }{ \begin{matrix}Number of goals \\ with Priority ( g ) = p\end{matrix}} \qquad ( equation 27 )$$

The Wellness Difference, WDiff_i, deficiency or surplus, between the Wellness Score Contribution of the goal and the average for the priority level is WDiff_i=WScoreC_i=WScoreLA_p. If WDiff_i is negative, the value of the goal should be reduced, and if WDiff_i is positive, the value of the goal should be increased, to result in an improved Wellness Score.

Adjusting the goal values is easiest to understand if the sum of the goal values at a priority level remains constant.

Table 15 shows an example of Wellness Score computation, for a user with nine goals, three at each priority level. The Wellness Score is initially 0.666, but after adjusting goal values as below, the Wellness Score becomes 0.693, see Table 16, an improvement of 0.027.

TABLE 15
Example showing where to adjust Wellness Score

| 1 | Goal g_k | 1 | 2 | 3 | 4 | 5 | 6 | 7 | 8 | 9 |
|---|---|---|---|---|---|---|---|---|---|---|
| 2 | Goal priority | High | High | High | Med | Med | Med | Low | Low | Low |
| 3 | Contribution Weight | 0.80 | 0.80 | 0.80 | 0.60 | 0.60 | 0.60 | 0.20 | 0.20 | 0.20 |
| | CW(priority(g_k)) | | | | | | | | | |
| 4 | Goal Value ($000) | 100 | 200 | 300 | 100 | 50 | 100 | 200 | 300 | 100 |
| 5 | Goal success likelihood | 90% | 85% | 70% | 65% | 55% | 50% | 40% | 30% | 20% |
| | Prob(g_k) | | | | | | | | | |
| 6 | Wellness Score WScore | 0.666 | | | | | | | | |
| 7 | Wellness Score | 0.10 | 0.18 | 0.22 | 0.05 | 0.02 | 0.04 | 0.02 | 0.02 | 0.01 |
| | Contribution | | | | | | | | | |
| | WScoreC_i | | | | | | | | | |
| 8 | Average Wellness Score | 0.17 | | | 0.04 | | | 0.02 | | |
| | for this priority | | | | | | | | | |
| | WScoreLA_p | | | | | | | | | |
| 9 | Wellness Difference | −0.07 | 0.01 | 0.06 | 0.01 | −0.02 | 0.00 | 0.00 | 0.01 | −0.01 |
| | WScoreLA_i | | | | | | | | | |

For priority level “High”, the first goal is underachieving (WScoreC_i 0.10<WScoreLA_p 0.17) while the third goal is the most overachieving (WScoreC_i 0.22>WScoreLA_p 0.17). The Wellness Score will improve if the value of the overachieving third goal is reduced, and the underachieving first goal is increased. For this example, change the high priority goal values ($000) from (100 200 300) to (300 200 100).

For priority level “Medium”, the fifth goal is underachieving (WScoreC_i 0.02<WScoreLA_p 0.04) while the fourth goal is overachieving (WScoreC_i 0.05>WScoreLA_p 0.04). The Wellness Score will improve if the value of the overachieving fourth goal is reduced, and the underachieving fifth goal is increased. For this example, change the medium priority goal values ($000) from (100 50 100) to (50 100 100).

For priority level “Low”, the ninth goal is underachieving while the eighth goal is the overachieving. The Wellness Score will improve if the value of the overachieving eighth goal is reduced, and the underachieving ninth goal is increased. For this example, change the low priority goal values ($000) from (200 300 100) to (200 100 300).

The goals success likelihood Prob(g_k) usually changes when the goal value is changed. However, for this example, assume the goals success likelihood is unchanged. With the changes above, the new Wellness Score amounts are shown in Table 16.

TABLE 16
Draft result of adjusting goal values to influence Wellness Score

| 1 | Goal g_k | 1 | 2 | 3 | 4 | 5 | 6 | 7 | 8 | 9 |
|---|---|---|---|---|---|---|---|---|---|---|
| 2 | Goal priority | High | High | High | Med | Med | Med | Low | Low | Low |
| 3 | Contribution Weight | 0.80 | 0.80 | 0.80 | 0.60 | 0.60 | 0.60 | 0.20 | 0.20 | 0.20 |
| | CW(priority(g_k)) | | | | | | | | | |
| 4 | Revised | 300 | 200 | 100 | 50 | 100 | 100 | 200 | 100 | 300 |
| | Goal Value ($000) | | | | | | | | | |
| 5 | Goal success likelihood | 90% | 85% | 70% | 65% | 55% | 50% | 40% | 30% | 20% |
| | Prob(g_k) | | | | | | | | | |
| 6 | Revised | 0.693 | | | | | | | | |
| | Wellness Score WScore | | | | | | | | | |
| 7 | Revised | 0.29 | 0.18 | 0.07 | 0.03 | 0.04 | 0.04 | 0.02 | 0.01 | 0.02 |
| | Wellness Score | | | | | | | | | |
| | Contribution | | | | | | | | | |
| | WScoreC_i | | | | | | | | | |
| 8 | Revised | 0.18 | | | 0.04 | | | 0.02 | | |
| | Average Wellness Score | | | | | | | | | |
| | for this priority | | | | | | | | | |
| | WScoreLA_p | | | | | | | | | |
| 9 | Revised | 0.11 | 0.01 | −0.11 | −0.01 | −0.01 | 0.00 | 0.01 | −0.01 | 0.00 |
| | Wellness Difference | | | | | | | | | |
| | WScoreLA_i | | | | | | | | | |

Other metrics can be devised.

Single Goal Sensitivity Analysis will now be discussed.

A single goal sensitivity analysis is simply showing how the goal varies as one of its parameters is varied. When using single goal sensitivity, the objective is usually to improve the given goal's likelihood of achievement, and the sensitivity analysis allows pinpointing the goal parameter that makes this possible.

At step 2380, FPS 2021 checks whether any of the financing offers chosen for the FS have acceptance time constraints, indicated as “Loan(t)” to distinguish from a loan lacking an acceptance time constraint. For instance, a lender may offer a loan at a special rate if the borrower pays something by a first date to lock in the special rate, then uses the loan by a second date. This helps lenders forecast loan demand. If not, processing continues at step 2390, since if no loan has an acceptance time constraint, then loans may be in the user's FS, and loan commitments will occur when the loans are needed.

If a selected loan has an acceptance time constraint, then at step 2382, FPS 2021 prepares information as to how not accepting (committing to) this loan affects the user's FS, specifically, (i) whether there are similar loans but slightly more expensive and devoid of acceptance time constraints that can be easily substituted with no other changes to the user's FS, (ii) whether paying cash instead of accepting financing would affect the user's goal achievement, and (iii) whether not accepting the financing with a time constraint would block the user from achieving a goal

At step 2384, loan commitment processing as shown in FIG. 17H occurs. The user will be asked if s/he wishes to approve the loan and will be presented with the alternatives information prepared at step 2382. Since accepting a loan changes the user's situation—more immediate wealth, a new liability, and need to make repayments—at step 2386, the FS is updated. If at least one loan commitment does not occur at step 2384, then updating the FS at step 2386 is skipped.

At step 2390, the user's FS has been determined. FPS 2021 stores the FS in one of client database 2024, 2064, 2083.

At step 2392, FPS 2021 stores a reduced (anonymized) form of the FS in reduced database 2025.

Step 2395, applying the financial strategy, is shown in FIG. 17G.

FIG. 17E shows determination of a benchmark; this figure is similar to FIG. 11B. There are no differences to discuss. FIG. 11B shows a benchmark for maximizing the number of goals achieved but not necessarily maximizing wealth. In other embodiments, other benchmarks are used.

FIG. 17F shows evaluation of a sub-goal, corresponding to the (n, t, p, s) innermost loop of step 850 in FIG. 11A. The innermost loop of step 850 compares current wealth B[n,t−1] with the appropriate benchmark Benchmark_p_s and if wealth is too small, liquidates assets to increase wealth, whereas if wealth is sufficient, uncommitted goals are committed, corresponding to steps 2535 and 2570 of FIG. 17F. All the other steps of FIG. 17F are new, for automatic selection of financing.

At step 2515, for each financing scenario af, af=1 . . . AF, determined at FIG. 17D step 2345, FPS 2021 estimates the effect of the financing on the user's wealth B[n,t,af] similar to adjusting goals to reflect financing at FIG. 16E step 1610. Based on the amount to be financed, which is affected by any asset liquidation at step 2575, each financing scenario where the lender meets the borrower's need, and the borrower meets the lender's criteria, is included in income INC[t, af], such as the period t when the financing is provided, and in expenses EXP[t, af] for the periods t when closing costs are incurred and loan repayments occur. Then, wealth B[n,t,af] is computed as in Equation 28.

B[n,t,af]=B[n,t−1,af]+INC[t,af]−EXP[t,af]+(1+SUM_k w[n,t−1,k]*SIR[n,t,k])*B[t−1] (equation 28)

Often, loan repayments depend on an interest rate that depends on a market rate, and this market rate is simulated at FIG. 17D step 2310.

At step 2520, FPS 2021 eliminates the scenarios among 1 AF that violate the FS periodic acceptability criteria selected at step 2285 of FIG. 17C. The remaining scenarios are the “eligible scenarios”.

At step 2522, FPS 2021 checks whether there are any eligible scenarios. If not, processing continues at step 2570. If so, processing continues at step 2525.

At step 2525, FPS 2021 stores the eligible scenarios

At step 2530, from among the eligible scenarios, FPS 2021 selects the financing scenario, designated as af*,in accordance with the FS scenario-best criteria selected at step 2285 of FIG. 17C. Step 2530 is a test that automatically determines which financing scenario is best. If multiple financing scenarios equally satisfy the scenario-best criteria, then FPS 2021 selects the one of the equally satisfactory scenarios associated with maximum wealth B[n,t,af].

At step 2535, FPS 2021 checks whether current estimated wealth B[n,t,af*] exceeds Benchmark_p_s, similar to step 850 of FIG. 11A that checks whether B[n,t−1]>Benchmark_p_s. Step 2535 is a test that automatically determines whether a financing scenario corresponds to a minimum acceptable FS based on achieving goals. Note that step 2535 uses the estimated wealth for the current time t, whereas step 850 uses the actual wealth for the previous time t−1, that is, the estimation that occurred at step 2515 permits a more relevant comparison at step 2535. If the condition is true, processing continues at step 2540. If the condition is false, processing continues at step 2570.

In this embodiment, the test of “best-ness” (optimality) occurs at step 2530, then the test of minimum acceptability of goal achievement occurs at step 2535. In other embodiments, the sequence of tests is swapped, i.e., the test of minimum acceptability occurs first, then the test of “best-ness” (optimality) occurs second.

At step 2540, FPS 2021 checks whether the selected financing scenario af* corresponds to hypothetical financing. If not, processing continues at step 2560.

If the selected financing scenario af* corresponds to hypothetical financing, at step 2545, FPS 2021 stores the event of hypothetical financing being selected in reduced database 2025, similar to step 1680 of FIG. 16E.

At step 2550, FPS 2021 reverses any provisional asset liquidation and wealth adjustment made at steps 2575 and 2580.

At step 2555, FPS 2021 picks the next best of the eligible financing scenarios stored at step 2525, and sets af′ to correspond with the next best eligible scenario. Processing continues at step 2535.

At step 2560, FPS 2021 appropriately adjusts the goal, income INC[t], expenses EXP[t] and assets to reflect af*, that is, includes the financing for scenario af* in the user's FS. If an unreversed provisional liquidation occurred, it becomes an actual liquidation at this point.

At step 2565, FPS 2021 marks the financed goal as being committed in the FS, and processing returns to step 2350 of FIG. 17D.

Note that goal commitment means that the goal has been achieved, whereas loan commitment means merely a bilateral “binding-ness” agreement has occurred.

At step 2570, FPS 2021 has determined that even with the best eligible financing scenario af*, the goal is unattainable. So, FPS 2021 checks whether liquidating assets, as described above with respect to step 850 of FIG. 11A, would result in a scenario af** such that B[n,t,af**]>Benchmark_p_s. Generally, asset liquidation occurs only once per sub-goal, so that if asset liquidation results in a new af′ at step 2530 that again does not meet the benchmark, it is not attempted again. However, if a provisional liquidation has been reversed, another provisional liquidation can occur. Asset liquidation can affect financing by reducing or eliminating the need for financing.

In this embodiment, the FPS attempts to get financing before considering asset liquidation. In other embodiments, the sequence is reversed. In still other embodiments, the user can select the sequence of financing and asset liquidation, sometimes by goal priority.

If no such scenario af** exists, that is, there are no more assets to liquidate, at step 2572 FPS 2021 reverses any provisional liquidation that may have occurred at step 2575 and reverses any wealth adjustment that may have occurred at step 2580, sub-goal evaluation is complete, processing returns to step 2350 of FIG. 17D, and the goal is not committed.

If a suitable scenario af** exists, that is, there are assets to liquidate, then at step 2575, FPS 2021 provisionally adjusts its data to reflect the corresponding asset liquidation. The liquidation must be provisional, so that in case the financing is hypothetical, the liquidation can be reversed at step 2550.

At step 2580, FPS 2021 adjusts B[n,t−1] to reflect that the asset was liquidated, and processing returns to step 2515. Re-checking the best financing is necessary because the asset liquidation may alter which financing the user qualifies for, that is, at step 2910, there may be more, fewer, or the same number of financing alternatives as in the first iteration of step 2910.

FIG. 17G shows detail of step 2396 of FIG. 17D, “apply financial strategy”; this figure is similar to FIG. 11C and for brevity, only differences are discussed. Applying the FS means (i) taking actions in view of the user's goals and the market environment at the previous time interval, (ii) updating the values reflecting the market environment, and (iii) determining a new FS if needed.

At step 2630, based on the FS and market conditions, FPS 2021 may suggest actions such as rebalancing an investment portfolio, liquidating assets, taking out a loan to finance a goal, making a loan payment, or prepaying a loan. FPS 2021 automatically checks whether loan prepayment is feasible. If a user's income has increased, such as via inheritance, job promotion or investment performance, or expenses have decreased, so that B[n,t−1]—Benchmark>PPAY-TH, where PPAY-TH is defined at FIG. 17C step 2297, then FPS 2021 presents the user with this situation, advises whether there are loan prepayment penalties, and notifies the user of the loan interest rate and the investment rate, so the user can decide whether to increase the loan payment for this period, and by how much. Depending on the loan terms, if excess payment is made, FPS 2021 adjusts the loan's end time, or the loan's payment for future periods.

At step 2635, FPS 2021 determines whether to automatically commit to a loan, as shown in FIG. 17H. It will be recalled that loans with acceptance time constraints are considered for commitment at step 2380 of FIG. 17D. Typically, a user wants to postpone committing as long as possible, in case circumstances change, but could be persuaded to commit early by a good offer.

At step 2690, evaluation of a sub-goal in the (p, s) innermost loop is shown in FIG. 17F, instead of simply comparing current wealth B[n,t−1] with Benchmark_p_s and if wealth is too small, liquidates assets and adjusts wealth, whereas if wealth is sufficient, uncommitted goals are committed, as in step 1090 of FIG. 11C.

If a new loan is available, as a result of loan demand curves (see FIG. 17I step 2865) or a lender independently adding a new loan offer (see FIG. 17K step S430), then step 2690 determines whether, with the user's existing financial strategy, the new loan is better than a loan, if any, in the user's existing FS.

FIG. 17H shows detail of step 2635 of FIG. 17G; this figure is similar to FIG. 16F and for brevity, only differences are discussed.

At step 2705, FPS 2021 checks whether there is financing in the FS. If not, processing is complete. If there is financing, processing proceeds to step 2710.

FIG. 17I shows the operation of benchmark utility software 2022 to create financing demand curves for the modified benchmark financial planning system with automatically selected financing; this figure is similar to FIG. 16G and for brevity, only differences are discussed.

At step 2830, the loan demand curve from a modified benchmark FPS is superior to the loan demand curve from a modified conventional FPS because more potential customers are included for higher PDR. A modified conventional FPS can detect only existing borrowers as potential customers for a revised or new loan product because of the deterministic nature of a conventional FPS, see FIG. 15C. A modified benchmark FPS can detect existing borrowers as potential customers for a revised or new loan product, and can also detect non-borrowers as potential customers because of the probabilistic nature of a modified benchmark FPS, see FIG. 15D. More specifically, the probabilistic nature of a modified benchmark FPS allows identification of users who do not quite qualify for a loan, and thus are a good source of potential customers.

At step 2865, benchmark utility software 2022 provides notification of revised or new financing only to users served by a modified benchmark FPS. These users include already identified borrowers and relevant non-borrowers. The notification is received at step 2395 of FIG. 17D.

Software 2023 executes only step 2865, for users—only already identified borrowers-served by a modified conventional planning system.

FIG. 17J shows set-up for lender 2005; this figure is similar to FIG. 16H and for brevity, only differences are discussed.

At step S320, lender 2005 can choose a customer creditworthiness characteristic determined by FPS 2021 that changes during the lifetime of the FS, as the user's simulated incomes, expenses, assets, liabilities and wealth change. In this case, the FPS 2021 performs an initial calibration procedure to determine the parameters of the model for predicting changes in creditworthiness and for predicting associated changes in user-specific rate adjustments. This calibration can be done by estimating the current creditworthiness of multiple users and comparing it with lender-estimated user-specific rates adjustments for such users, in a cross-sectional model fitting procedure. After the calibration step is completed, the parameters of the creditworthiness model are saved and used for future estimates and simulations.

FIG. 17K shows operation for lender 2005; this figure is similar to FIG. 16I and there are no differences to discuss.

The embodiment of FIG. 17 provides at least the following advantages to a borrower, relative to a conventional financial planning system, beyond the advantages identified with respect to FIG. 16:
better modelling of the effects of financing due to interest rates that can change at each period, instead of being assumed over the lifetime of the financing;
better modelling of user preferences, due to the availability of more criteria: benchmarks, priorities, FS periodic acceptability criteria, FS scenario-best af* criteria, enabling a MBFPS to automatically find the best FS for a user, reducing the amount of time that the user spends in manually tweaking their FS;
ability to optimize the timing and financing of two goals with respect to each other. For example, assume the user wants to buy a new car in the next 2-4 years and buy a house in the next 3-5 years. The BFPS can evaluate how spending on one of the car and house affects spending on the other of the car and house. The MBFPS can also evaluate how the financing for one goal affects financing for other goals, typically because of the lender's criteria for maximum percentage of income directed to loan repayments. For instance, to get the best house mortgage, perhaps a user should delay purchasing a new car. As another instance, assuming home mortgage interest is cheaper than car loan interest, it may be better for the user to get as large a mortgage as possible so that car financing can be minimized.
automatic asset liquidation to make goals affordable;
better analysis of where to change user inputs for most favorable results;
automatic detection and suggestion of loan prepayment opportunities that do not jeopardize goal achievement.

The embodiment of FIG. 17 provides at least the following advantages to a lender, relative to a conventional financial planning system, beyond the advantages identified with respect to FIG. 16:
availability of predicted default rate during the term of a loan, which is the exact risk that the lender wants to avoid. That is, the lender usually does not care if the borrower defaults after repaying the lender. This temporal granularity is not possible in a conventional FPS.

### FPS with Automated Selection of Products and Financing

As used herein and in the claims, “products” means products, services or combinations of products and services, as appropriate.

FIG. 18 shows, at a high level, the present process of consumption financial planning; this figure is similar to FIG. 14B and for brevity, only differences are discussed.

Step 3000, creating a financing database, is similar to step 1115 of FIG. 14B.

At step 3005, an administrator for the financial planning system creates a product database identifying different products and their characteristics, such as initial cost, lifetime and annual cost, and manufacturer financing terms. A product can be defined generally, such as “luxury sportscar” or specifically, such as “Ferrari 488 GTB sportscar”. Specifically defined products can experience price improvement through the present financial planning system, as discussed below.

At step 3010, an individual profile is created, similar to step 1120 of FIG. 14B. At step 3010, an individual also specifies which sensitivity reports are of interest, discussed below at step 3035.

At step 3015, general object goals are defined, similar to step 1125 of FIG. 14B.

At step 3020, specific product goals are defined using the specific products in the product database, along with the individual's willingness to accept manufacturer and/or third-party financing, in embodiments wherein the user can have a general financing strategy but override it for specific goals. In other embodiments, all goals are subject to the user's general financing strategy.

During operation, at step 3030, a FP or FS is created for the individual based on their profile, general goals, specific goals and related profiles, similar to step 1130 of FIG. 14B.

At step 3040, the individual may be offered the opportunity to commit to a specific goal with or without a financing commitment, such as via pre-payment or a down-payment. In some embodiments, during set-up, an individual may consent to automatic agreement to products that fit the user's goal criteria. At step 3045, the individual may automatically commit to financing. If the individual commits to product purchase and/or financing, at step 3050, the financial planning system transfers funds and updates the individual's FP or FS. The user, by “pre-purchasing”, helps the purveyor to properly forecast demand for its products. Steps 3045 and 3050 are similar to steps 1140 and 1150 of FIG. 14B.

When a user creates a FP or FS, it contains information about major purchases the user intends to make, and how much the user intends to spend. The financial planning system can aggregate this information to create a demand curve for its users, and negotiate with purveyors to provide advantages, such as lower prices or additional services, thereby benefitting the users and improving their financial future.

At step 3055, executed periodically, the financial planning system surveys the collection of individual FPs or FSs, and creates product demand curves for different types of products that individuals have in their FPs or FSs. The product demand curves include how many general products are in FPs or FSs, and how many specific products. For example, as shown in FIG. 20A, the financial planning system extracts from individual FPs or FSs how many instances of a particular goal, such as product X, are expected to be purchased at all prices, and when, to create a purchases-by-time graph. The financial planning system produces a demand curve as shown in FIG. 20B, depicting the number of purchases at each price, as price and quantity vary. The product demand curves are anonymized, meaning that the identity of the purchasers cannot be readily discerned, usually because of the volume of purchases represented in the anonymized demand curves.

The product demand curves are similar to the loan demand curves in that modified conventional FPSs generate deterministic plans, whereas modified benchmark FPSs generate probabilistic plans, as discussed with respect to FIGS. 15C and 15D.

Then, at step 3060, the financial planning system makes the product demand curves available to relevant product providers, so that the product providers can choose to offer better terms to individuals served by the financial planning system. Better terms may mean lower prices, a most favorable price guarantee, cheaper financing, fulfillment priority, or custom versions of a product. The product database, created at step 3005, is then updated, and relevant individuals are notified of the updated product, so at step 3040, they may make or update their purchase commitments.

Real-world effects of the present invention include obtaining price improvement in products and/or financing for system users based on the actions of other system users, and a system that automatically purchases, or makes a pre-payment for, a product and/or a type of financing.

Advantages of the present FPS with automatic product and financing selection—both MCFPS and MBFPS—relative to a conventional financial planning system include the benefits discussed above for financing, plus:
The present FPS enables selection of products consistent with a user's financial preference criteria, reducing the likelihood of impulse purchases that will later be regretted, and improving user satisfaction with their purchases;
The present FPS helps the user withstand manufacturer “upselling”. Manufacturers sometimes offer financing for their products at a lower rate than third-party financing, to encourage people to buy more expensive products, beyond what is justifiable from the financing. Here, the FPS focuses on achieving goals over the user's lifetime, so the user is unlikely to be lured into buying a too-expensive product;
A conventional system assumes a fixed price for a product, whereas the present system may offer product terms dependent on group behavior (demand curve) and individual behavior (history of following their FP or FS) due to the willingness of product suppliers to consider such group and individual behaviors, resulting in a better price and/or a better (customized) product for the user possibly available exclusively via the present FPS;
Conventionally, a user is on his/her own after purchasing a product, leaving the user vulnerable to product suppliers who can “get away” with poor customer service. By purchasing via the present FPS, a user can file a complaint that potential users can see, giving the user more leverage in resolving disputes with sellers, and reducing the vulnerability of users to poor after-sale service;
A conventional system assumes goals must be funded by accumulated savings, whereas the present system also accommodates goal-focused loans, more accurately modeling the user's reality and improving the likelihood of goal achievement;
A conventional FPS ignores product experiences of other users, whereas the present FPS facilitates the user's access to reliable product ratings databases, educating the user to be a better consumer;
A conventional planning system is independent of product providers, whereas the present system systematizes purchase commitments on behalf of product and/or financing providers, helping product providers forecast demand for their products.
Steps 3065 and 3070 are similar to steps 1160 and 1170 of FIG. 14B.

Section 3. Modified Conventional Financial Planning System with Products and Financing

FIG. 21A shows several variations of how a conventional financial planning system can be modified to accommodate automatic selection of products and financing (consumption planning), and demand aggregation leading to better deals for users of the financial planning system. FIG. 21A is similar to FIG. 16A, and for brevity, only differences are discussed.

Reduced client database 3177 is similar to reduced client database 1277 of FIG. 16A, except that it accommodates reduced financial plans with automatically selected products.

FPS software 3152, 3162, 3172 is respectively similar to FPS software 1252, 1262, 1272 of FIG. 16A, except that it also functions:
to accept, from users, product goal definitions and authorization to automatically commit to product purchases,
to automatically select products for users,
to automatically select the best financing for products when financing is available from a variety of sources, including third-party financing provider 3180, product supplier 3190 and the user,
to accept product purchase commitments from users,
to send product purchase commitments to product providers 3190, and
to present revised and new product offers to users.

FPS software 3161 also functions to populate supplemental products database 3167 with products offered by supplemental product provider 3168.

Utility program 3176 is similar to utility program 1276 of FIG. 16A, except that it also functions:
to populate products database 3179 with products offered by product suppliers 3190,
to provide information from products database 3179 to FPS software 3152, 3162, 3172,
to create product demand curves, and
to process revised and new product offers.

Third party product supplier 3190 is a provider, e.g., manufacturer or distributor, of goods. Supplier 3190 indicates products it provides via their characteristics and/or brand names for inclusion in products database 3179. Some suppliers 3190 are willing to provide financing to buyers of their products, and such financing is also indicated by supplier 3190 along with parameters describing acceptable loans and characteristics of acceptable borrowers. Supplier 3190 authorizes FPS software 3152, 3162, 3172 to commit to product loans satisfying its parameterized loans, similar to how lenders 1280 in FIG. 16A authorize automated loan commitment.

Products database 3179 includes registration profiles for suppliers 3190, similar to client profiles, along with the supplier's parameterized descriptions of its offered products and any loans that the supplier is willing to provide to borrowers who meet its lending criteria, as discussed above with respect to third-party financing providers. Via utility program 3176, FPS software 3152, 3162, 3172 uses products database 3179. As used herein and in the claims, a “product” refers to a tangible product or a service from multiple service providers that is sold in similar manner. For example, a home companion service agency may sell four hours daily of companionship for an elderly or injured person as its product.

Supplemental product supplier 3166 is similar to third party product supplier 3190, except that it makes product offers only to customers of FPS software 3161.

Supplemental products database 3167 is similar to products database 3179, except that it is only for storing information from supplemental products suppliers 3166.

FIG. 21B shows system setup for the configuration of FIG. 21A, and is similar to FIG. 16B; for brevity, only differences will be discussed.

Steps 3210-3260 are similar to steps 1310-1360 of FIG. 16B.

At step 3270, products database 3179 is defined via steps 3272-3278.

At step 3272, a system administrator (not shown) for utility program 3176 defines the product types. Products include investment products, insurance products, banking products, financial services (planning for activity and taxes, management), education services, training services, medical services, child care services, annual child costs, durable goods, vehicle purchases or leases, residences (primary, secondary, investment), high value capital items (furniture), leisure travel and so on. Table 17 shows a sample list of products.

TABLE 17
Sample Product Types PTi

| | |
|---|---|
| 01 | Personal road vehicle |
| 02 | Boat |
| 03 | Airplane |
| 04 | Apartment |
| 05 | House |
| 06 | Home renovation |
| 07 | Cruise |
| 08 | Personal travel |
| 09 | College education |
| 10 | Graduate education |
| 11 | Elective surgery |
| 12 | Elective dentistry |

At step 3274, the system administrator for utility program 3176 defines product characteristics, such as description, lifetime in months, and cash flow by month, and also defines relevant reliable ratings databases for the product. The product characteristics are usually drawn from industry schema.

Product characteristics also include complaints about the product/supplier from other users of the present FPS. Typically, the system administrator for utility program 3176 configures the present FPS to produce a complaint alert for the system administrator when complaints exceed a complaints threshold, so the system administrator can decide whether to intervene and/or restrict access of the product/supplier to the present FPS.

In some embodiments, if complaints for a product exceed a threshold, such as more than 6% of buyers file a complaint, the FPS automatically increases the periodic cost (as opposed to initial cost) of the product to reflect poor post-sale performance, akin to a “handyman special” indicating a product appropriate for a user who can do most of their own post-sale support.

In some embodiments, if complaints for a supplier exceed a threshold, the FPS automatically adds a penalty cost to products from that supplier, encouraging buyers to select a competing supplier, and encouraging suppliers to resolve complaints.

As another example of a characteristic, the annual increase (or decrease) in the product's cost may be specified, along with the annual increase (or decrease) in resale value for a purchased product. In one embodiment, as a default, if the resale value is not specified, then the product's value is amortized over the product's lifetime. In some cases, a tax lifetime that differs from an expected lifetime may be specified. Product suppliers 3190 then define specific product instances at step S720 of FIG. 21L.

For example, for product type 01 Personal Road Vehicle, there may be instances as shown in Table 18. Product instances are associated with product sellers, see FIG. 21L step S720.

TABLE 18
Sample 01 Personal Road Vehicle Instances

| | |
|---|---|
| 01 | Sedan, four door |
| 02 | Sedan, two door |
| 03 | Luxury Sedan |
| 04 | Sportscar |
| 05 | Luxury Sportscar |
| 05-01 | Ferrari 488 GTB Luxury Sportscar |
| 06 | Truck with open cab |
| 07 | Truck with closed cab |
| 08 | Van |
| 09 | Sport utility vehicle |
| 10 | Motorcycle |
| 11 | Bicycle |
| 12 | Scooter |

The system administrator for utility program 3176 defines general instances of a product type, such as “01-05 Luxury Sportscar”.

Each product type has parameters. In many industries, there are already standardized data schemes for defining product characteristics, such as Financial Information Exchange (FIX) for financial instruments, www.fixtrading.org. Utility program 3176 uses standardized data schemes for product characteristics where possible.

Relevant reliable ratings databases are instances of third-party information services 40, shown in FIGS. 21A and 22A; examples include Amazon, manufacturer websites, and independent rating services such as Consumer Reports and Better Business Bureau. Users benefit because:
the system administrator evaluates reliability (fake reviews) and excludes unreliable databases and/or databases with few reviews, while finding appropriate databases;
the system administrator ensures that ratings from different databases can be translated into a normalized format, such as 5 stars best . . . 1 star worst, and combined;
the present FPS provides the ratings and normalized summaries at the point where the user is selecting a product, see FIG. 21D step 3415, so that the user can easily access them without having to remember to search for ratings;
the present FPS subscribes to for-fee ratings services, such as Consumer Reports, on behalf of all users, improving convenience, cost-effectiveness of accessing highly relevant information during product selection.

It will be appreciated that a product demand curve, see step 3948 of FIG. 21I, is for a product type.

At step 3275, the system administrator for utility program 3176 defines product financing templates, if any, in addition to the financing templates defined at step 3240. For example, if the financing templates from step 3240 are:
“Any”—use any available financing;
“Combined”—use multiple financing sources when possible; and
“Private only”—use only private financing defined by the user;
then at step 3275, the following templates may be defined:
“Combined Product only for Value”—use multiple financing sources only for products having a value exceeding Value, where Value is a parameter provided by the user, such as $20,000; and
“Private only for Products”—use private financing only to finance products.

At step 3280, supplemental product supplier 3168 defines supplemental products for supplemental products database 3167, in similar manner as third party products suppliers at step 3270 (specifically, steps 3276 and 3278). The definition of product types and characteristics from step 3270 is used at step 3280.

At step 3290, the system administrator for utility program 3176 and/or product supplier 3190 defines hypothetical products for products database 3179.

A hypothetical product is a way of testing market acceptance of a new product. Generally, a hypothetical product offer is the same as a non-hypothetical product offer, except that the hypothetical product offer includes a field showing it is hypothetical. As explained below, if the FPS would have selected the hypothetical product offer, this event is recorded, then the hypothetical product offer is marked as temporarily ineligible, forcing the FPS to choose a non-hypothetical product offer for the financial plan. The event of selecting the hypothetical product offer is stored in reduced database 3177, so that when product demand curves are created, the demand for the hypothetical product can be assessed.

FIG. 21C shows user setup for the configuration of FIG. 21A, and is similar to FIG. 16C; for brevity, only differences will be discussed.

At step 3307, the user selects product characteristics, as shown in detail in FIG. 21D.

At step 3308, if the user has purchased a product via the present FPS and has an unresolved problem, the user can file a complaint about the product, visible to other users at step 3350 and possibly to the system administrator at FIG. 21B step 3274. When the complaint is resolved, the user can delete it.

At step 3350, the general research interface also provides a user-friendly way to browse the contents of product database 3179, as shown in Table 19.

TABLE 19
General Research GUI, Modified
Conventional FPS, Products and Financing
General Research

Help
Data structure of financing offers
Statistics for financing offers
Lender information
Financing offers
Data structure of product offers
Statistics for product offers
Product supplier information
Product offers

Other than the first five menu items that function as described with respect to step 1450 of FIG. 16C, the menu items function as follows:
Data structure of product offers—lets the user browse the product structure defined in step 3270 of FIG. 21B, to get a map of the information available at the “Product offers” menu item;
Statistics for product offers—similar to statistics for financing offers, see Table 11, and includes complaints filed by users at step 3308;
Product supplier information—lets the user browse user-visible marketing information about product suppliers 3190 optionally provided by the product suppliers 3190 in products database 3179, when they registered as product suppliers 3190 (not shown). Typically, product supplier 3190 populates its user-visible marketing information when it is prepared to communicate directly with users, such as to provide more details about its product offers or, on a case-by-case basis, consider whether to extend its product specific financing offer to a user that does not meet its customer criteria in database 3179;
Product offers—lets the user browse the product offers available in products database 3179, which software 3152, 3162, 3172 can select among for the user. Typically, the user quickly gets overwhelmed in trying to manually compare the products, and is then far more appreciative of the convenience of using software 3152, 3162, 3172. Generally, the user selects a product type from among the product types specified at step 3272 of FIG. 21B, then selects values or value ranges for the product characteristics defined at step 3274 of FIG. 21B, and utility program 3176 responds with the product instances, of the types defined at step 3276 of FIG. 21B along with product-specific financing offers defined at step 3278 of FIG. 21B.

FIG. 21D shows selection of product characteristics.

At step 3405, FPS software 3152, 3162, 3172 begins with the first goal defined by the user at step 3305 of FIG. 21C.

At step 3407, FPS software 3152, 3162, 3172 asks the user if the goal is for a product (or service) in products database 3179. If not, At step 3425, FPS software 3152, 3162, 3172

At step 3410, the user associates goal g with a product type PTi selected from products database 3179.

At step 3415, the user specifies product characteristics for the product type selected at step 3410. There are usually multiple ways of specifying product characteristics, e.g., via a menu, via choosing a product offered in products database 3179 so that its characteristics are used as the specified characteristics, or via a combination thereof. A brand name can be a product characteristic. As mentioned above, product characteristics are usually defined by industry data schema. At this step, the user can:
see actual reviews and comments in third-party ratings databases, to learn more about the product's features and experiences of others with the product;
see a quick ratings summary for each ratings database, such as: 5 star best reviews (%, number) . . . 1 star worst reviews (%, number);
see an average of ratings summaries across all ratings databases generated by the present FPS, with ability to hyperlink back to the ratings databases.

At step 3420, based on the user-specified characteristics from step 3415, FPS software 3152, 3162, 3172 selects all products in products database 3179 that meet the user's characteristics. The user can edit the set of products, such as by removing or adding products. The user finds products outside of his/her specified characteristics using a General Research interactive interface, discussed at step 3350 of FIG. 21C.

At step 3425, FPS software 3152, 3162, 3172 checks whether there are any products in the set of selected products. For example, the user may dislike the specific product offers in products database 3179, and prefer to retain only a generic goal g. If there are no products, processing continues at step 3455.

At step 3430, FPS software 3152, 3162, 3172 stores the product scenarios for this goal. The product scenarios are the set of products remaining after step 3420. The generic goal is retained if its value differs from the product values.

At step 3435, if the user wishes to augment the financing templates selected at step 3330 of FIG. 21C for this goal, the user selects product financing templates for this goal. The default order of selecting financing for software 3152, 3162, 3172, assuming that all other characteristics of the financing are equal, in order of preference, is: private, supplemental product supplier, supplemental financing provider, hypothetical, third-party product supplier, third-party financing provider. The user can change this ordering.

At step 3440, the user specifies whether s/he opts into automatic purchase approval, on a goal-by-goal basis or for all goals.

At step 3445, the user specifies whether s/he opts into automatic new product replacement, for existing products and/or end-of-life products.

Automatic product replacement can change an existing product. As product suppliers 3190 offer upgraded and new products that satisfy the goal product characteristics specified by the user, FPS software 3152, 3162, 3172 can be pre-authorized to automatically decide what to do with such offers. If a user has committed to purchase a product, and then changes their mind, the product supplier may charge a cancellation fee, such as 20% of the product's cost. Automatic product replacement can replace a product at the end of its life. The original goal is automatically re-instated after the product's end-of-life, at t=PTi_LIFE+1 (see step 3274 of FIG. 21B).

At step 3455, FPS software 3152, 3162, 3172 increments g, to choose the next goal defined by the user at step 3305 of FIG. 21C.

At step 3460, FPS software 3152, 3162, 3172 checks whether the new value of g exceeds the number of user goals defined at step 3305 of FIG. 21C. If not, processing returns to step 3407. If so, processing returns to step 3310 of FIG. 21C.

FIG. 21E shows user operation for the configuration of FIG. 21A, and is similar to FIG. 16D; for brevity, only differences will be discussed.

At step 3530, FPS software 3152, 3162, 3172 determines all the possible combinations of goals-products and financing relevant to this user by searching products database 3179. This is similar to step 1530 of FIG. 16D, except that it is likely to result in many more scenarios, as there are often many products satisfying a particular goal. FPS software 3152, 3162, 3172 ensures that at least one combination of goal-products and financing will result in a non-hypothetical product (or goal for which products have not been specified) and non-hypothetical financing (which could be a cash-only scenario).

At step 3535, FPS software 3152, 3162, 3172 determines an Iteration Plan, as shown in FIG. 21F.

Step 3540 is a test that manually determines acceptability.

At step 3545, if no acceptable financial plan has been found, one of the things that the user can revise is his/her specification of product characteristics.

When there is a new loan offer or a new product offer, as indicated by the AA and BB circles (see FIG. 21I steps 3931 and 3962), FPS software 3152, 3162, 3172 needs to compare the new offer with the existing offers, that is, the new offers become part of new goal-product scenarios created at step 3530 and compared at step 3535.

At step 3560, FPS software 3152, 3162, 3172 determines whether to commit to a purchase, as shown in FIG. 21G.

At step 3580, FPS software 3152, 3162, 3172 determines whether to commit to a loan, as shown in FIG. 21H.

FIG. 21F shows determining an Iteration Plan for the configuration of FIG. 21A, and is similar to FIG. 16E; for brevity, only differences will be discussed.

At step 3605, FPS software 3152, 3162, 3172 begins cycling through combination goal-product/financing scenarios, not merely financing scenarios as in FIG. 16E.

Step 3630 is a test that automatically determines whether an iteration plan corresponding to a goal-product financing scenario is minimally acceptable.

Step 3670 is a test that automatically determines which iteration plan, corresponding to a respective goal-product financing scenario, is best.

At step 3675, FPS software 3152, 3162, 3172 checks whether the selected eligible Iteration Plan includes either a hypothetical product or a hypothetical loan. If so, processing continues at step 3680.

FIG. 21G shows automated product commitment processing for the modified conventional financial planning system with automatically selected products and financing

At step 3710, software 3152, 3162, 3172 checks whether the user has authorized automatic product purchase commitment for a financial plan being prepared, or has authorized automatic product replacement for a revised or new product offer. If no, processing continues at step 3725.

If the user has authorized automated product purchase commitment for a financial plan being prepared, or has authorized automatic product replacement for a revised or new product offer, at step 3720, software 3152, 3162, 3172 sends product purchase commitments to the appropriate product suppliers, send cancellations for automatically replaced products, and processing is complete.

If the user has not authorized automated product purchase commitment, at step 1325, software 3152, 3162, 3172 asks the user if s/he wishes to commit to a selected product purchase, and receives the user's response.

At step 3730, software 1252, 1262, 1272 checks whether the user has approved committing to the product purchase. If not, processing is complete. If the user has approved, processing proceeds to step 3720.

FIG. 21H shows loan commitment for the configuration of FIG. 21A, and is similar to FIG. 16F; for brevity, only differences will be discussed.

At step 3820, it will be appreciated that the lender may be a product supplier offering financing for their product.

FIG. 21I shows creation of product and financing demand curves for the modified conventional financial planning system with automatically selected products and financing. This figure is similar to FIG. 16G for creation of financing demand curves; for brevity, only creation of product demand curves is discussed.

At step 3944, for each type of product, as defined at step 3272 of FIG. 21B, at step 3946, utility program 3176 retrieves the financial plans from reduced storage 3177 that include this type of product. These financial plans can be depicted in a chart as in FIG. 20A. At step 3948, utility program 1276 then constructs a product demand curve for each type of product, as in FIG. 20B, based on the retrieved financial plans.

At step 3950, utility program 3176 sends the various types of product demand curves to those of product suppliers 3190 that either offer this type of loan, or have indicated interest in offering this type of loan.

If an entity offering supplemental products wishes to see the product demand curves for third-party products, it must register as an instance of product supplier 3190 and indicate interest in offering this type of product.

At step 3952, the appropriate ones of product supplier 3190 receive the product demand curve.

At step 3954, each product supplier 3190 decides whether to offer revised or new products based on the product demand curve.

At step 3956, if product supplier 3190 has decided to offer a revised or new product, product supplier 3190 sends the product terms to utility program 3176.

At step 3958, utility program 3176 receives the revised and new products, if any.

At step 3960, utility program 3176 updates products database 3178 with the revised or new products.

At step 3962, utility program 3176 notifies the software, selected from software 3152, 3162, 3172, associated with the relevant financial plans, i.e., the financial plans retrieved at step 3944, of the revised or new product terms.

At step 1870, utility program 3176 sets the timer t elapsed to zero, and processing returns to step 3910.

In some embodiments, software 3162 executes steps 3910, 3944, 3954, 3960, 3962, 3970 for the financial plans in client database 3163, to produce supplemental product demand curves for its customers. These supplemental product demand curves are proprietary to the owner of FPS 3160.

FIG. 21J shows set-up for lender 3180; this figure is similar to FIG. 16H, discussed above.

FIG. 21K shows operation for lender 3180; this figure is similar to FIG. 16I, discussed above.

FIG. 21L shows set-up for product supplier 3190; this figure is similar to FIG. 21J, and for brevity, only differences are discussed.

At step S700, product supplier 3190 provides account set-up information appropriate for a product supplier.

At step S720, product supplier 3190 populates products database 3179 with instances of products that it wishes to offer to financial plan users. As mentioned, product characteristics usually comply with an industry standard data scheme for the product.

Also at step S720, supplier 3190 defines the cashflow for its product, such as costs of an annual maintenance contract and/or cost of consumables.

At step S720, if there are any timing restrictions for this product offer, they are defined, such as “purchase by date-1, accept delivery by date-2”.

Further at step S720, supplier defines any financing it is willing to offer only to purchasers of this product, in similar manner as loan offers are defined at step S120 of FIG. 16H.

FIG. 21M shows operation for product supplier 3190; this figure is similar to FIG. 21K.

Section 4. Modified Benchmark Financial Planning System with Products and Financing

FIG. 22A shows the system configuration for the benchmark planning system that automatically selects products and financing. FIG. 22A is similar to FIG. 17A; for brevity, only differences will be discussed.

Reduced client database 4025 is similar to reduced client database 2025 of FIG. 17A, except that it accommodates reduced F Ss with automatically selected products.

Products database 4028 is similar to products database 3179 of FIG. 21A. Via utility program 4023, financial planning systems 4050, 4060, 4080 and benchmark program 4021 use products database 3179.

The objects in objects database 4026 represent general goals, such as “luxury sports car”, while the products in products database 4028 represent specific goals—products and services—instances of objects, such as “Ferrari 488 GTB sports car”.

Third party product supplier 4015 is similar to third party product supplier 3190 of FIG. 21A.

Supplemental product supplier 4088 is similar to supplemental product supplier 3166 of FIG. 21A.

Supplemental products database 4087 is similar to supplemental products database 3167 of FIG. 21A.

Financial planning systems 4050, 4060, 4080 and benchmark program 4021 are respectively similar to financial planning systems 2050, 2060, 2080 and benchmark program 2021 of FIG. 17A, except that each also functions:
to accept, from users, product goal definitions and authorization to automatically commit to product purchases,
to automatically select products for users,
to automatically select the best financing for products when financing is available from a variety of sources, including third-party financing provider 3180, product supplier 3190 and the user,
to accept product purchase commitments from users,
to send product purchase commitments to product providers 3190, and
to present revised and new product offers to users.

FPS software 4081 also functions to populate supplemental products database 4087 with products offered by supplemental product provider 4088.

Utility program 4023 is similar to utility program 2023 of FIG. 17A, except that it also functions:
to populate products database 4028 with products offered by product suppliers 4015,
to provide information from products database 4028 to financial planning systems 4050, 4060, 4080 and benchmark program 4021,
to create product demand curves, and
to process revised and new product offers.

FIG. 22B shows system setup for the modified benchmark FPS that automatically selects products and financing. FIG. 22B is similar to FIG. 17B; for brevity, only differences are discussed.

Step 4140, define products database, is similar to step 3270 of FIG. 21B.

Step 4150, define available product financing templates, is similar to step 3275 of FIG. 21B.

At step 4150, product financing acceptability criteria are defined by the system administrator for utility program 3176, such as:
maximum negative impact of X percent on another goal or product Y,
maximum down payment of X dollars,
maximum negative impact of X percent on wealth B[N] as of N years after purchase.

Step 4155, define available scenario-best criteria, is similar to step 2150 of FIG. 17B. Here, since products are being considered, available criteria may include:
Choose popular products—select the scenario of for which a product is affordable, i.e., B[n,t,af] exceeds the benchmark curve, and the product has the best reviews averaged across external product reviews websites. The external product reviews websites are each an instance of info service 40. The system administrator of the MBFPS identifies external product reviews websites to consult each time a product is considered for inclusion in the user's FS, normalizes the reviews (say, to a ranking of 1-5 with 5 being the best), and the MBFPS lets the user choose which external reviews are averaged for the user. This choice relies on others' experiences with suitable products to decide which product is best.
Best deal on good products—involves, during system setup, selecting reliable review sites, instances of info service 40, for each product type, and normalizing their reviews to, e.g., a five point rating system where five is best. During user setup, the user selects which review sites to rely on for each of their goal product-types (part of selecting product characteristics). During user operation, the MCFPS considers only products wherein at least 80% of the reviews are four points or better, and prefers sales or special rate financing, or if there are none, then the MCFPS selects a mid-price product with the best reviews.

Step 4160, define supplemental product, is similar to step 3280 of FIG. 21B.

Step 4180, define hypothetical product, is similar to step 3290 of FIG. 21B.

FIG. 22C shows individual setup for the modified benchmark FPS that automatically selects products and financing. FIG. 22C is similar to FIG. 17C; for brevity, only differences will be discussed.

Step 4232, user selects product characteristics, is shown in FIG. 23D.

Step 4233, user files product complaint, is similar to FIG. 21C step 3308.

Step 4299 is similar to step 2499 of FIG. 17C. The “More data structure” and “Your financial strategy set-up information” portions of the Personal Research GUI available at step 4470 of FIG. 22E are also in the General Research GUI available at step 4299.

FIG. 22D shows selection of product characteristics and is similar to FIG. 21D; for brevity, only differences will be discussed.

At step 4315, one of the characteristics that the user can specify is whether the FS should evaluate the product at its present cost or its future cost. If a product's cost seems to increase as prices increase generally, then future value is a good choice. However, if a product's price does not increase over time, or possibly drops over time, then present value is a good choice.

At step 4330, the product scenarios for this goal are the selected products from step 4320, and the ones of the sub-goals (if any), defined at step 4230 of FIG. 22C, that have a different value than the selected products. It will be recalled that the financial strategy is trying to figure out what the user can afford, so if there is a product having the sub-goal's cost, then the sub-goal is redundant. However, if a sub-goal's cost differs from all product costs, then retaining the sub-goal will provide useful information to the user in the to-be-determined FS.

FIG. 22E shows user operation for the modified benchmark FPS with automated product and financing selection, and is similar to FIG. 17D; for brevity, only differences will be discussed. Instances of the modified benchmark FPS are financial planning systems 4050, 4060, 4080 and benchmark program 4021.

At step 4420, the benchmark is determined as shown in FIG. 22F.

At step 4445, FPS 4050, 4060, 4080 or benchmark FPS program 4021 (collectively, “FPS 4021”) determines the goal-product financing scenarios based on the product scenarios created at step 4330 of FIG. 22D, and the financing templates selected at step 4335 of FIG. 22D and step 4280 of FIG. 22C.

At step 4455, the sub-goals are evaluated as shown in FIG. 22G.

Step 4465 is a test that manually or automatically determines acceptability.

Step 4470, occurring after the financial strategy is tentatively determined (before it is tested for acceptability at step 4465), for providing a personal research interface, is similar to step 2372 of FIG. 17D, except that the user can also query information relating to his/her FS, provided by FPS 4021.

The personal research interface is typically a graphical user interface (GUI) that presents a start page with a menu such as in Table 20.

TABLE 20
Personal Research GUI, Benchmark FPS with Products and Financing
Personal Research

Help
Data structure of financing offers
Statistics for financing offers
Lender information
Financing offers
Data structure of product offers
Statistics for product offers
Product supplier information
Product offers
More data structure

```
  Investments and risk parameters
  System strategies (selected investments and weights)
  Life Action templates
  Goal templates
  Financing templates
Periodic acceptability criteria
```

Your financial strategy set-up information

```
  Account information
  Life Actions
  Goals
  Product characteristics
  Product financing acceptability criteria
  Liquidatable Assets
  System strategies
  Financial plan acceptability criteria
  Accounts with third party systems
  Private financing
  Financing templates
  Periodic acceptability criteria
  Automatic loan approval
```

Your financial strategy

```
  Financial strategy
  Benchmark
  Financing offers that you were eligible for, by goal
  Financing offers that you were not eligible for, by goal
  Financing comparison
  Product offers that you were eligible for, by goal
  Product offers that you were not eligible for, by goal
  Product financing comparison
  Assets liquidated to achieve financial strategy
  Goals success likelihood
  Predicted default rate
  Success weights, Success threshold, Success of Financial Strategy
```

Dual Goal Sensitivity Analysis
Single Goal Sensitivity Analysis

Other than the first five menu items that function as described with respect to step 1450 of FIG. 16C, the next four menu items that function as described with respect to step 3350 of FIG. 21C, and the remaining menu items that function as described with respect to step 2372 of FIG. 17D, the menu items function as follows:
Your financial strategy set-up information—lets the user examine the following:
   product characteristics provided by the user at step 4320 of FIG. 22D;
   product financing acceptability criteria provided by the user at step 4322 of FIG. 22D;
Your financial strategy—lets the user examine the following:
   Product offers that you were eligible for, by goal—the product offers for the eligible scenarios of step 4625 of FIG. 22G;
   Product offers that you were not eligible for, by goal—the product offers identified at step 4610 of FIG. 22G but not included in step 4625 of FIG. 22G, with an explanation of why the user was ineligible, such as the product violated the user's periodic criteria, or the product could not be financed;
   Product financing comparison—if the user wishes, the FPS generates a table (report) comparing the financing alternatives for a product of interest according to the product financing acceptability criteria selected by the user at step 4322 of FIG. 22D, that is, a subset of the product/financing offers identified at step 4610 of FIG. 22G, see examples below. As a result of considering such a table, the user may decide to change his/her set-up information to force the FPS to choose a different financing offer.
      The Personal Research GUI also lets the user save and retrieve (not shown) his/her FS information, sensitivity analyses and goal sensitivity analyses.

In embodiments of FIG. 21A, where the API for utility program 3176 supports transferring individual user information from FPS 3150, 3160, 3170, the “More data structure” and “Your financial plan set-up information” is also available in the General Research GUI of step 3350 of FIG. 21C.

A first example of a product financing comparison report is now presented. Assume the product is a car. Table 21 shows a report comparing various forms of purchase financing, such as cash purchase (no financing needed), lease instead of buy with low or high down payment, purchase financed by longer term asset backed loan with low or high down payment, and finally, an option to take out a home equity loan (HELOC) and use it for payment for the car purchase.

TABLE 21
Example of Product Financing Comparison Report for Car

| | | | Estimated Impact | Impact on User's |
|---|---|---|---|---|
| | | Estimated Total | on User's Wealth | Retirement Goal |
| Financing | Description | Cash Flows | after 5 years | Achievement |
| 01 | Cash Purchase | $50,000 | −$20,000 | −5% |
| 02 | 5-year lease with $500 | $26,000 | −$26,000 | −3% |
| | downpayment | | | |
| 03 | 5-year lease with | $25,000 | −$25,000 | −4% |
| | $1,000 downpayment | | | |
| 04 | 10-year asset backed | $65,000 | −$24,000 | −3% |
| | financing with $1,000 | | | |
| | downpayment | | | |
| 05 | 10-year asset backed | $61,000 | −$22,000 | −2% |
| | financing with $5,000 | | | |
| | downpayment | | | |
| 06 | Home equity loan | $62,000 | −$23,000 | −2.5% |
| | (HELOC) | | | |

A second example of a product financing comparison report is now presented. Assume the product is a college education for the user's child. Table 22 shows a report comparing various forms of purchase financing, including the parent taking a personal unsecured loan, the parent taking a home equity loan, and a child participating by taking a student loan.

TABLE 22
Example of Product Financing Comparison Report for College

| | | | Estimated Impact | Impact on User's |
|---|---|---|---|---|
| | | Estimated Total | on User's Wealth | Retirement Goal |
| Financing | Description | Cash Flows | after 5 years | Achievement |
| 01 | Cash Payments | $50,000/ | −$220,000 | −25% |
| | | yr x 4 yrs | | |
| 02 | Personal 10-year loan | $250,000 | −$250,000 | −30% |
| 03 | Home equity loan | $230,000 | −$230,000 | −26% |
| 04 | Child takes 50% in | $125,000 | −$125,000 | −10% |
| | student loan, and user | | | |
| | takes personal loan | | | |
| 05 | Child takes 50% in | $115,000 | −$115,000 | −8% |
| | student loan, and user | | | |
| | takes home equity loan | | | |

At step 4480, FPS 4021 checks whether any of the product offers or any of the financing offers chosen for the FS have acceptance time constraints, indicated as “Purchase(t)” and “Loan(t)”. For instance, a product supplier may offer a product at a special price if the purchaser pays something by a first date to lock in the special price, then pays the remainder by a second date. This helps product suppliers forecast product demand. If not, processing continues at step 4490.

If a selected product or a selected loan has an acceptance time constraint, then at step 4482, the benchmark FPS prepares alternative information, so that the user can see the effect on his/her FS of not immediately committing to the product or loan with time constraints.

At step 4484, purchase commitment processing as shown in FIG. 22H or loan commitment processing as shown in FIG. 22J occurs. Step 4484 is repeated once for each product offer or loan offer with an acceptance time constraint. The relevant information prepared at step 4482 is displayed to the user during step 4484, so the user can make an informed decision on whether to immediately commit to the product or loan with a time constraint.

Since purchasing a product or accepting a loan changes the user's situation, at step 4486, the FS is updated. If a product or loan commitment does not occur at step 4484, then step 4486 is skipped.

At step 4490, the user's FS is determined.

If a relevant new product offer or loan offer occurs, see FIG. 22K steps S031 and S062, FIG. 22M step 6030, FIG. 22O step 6230, this information is received just prior to step 4495, so that the new offers can be considered when a new financial strategy is created as a result of step 4880 of FIG. 22I, or the existing financial strategy is maintained at step 4890 of FIG. 22I.

At step 4495, the financial strategy is applied as shown in FIG. 22I.

FIG. 22F shows determination of a benchmark; this figure is similar to FIG. 11B. There are no differences to discuss. FIG. 11B shows a benchmark for maximizing the number of goals achieved but not necessarily maximizing wealth. In other embodiments, other benchmarks are used.

FIG. 22G shows sub-goal evaluation and is similar to FIG. 17F; for brevity, only differences will be discussed.

Step 4630 is a test that automatically determines which goal-product financing scenario is best.

Step 4635 is a test that automatically determines whether a goal-product financing scenario is minimally acceptable.

At step 4640, the benchmark FPS checks whether the product or the financing is hypothetical.

FIG. 22H shows purchase commitment and is similar to FIG. 21G; for brevity, only differences are discussed.

At step 4705, the benchmark FPS checks whether there is a product offer that can be committed to, in the FS, and whether the product supplier has opted into automatic purchase approval. If yes, processing proceeds to step 4710. If no, processing is complete, as there is nothing to commit to.

FIG. 22I shows how the benchmark FPS applies the financial strategy and is similar to FIG. 17G; for brevity, only differences will be discussed.

At step 4830, the actions that the benchmark FPS suggest to the user may include purchasing a product and/or taking out a loan.

At step 4832, FPS 4021 determines whether to automatically commit to a purchase, as shown in FIG. 22H.

At step 4835, the benchmark FPS determines whether to automatically commit to a loan, as shown in FIG. 22J.

At step 2690, evaluation of a sub-goal in the (p, s) innermost loop is shown in FIG. 22G.

FIG. 22J shows loan commitment and is similar to FIG. 17H. There are no differences to discuss.

FIG. 22K shows creation of product and financing demand curves for a modified benchmark financial planning system with automatically selected products and financing. This figure is similar to FIG. 22I; for brevity, only differences are discussed. This figure describes activity executed by benchmark utility program 4022.

Step S044 is performed for each product type PTi defined at step 4140 of FIG. 22B

At step S046, all reduced FSs with the product type are retrieved from reduced client database 4025.

At step S048, the product demand curve is created based on the information retrieved at step S046.

FIG. 22L shows set-up for lender 4005; this figure is similar to FIG. 21J, discussed above.

FIG. 22M shows operation for lender 4005; this figure is similar to FIG. 21K, discussed above.

FIG. 22N shows set-up for product supplier 4015; this figure is similar to FIG. 21L, discussed above.

FIG. 22O shows operation for product supplier 4015; this figure is similar to FIG. 21M, discussed above.

### Use Cases

An actual financial plan is typically about 50 pages long, and is thus too voluminous to provide as a use case. For brevity, the following use cases are greatly abridged. All of the use cases assume two similar starting goals, so that the FPS results can be readily compared.

### First Use Case: Conventional FPS

Assume that, at step 205 of FIG. 3C, the user has defined two goals, retirement and car purchase, as shown in Table 23. The retirement goal represents the user's desire to retire in 480 months (40 years), and live for 20 years until month 720 on a monthly income of $9,000. The car goal represents the user's desire to buy a car for $50,000 in three years (36 months), estimating that the car will last for ten years, and cost about $1,000 per month to operate (parking, gas, insurance, registration fees).

TABLE 23
User Setup: Goal Definition for Conventional FPS

| | | |
|---|---|---|
| Goal-ID | g = 1 | g = 2 |
| Description | Retirement | Car Purchase |
| Goal Value G[g] ($) | 0 | 50,000 |
| Goal Start Date GS[g] | month 480 | month 36 |
| Goal End Date GE[g] | month 720 | month 156 |
| Goal Cash Flow per | 9,000 | 1,000 |
| month GCF[t, g] ($) | | |

Based on the user's assets, income and simulations of investment performance, the FPS creates a FP to achieve the user's goals, as shown in FIG. 3D. The FP is shown in Table 24, and Table 25 is an excerpt of an exemplary financial plan report for this use case.

TABLE 24
Exemplary FP

| Source | Description | FP Setting |
|---|---|---|
| System | Date Updated | Feb. 21, 2021 |
| User | Initial Savings Balance | $2,000 |
| User | User Age | 28 |
| System | Time periods T | 720 months (60 years) |
| User | Expected Income | INC[t], t = 1 . . . 720 |
| User | Expected Expenses | EXP[t], t = 1 . . . 720 |
| User | Goal-1 Name | Retirement |
| User | Goal-1 Start Period | t = 480 (user age 68) |
| System | Goal-1 End Period | t = 720 |
| User | Goal-1 Income Start | 0 |
| User | Goal-1 Expenses Period | 9000 |
| System | Goal success likelihd | 88 |
| | Goal-1 | |
| User | Goal-2 Name | Car Purchase |
| User | Goal-2 Start Period | t = 36 |
| User | Goal-2 End Period | t = 156 (10 yr. life) |
| User | Goal-2 Income Start | −50,000 (cost of car) |
| User | Goal-2 Expenses Period | 1,000 |
| System | Goal success likelihd | 65 |
| | Goal-2 | |
| User | Investment I-1 | Stock Fund, Small Molecule |
| | | Pharma |
| System | Investment I-1 ID | INV-1023-0387 |
| User | Investment weight wI-1 | 20 |
| User | Investment I-2 | Stock Index Fund, Russell |
| | | 1000 |
| System | Investment I-2 ID | INV-1023-0166 |
| User | Investment weight wI-2 | 40 |
| User | Investment I-3 | Stock ETF, China Large |
| | | Companies |
| System | Investment I-3 ID | INV-0688-0721 |
| User | Investment weight wI-3 | 10 |
| User | Investment I-4 | Municipal Bond Fund |
| System | Investment I-4 ID | INV-0688-0004 |
| User | Investment weight wI-4 | 10 |
| User | Investment I-5 | Money Market Fund |
| System | Investment I-5 ID | INV-0002-0007 |
| User | Investment weight wI-5 | 20 |

TABLE 25
Conventional FPS: Financial Plan Report excerpt
Conventional FPS, Financial Plan Excerpt

| Date Prepared Feb. 21, 2021 | |
|---|---|
| Your Goals | |
| (1) Retirement with $9,000 monthly | |
| income at month 240. | |
| (2) Car Purchase of $50,000 at month | |
| 36 with $1,000 monthly operating costs. | |
| Your Goals Success Likelihood | |
| Retirement | 88% |
| Car Purchase | 65% |

| Your Investment Plan | |
|---|---|
| Stock Fund, Small Molecule Pharma | 20% |
| Stock Index Fund, Russell 1000 | 40% |
| Stock ETF, China Large Companies | 10% |
| Municipal Bond Fund | 10% |
| Money Market Fund | 20% |

### Second Use Case: Benchmark FPS

Assume that, at step 730 of FIG. 10, the user has defined retirement and car goals as shown in Table 26. Note that the Retirement goal has a flexible start date, between 20 and 26 years from today (240-312 months) and a fixed end date of 40 years (480 months) from today. Note that the car goal has a flexible cost, and has been split into four subgoals: a $20,000 car, a $30,000 car, a $40,000 car and a $50,000 car.

TABLE 26
User Setup: Goal Definition for Benchmark FPS

| | | |
|---|---|---|
| Goal-ID | g = 1 | g = 2 |
| Description | Retirement | Car Purchase |
| Priority | Medium (2) | High(1) |
| Goal Initial Cost G[g] | 0 | range: 20,000-50,000 |
| ($) | | subgoal1: 20,000 |
| | | subgoal2: 30,000 |
| | | subgoal3: 40,000 |
| | | subgoal4: 50,000 |
| Goal Start Date GS[g] | range: 360-600 | month 36 |
| | subgoal1: 360 | |
| | subgoal2: 480 | |
| | subgoal3: 600 | |
| Goal End Date GE[g] | month 720 | month 156 |
| Goal Cost per month | 9,000 | 1,000 |
| GCF[t, g] ($) | | |

Based on the user's assets, income and simulated investment performance, as shown in FIGS. 11A-11C, the BFPS creates a FS, shown in Table 27 to achieve the user's goals.

TABLE 27
Exemplary FS

| Source | Description | FP Setting |
|---|---|---|
| System | Date Updated | Feb. 21, 2021 |
| User | Initial Savings Balance | $2,000 |
| User | User Age | 28 |
| System | Time periods T | 720 months (60 years) |
| User | Expected Income | INC[t], t = 1 . . . 720 |
| User | Expected Expenses | EXP[t], t = 1 . . . 720 |
| Use | Liquidatable Asset ($) | 10,000 (diamond ring) |
| User | Priority levels | 2 |
| User | Acceptability | p = 1: 95 |
| | | p = 2: 90 |
| User | Goal-1 Name | Retirement |
| User | Goal-1 Priority | 2 (Medium) |
| User | Goal-1 Start Period Range | t = 360-600 (user age 58-78) |
| User | Goal-1 Start Period subgoal1 | 360 |
| User | Goal-1 Start Period subgoal2 | 480 |
| User | Goal-1 Start Period subgoal2 | 600 |
| System | Goal-1 End Period | t = 720 |
| User | Goal-1 Income Start | 0 |
| User | Goal-1 Expenses Period | 9000 |
| System | Goal success likelihood | subgoal1: 43 |
| | Goal-1 | subgoal2: 88 |
| | | subgoal3: 95 |
| User | Goal-2 Name | Car Purchase |
| User | Goal-2 Priority | 1 (High) |
| User | Goal-2 Start Period | t = 36 |
| User | Goal-2 End Period | t = 156 (10 yr. life) |
| User | Goal-2 Cost Range | 20,000-50,000 |
| User | Goal-2 Cost subgoal1 | 20,000 |
| User | Goal-2 Cost subgoal2 | 30,000 |
| User | Goal-2 Cost subgoal3 | 40,000 |
| User | Goal-2 Cost subgoal4 | 50,000 |
| User | Goal-2 Expenses Period | 1,000 |
| System | Goal success likelihood | subgoal1: 99 |
| | Goal-2 | subgoal2: 86 |
| | | subgoal3: 70 |
| | | subgoal4: 65 |
| System | Benchmark curves | Benchmark_p1 (pointer |
| | | to curve) |
| | | Benchmark_p1 (pointer |
| | | to curve) |
| User | System strategy: Core no. | 5 |
| | invest | |
| User | SS: Core Investment I-1 | Stock Fund, Small Molecule |
| | | Pharma |
| System | SS: Core Investment I-1 ID | INV-1023-0387 |
| User | SS: Core Investment weight | 0.20 |
| | wI-1 | |
| User | SS: Core Investment I-2 | Stock Index Fund, Russell |
| | | 1000 |
| System | SS: Core Investment I-2 ID | INV-1023-0166 |
| User | SS: Core Investment weight | 0.40 |
| | wI-2 | |
| User | SS: Core Investment I-3 | Stock ETF, China Large |
| | | Companies |
| System | SS: Core Investment I-3 ID | INV-0688-0721 |
| User | SS: Core Investment weight | 0.10 |
| | wI-3 | |
| User | SS: Core Investment I-4 | Municipal Bond Fund |
| System | SS: Core Investment I-4 ID | INV-0688-0004 |
| User | SS: Core Investment weight | 0.10 |
| | wI-4 | |
| User | SS: Core Investment I-5 | Money Market Fund |
| System | SS: Core Investment I-5 ID | INV-0002-0007 |
| User | SS: Core Investment weight | 0.20 |
| | wI-5 | |

Compared to the FP of Table 24, the FS of Table 27 includes liquidatable assets, priority levels, acceptability thresholds by priority levels, goal priority levels, a goal (retirement) start date expressed as a range, a goal (car) value expressed as a range, subgoals for goal parameters with ranges, goals success likelihood by subgoal, benchmark curves by priority levels, and the ability to have multiple investment strategies (only one strategy is shown in this FS).

An excerpt of an exemplary benchmark financial strategy report is shown in Table 28, and an example of periodic advice is shown in Table 29. The periodic advice is generated at FIG. 11C step 1030.

TABLE 28
Benchmark FPS, Financial Strategy Report Excerpt
Benchmark Financial Planning System, Financial Strategy Excerpt

Date Prepared Feb. 21, 2021
Your Goals
Priority HIGH, Acceptability required by you 95%
Goal: Car Purchase in month 36

| Sub-goal | Probability of Achieving |
|---|---|
| $20,000 car | 99% |
| $30,000 car | 86% |
| $40,000 car | 70% |
| $50,000 car | 65% |

| | |
|---|---|
| Able to Car Purchase (most likely sub-goal) | 99% |
| Unable to Car Purchase | 1% |
| Total | 100% |

Priority MEDIUM, Acceptability required by you 90%
Goal: Retirement with $9,000 monthly income

| Sub-goal | Probability of Achieving |
|---|---|
| Retire at month 360 | 43% |
| Retire at month 480 | 88% |
| Retire at month 600 | 95% |

| | |
|---|---|
| Able to Retire (most likely sub-goal) | 95% |
| Unable to Retire | 5% |
| Total | 100% |

Your Investment Plan

| | |
|---|---|
| Stock Fund, Small Molecule Pharma | 20% |
| Stock Index Fund, Russell 1000 | 40% |
| Stock ETF, China Large Companies | 10% |
| Municipal Bond Fund | 10% |
| Money Market Fund | 20% |

TABLE 29
Benchmark FPS, Periodic Advice Excerpt
Benchmark Financial Planning System,
Periodic Advice Excerpt
Date: Start of month 360 = Mar. 1, 2051
Do not retire yet. Insufficient savings to fund
retirement goal with $9,000 monthly income.
Update for Retirement Goal
Goal: Retirement with $9,000 monthly income

| | |
|---|---|
| Sub-goal | Probability |
| | of Achieving |

| | |
|---|---|
| Retire at month 360 | 0% |
| Retire at month 480 | 88% |
| Retire at month 600 | 95% |

| | |
|---|---|
| Able to Retire (most likely sub-goal) | 95% |
| Unable to Retire | 5% |
| Total | 100% |

Comparing goal results between the Conventional FPS and the Benchmark FPS, it is seen that the Benchmark FPS results are more helpful because, when the user has flexibility in the timing and cost of a goal, the BFPS can show the user the value of such flexibility with respect to achieving their goals. Given the range of success likelihoods shown by a BFPS, the user is likely to better understand that their actions impact their financial futures, and so be more motivated to act responsibly over the long term.

### Third Use Case: MCFPS with Automated Financing Selection

Turning to the MCFPS of FIG. 16, assume that the user is financial planner 1264 making a plan for his client number 345 on 2/21/2021 so t=1=3/1/2021, and that the financing offers in supplemental financing database 1265 (available to the user) and financing database 1278 of utility system 1275, along with the user's private financing offer in client database 1263 are as shown in Table 30. In a real situation, far more offers are available.

TABLE 30
Exemplary Financing Offers

| | | | | | |
|---|---|---|---|---|---|
| 1 | Record Location | Financing | Financing | Supplemental | Client |
| | | Database 1278 | Database 1278 | Database 1265 | Database 1263 |
| 2 | Record ID | TPFOffer-1 | TPFOffer-2 | TPFOffer-9 | UFOffer-1 |
| 3 | Financing Provider | Yoyo Bank | Zebra Bank | Atlantis Bank | Aunt Agatha |
| 4 | Financing Type | Car purchase | Car purchase | Car purchase | Anything |
| 5 | Minimum Amount ($K) | 1 | 1 | 1 | 10 |
| 6 | Maximum Amount ($K) | 50 | 50 | 20 | 10 |
| 7 | Security Interest (Lien) | Yes | Yes | Yes | No |
| 8 | Maximum Percent | 80 | 85 | 80 | 100 |
| | of Item Value | | | | |
| 9 | One-Time Fee ($) | 0 | 0 | 0 | 0 |
| 10 | Term (months) | 60 | 84 | 60 | 120 |
| 11 | Interest Rate | Prime + 4% | Prime + 3% | Prime + 1% | 0% |
| 12 | Principal Repayment | Amortize | Amortize | Balloon | Balloon |
| 13 | Accept By | NA | NA | NA | Mar. 21, 2022 |
| 14 | Prepayment Penalty | 0 | 0 | 0 | 0 |
| 15 | Borrower payments | 30 | 30 | NA | NA |
| | max % of income | | | | |
| 16 | Borrower max PDR % | 10 | 8 | 05 | NA |

Also assume that information provided during user set-up is as in Tables 31 and 32.

TABLE 31
MCFPS Exemplary user parameters

| | | | |
|---|---|---|---|
| 1 | FIG.:Step | Record | Client Database 1263 |
| 2 | 16C:1401 | Unique ID | FPS1260USER1264CLIENT0345 |
| 3 | 16C:1405 | Initial Savings Balance | $2,000 |
| 4 | 16C:1405 | User Age | 28 |
| 5 | 16C:1405 | Time periods T | 720 months (60 years) |
| 6 | 16C:1405 | Income | INC[t], t = 1 . . . 720 |
| 7 | 16C:1405 | Expenses | EXP[t], t = 1 . . . 720 |
| 8 | 16C:1405 | Goals | see Table 23 |
| 9 | 16C:1425 | Private financing | see Table 30 (Aunt Agatha) |
| 10 | 16C:1430 | Financing templates | Specified Goal = Car, |
| | | | Private Additional |
| 11 | 16C:1435 | Financial plan acceptability criteria | FP_PDR < PDR-Threshold, |
| | | | PDR-Threshold = 12% |
| 12 | 16C:1440 | Financial plan optimality criteria | Minimize PDR |

TABLE 32
MCFPS Exemplary Goals

| | | |
|---|---|---|
| Goal-ID | g = 1 | g = 2 |
| Description | Retirement | Car Purchase |
| Goal Value G[g] ($) | 0 | 50,000 |
| Goal Start Date GS[g] | t = 480 (user age 68) | t = 36 |
| Goal End Date GE[g] | t = 720 | t = 156 (10 yr. life) |
| Goal Cash Flow per | 9,000 | 1,000 |
| month GCF[t, g] ($) | | |

For lines 6 and 7 of Table 28, it will be understood that the user provides actual values for her expected future income and expenses at each time period, but for brevity of this use case, the values are indicated as INC[t] and EXP[t].

At the start of operation, see FIG. 16D step 1510, the user defines available investments INV[v], v=1 . . . V, and risk parameters.

At FIG. 16D step 1520, software 1262 generates the Scenario Investment Returns SIR[n,t,v], n=1 . . . 1,000 (N=1,000), t=1 . . . 720 (T from Table 28 line 5), v=1 . . . V (V specified in step 1510).

At FIG. 16D step 1530, software 1262 determines the financing scenarios. Only the car goal g=2 is suitable for financing.

First, based on the user's selected financing templates (see Table 28, line 10), software 1262 determines there are at least five financing scenarios involving cash only (always evaluated) and private financing:
1. cash only,
2. private financing only,
3. private and supplemental financing,
4. private and third party financing,
5. private and supplemental and third party financing.

At this point, all the financing offers in Table 27 are available for consideration. In practice, many more financing offers are available. Since there is one instance of private financing (Aunt Agatha), one instance of supplemental financing (Atlantis Bank) and two instances of third party financing (Yoyo Bank and Zebra Bank), software 1262 determines that there are seven financing scenarios:
1. cash only,
2. private financing (Agatha) only,
3. private (Agatha) and supplemental (Atlantis) financing,
4. private (Agatha) and third party (Yoyo) financing,
5. private (Agatha) and third party (Zebra) financing,
6. private (Agatha) and supplemental (Atlantis) and third party (Yoyo) financing,
7. private (Agatha) and supplemental (Atlantis) and third party (Zebra) financing.

Next, for each financing offer, software 1262 checks whether the user meets the lender's criteria.

Private lender Aunt Agatha merely requires acceptance by Mar. 21, 2022. This is before the user wants to buy the car, but since Agatha does not require a security interest, the user can accept Agatha's offer and just use Agatha's money as an investment until it is needed for the car. So, if the user accepts Agatha's maximum offer of $10,000, as of the first planning period t=1=3/1/2021, there will be immediate income INC[t=1]=10,000, no interest payments, and a balloon principal payment in ten years EXP[t=120]=10,000.

Supplemental lender Atlantis Bank requires a security interest, so the loan must occur as of when the car is purchased in three years. Assuming use of the maximum offer for its maximum duration of 5 years, there will be income INC[t=36]=20,000, EXP[t=36 . . . 96]=20,000*(Prime+1%), and a balloon payment EXP[t=96]=20,000. Atlantis will lend up to 80% of the car's value (Table 27, line 8); since the car's value is $50,000, and 20,000<0.8*50,000, the maximum loan amount is eligible.

However, Atlantis requires a maximum PDR of 5% (Table 27 line 16). The user has specified PDR-Threshold=12% (see Table 28, line 11). So that the user meets Atlantis's criteria, software 1262 changes PDR-Threshold to 5% when supplemental financing from Atlantis is used. This is an example of a user's risk tolerance being affected by a lender.

Third party lender Yoyo Bank requires a security interest, so the loan must occur as of when the car is purchased in three years and is willing to lend for 5 years (Table 27, line 10). Yoyo is willing to lend up to $50,000 (Table 27, line 6) but no more than 80% of the item's value (Table 27, line 8)=0.8*$50,000=$40,000. When the user uses Yoyo's offer, the user is getting money from Agatha ($10,000) and possibly Atlantis ($20,000), so the user will rely on Yoyo for $40,000 (car value−Agatha loan) or $20,000 (car value—Agatha loan—Atlantis loan). The user will have income from Yoyo in month 36, and amortize the loan amount over 60 payments using an interest rate of Prime+4%.

Yoyo requires that its repayments not exceed 30% of the borrower's income. At this point, software 1262 can estimate whether the Yoyo payments will exceed the user's expected income INC[t], such as from salary, and investment income during t=36 . . . 96. Checking again after the draft FP has estimated investment income via simulations is prudent.

Yoyo requires a maximum PDR of 10% (Table 27 line 16). The user has specified PDR-Threshold=12% (see Table 28, line 11). So that the user meets Yoyo's criteria, software 1262 changes PDR-Threshold to 10% when third party financing from Yoyo is used. If supplemental financing from Atlantis is being used, then software 1262 will have changed PDR-Threshold to 5%, and that is well within Yoyo's criteria.

Similar analysis applies for Zebra Bank's loan offer.

At this point, software 1262 lacks reason to eliminate any of the seven financing scenarios, so it maintains all of them.

At FIG. 16D, step 1535, software 1262 determines the Iteration Plan (draft FP) for the user.

Turning to FIG. 16E, at step 1600, financial planner 1264 creates a trial financial plan by manually selecting investments I[k], k=1 K, from the eligible investments INV[v], v=1 . . . V, defined at step 1510, and manually selecting investment weights wI[k], k=1 . . . K. For brevity, the actual trial financial plan is not shown here.

In some embodiments, software 1262 automatically provides default investment weights that weight investments equally, i.e., for K investments, each w1[k]=1/K. The user can manually override the defaults. Usually, software 1262 automatically requires that SUM(wI[k])=1, k=1 . . . K.

At step 1610, before evaluating each of the financing scenarios at step 1620, software 1262 adjusts the goals to reflect financing in that scenario. In accordance with the above discussion, Table 33 shows the goal adjustments for the financing scenarios.

TABLE 33
Goal Adjustments for Financing Scenarios at FIG. 16E step 1610

| | | Income | | Expenses, Periodic | | Expenses, Balloon | | |
|---|---|---|---|---|---|---|---|---|
| | | t | amt | t | amt | t | amt | PDR-Thresh |
| Fin'g | Goal | 36 | −50000 | 36 . . . 156 | 1000 | 0 | 0 | 12 |
| Scen. 1 | Priv | — | 0 | — | 0 | — | 0 | — |
| | Supp | — | 0 | — | 0 | — | 0 | — |
| | TPF | — | 0 | — | 0 | — | 0 | — |
| | Adj | t[36]: −50000 | | t[36 . . . 156]: 1000 | | 0 | | 12 |
| | Goal | | | | | | | |
| Fin'g | Goal | 36 | −50000 | 36 . . . 156 | 1000 | 0 | 0 | 12 |
| Scen. 2 | Priv, | 1 | 10000 | — | 0 | 120 | 10000 | — |
| | Agatha | | | | | | | |
| | Supp | — | 0 | — | 0 | — | 0 | — |
| | TPF | — | 0 | — | 0 | — | 0 | — |
| | Adj | t[1]: 10000 + | | t[36 . . . 156]: 1000 | | t[120]: 10000 | | 12 |
| | Goal | t[36]: −50000 | | | | | | |
| Fin'g | Goal | 36 | −50000 | 36 . . . 156 | 1000 | 0 | 0 | 12 |
| Scen. 3 | Priv, | 1 | 10000 | — | 0 | 120 | 10000 | 12 |
| | Agatha | | | | | | | |
| | Supp, | 36 | 20000 | 36 . . . 96 | AA = 20000* | 96 | 20000 | 5 |
| | Atlantis | | | | (Prime + 1%) | | | |
| | TPF | | 0 | — | 0 | — | 0 | — |
| | Adj | t[1]: 10000 + | | t[36 . . . 96]: 1000 + AA + | | t[96]: 20000 + | | 5 |
| | Goal | t[36]: −30000 | | t[97 . . . 156]: 1000 | | t[120]: 10000 | | |
| Fin'g | Goal | 36 | −50000 | 36 . . . 156 | 1000 | 0 | 0 | 12 |
| Scen. 4 | Priv, | 1 | 10000 | | 0 | 120 | 10000 | 12 |
| | Agatha | | | | | | | |
| | Supp | — | 0 | — | 0 | — | 0 | — |
| | TPF, | 36 | 40000 | 36 . . . 96 | BB = | — | 0 | 10 |
| | Yoyo | | | | AMTZ(40000, | | | |
| | | | | | Prime + 4%, 60) | | | |
| | Adj | t[1]: 10000 + | | t[36 . . . 96]: 1000 + BB + | | t[120]: 10000 | | 10 |
| | Goal | t[36]: −10000 | | t[97 . . . 156]: 1000 | | | | |
| Fin'g | Goal | 36 | −50000 | 36 . . . 156 | 1000 | 0 | 0 | 12 |
| Scen. 5 | Priv, | 1 | 10000 | | 0 | 120 | 10000 | 12 |
| | Agatha | | | | | | | |
| | Supp | — | 0 | — | 0 | — | 0 | — |
| | TPF, | 36 | 40000 | 36 . . . 120 | CC = | — | 0 | 8 |
| | Zebra | | | | AMTZ(40000, | | | |
| | | | | | Prime + 3%, 84) | | | |
| | Adj | t[1]: 10000 + | | t[36 . . . 120]: 1000 + CC | | t[120]: 10000 | | 8 |
| | Goal | t[36]: −10000 | | + t[121 . . . 156]: 1000 | | | | |
| Fin'g | Goal | 36 | −50000 | 36 . . . 156 | 1000 | 0 | 0 | 12 |
| Scen. 6 | Priv, | 1 | 10000 | — | 0 | 120 | 10000 | 12 |
| | Agatha | | | | | | | |
| | Supp, | 36 | 20000 | 36 . . . 96 | AA = 20000* | 96 | 20000 | 5 |
| | Atlantis | | | | (Prime + 1%) | | | |
| | TPF, | 36 | 20000 | 36 . . . 96 | DD = | — | 0 | 10 |
| | Yoyo | | | | AMTZ(20000, | | | |
| | | | | | Prime + 4%, 60) | | | |
| | Adj | t[1]: 10000 + | | t[36 . . . 96]: | | t[96]: 20000 + | | 5 |
| | Goal | t[36]: −10000 | | 1000 + AA + DD + | | t[120]: 10000 | | |
| | | | | t[97 . . . 156]: 1000 | | | | |
| Fin'g | Goal | 36 | −50000 | 36 . . . 156 | 1000 | 0 | 0 | 12 |
| Scen. 7 | Priv, | 1 | 10000 | — | 0 | 120 | 10000 | 12 |
| | Agatha | | | | | | | |
| | Supp, | 36 | 20000 | 36 . . . 96 | AA = 20000* | 96 | 20000 | 5 |
| | Atlantis | | | | (Prime + 1%) | | | |
| | TPF, | 36 | 20000 | 36 . . . 120 | EE = | — | 0 | 8 |
| | Zebra | | | | AMTZ(20000, | | | |
| | | | | | Prime + 3%, 84) | | | |

| | | | | |
|---|---|---|---|---|
| Adj | t[1]: 10000 + | t[36 . . . 96]: | t[96]: 20000 + | 5 |
| Goal | t[36]: −10000 | 1000 + AA + EE + | t[120]: 10000 | |
| | | t[97 . . . 120]: 1000 + EE + | | |
| | | t[121 . . . 156]: 1000 | | |

For example, Table 33 shows that for the seventh financing scenario FS 7, using private financing from Aunt Agatha, supplemental financing from Atlantis Bank, and third party financing from Zebra Bank, the adjusted goal of the car corresponds to income of $10,000 at t=1 when Aunt Agatha's loan is accepted, and spending of $10,000 at t=36 when the car is purchased. So, the user does not have to dig into her savings to buy the $50,000 car at t=36.

However, during t=36 . . . 96, the user has monthly expenses of $1,000 for the car plus AA=$20,000*(monthly Prime+1%) for paying interest-only on the Atlantis loan plus EE=amortization of $20,000 from Zebra Bank at (monthly Prime+3%) interest over 84 months.

At t=96, the user must make a balloon payment to Atlantis Bank of $20,000.

During t=97 . . . 120, the user has monthly expenses of $1,000 for the car plus EE amortization payments to Zebra Bank.

At t=120, the user must make a balloon payment to Aunt Agatha of $10,000.

During t=121 . . . 156, the user has no monthly car loan payments, and just has monthly car expenses of $1,000. At t=156, the car is at the end of its life and must be replaced, or the user must use public and/or private transportation services and forego the convenience of having her own car.

Finally, because supplemental financing from Atlantis Bank is being used in the seventh financing scenario, the user is forced into a maximum PDR-Threshold of 5%.

Prior to creating a draft FP, software 1262 converts the parameter-based expressions to actual values, such as by estimating the monthly Prime rate at the start of financing, or perhaps using the current monthly Prime rate as an estimation. Then, software 1262 estimates whether the maximum percent of borrower monthly income criteria for Yoyo Bank and Zebra Bank (see Table 29 line 15) are met based on the user's expected income and its estimate of investment performance. Assume that these criteria are met.

At FIG. 16E step 1620, software 1262 creates a draft FP for each of the seven financing scenarios in Table 33.

At FIG. 16E step 1625, software 1262 determines the goals success likelihood (GSL) and predicted default rate (PDR) for each of the seven financing scenarios. Assume that the PDRs for the draft FPs are as in Table 34.

TABLE 34
PDRs determined for draft FPs, by financing scenario

| | Financing Scenario | | | | | | |
|---|---|---|---|---|---|---|---|
| | 1 | 2 | 3 | 4 | 5 | 6 | 7 |
| Draft FP | 86 | 75 | 50 | 8.5 | 6.5 | 8 | 6 |
| PDR (%) | | | | | | | |

At FIG. 16E step 1630, the draft FPs for the first and second financing scenarios indicate a high default probability because the user lacks enough cash to buy her desired car.

In the third financing scenario, the supplemental financing from Atlantis helps, but still results in a high PDR.

The draft FPs for the fourth to seventh financing scenarios each include sufficient financing so that the user does not have to dig into her meagre savings to buy the $50,000 car at t=36, resulting in PDRs under 10%.

But, the draft FPs for the sixth and seventh financing scenarios, relying on financing from Atlantis Bank, flunk the financial plan acceptability criteria, because the simulated PDR is greater than the acceptable PDR of 5%. In other words, to use the Atlantis financing, the user cannot take sufficient investment risk to achieve her retirement goal.

At FIG. 16E step 1670, the eligible draft FPs are those for the fourth and fifth financing scenarios, relying on financing from Aunt Agatha and one of Yoyo Bank or Zebra Bank, and having a determined PDR of 8.5% and 6.5%, respectively. These draft FPs plans are eligible because their PDRs are below the PDR borrower criteria of 10% and 8% for Yoyo Bank and Zebra Bank, respectively. The user chose minimum PDR as her optimality criteria (see Table 28 line 12), so the draft FP for the fifth scenario is used as the chosen FP.

Returning to FIG. 16D, at step 1540, the user manually looks at the chosen FP and finds it acceptable.

At FIG. 16D step 1550, software 1262 stores the settings for the chosen FP, shown in Table 35, in client database 1263. At FIG. 16D step 1585, software 1262 uses a subset of the settings stored at step 1550 to create the reduced FP shown in Table 35. Using the API for utility software 1276, software 1262 sends the reduced FP to utility software 1276, that stores the reduced FP in reduced client database 1277. Table 36 shows an excerpt of an exemplary FP report available at FIG. 16D step 1550, based on the FP shown in Table 35.

TABLE 35
Exemplary settings for chosen FP and reduced FP

| Source | Description | Chosen FP Setting | In Reduced FP |
|---|---|---|---|
| System | Unique ID | FPS1260USER1264CLIENT0345 | Yes |
| System | Date Updated | Feb. 21, 2021 | Yes |
| User | Initial Savings Balance | $2,000 | Yes |
| User | User Age | 28 | Yes |
| System | Time periods T | 720 months (60 years) | Yes |
| User | Expected Income | INC[t], t = 1 . . . 720 | — |
| User | Expected Expenses | EXP[t], t = 1 . . . 720 | — |
| User | Goal-1 Name | Retirement | Yes |
| User | Goal-1 Start Period | t = 480 (user age 68) | Yes |
| System | Goal-1 End Period | t = 720 | Yes |
| User | Goal-1 Income Start | 0 | Yes |
| User | Goal-1 Expenses Period | 9000 | Yes |
| System | Goal success likelihd Goal-1 | 86 | Yes |
| User | Goal-2 Name | Car Purchase | Yes |
| User | Goal-2 Start Period | t = 36 | Yes |
| User | Goal-2 End Period | t = 156 (10 yr. life) | Yes |
| User | Goal-2 Income Start | −50,000 (cost of car) | Yes |
| User | Goal-2 Expenses Period | 1,000 | Yes |
| System | Goal success likelihd Goal-2 | 99 | Yes |
| User | Financing template -1 | Specified Goal = Car, | — |
| User | Financing template -2 | Private Additional | — |
| User | FP acceptability criteria | FP_PDR < (PDR-Threshold = 12%) | — |
| User | FP optimality criteria | Minimize PDR | — |
| User | Fing-1 Category | Private | Yes |
| System | Fing-1 Goal | Goal-2 (Car Purchase) | Yes |
| System | Fing-1 Record ID | UFOffer-1 | — |
| User | Fing-1 Provider | Aunt Agatha | — |
| User | Fing-1 Type | Anything | — |
| System | Fing-1 Start Amount | 10,000 | Yes |
| System | Fing-1 Start Date | t = 1 | — |
| User | Fing-1 Monthly Payment | 0 | — |
| User | Fing-1 End Payment | 10,000 | — |
| System | Fing-1 End Date | t = 120 | — |
| User | Fing-1 Security Interest | No | — |
| User | Fing-1 Max % of Value | 100 | — |
| User | Fing-1 One-Time Fee | 0 | — |
| User | Fing-1 Interest Rate | 0 | — |
| User | Fing-1 Principal Repayment | Balloon | — |
| User | Fing-1 Accept By | 3/21/2022 | — |
| User | Fing-1 Payments Max % Inc | — | — |
| User | Fing-1 Max PDR tolerated | 100 | — |
| System | Fing-2 Category | Third party | Yes |
| System | Fing-2 Goal | Goal-2 (Car Purchase) | Yes |
| System | Fing-2 Record ID | TPFOffer-2 | — |
| System | Fing-2 Provider | Zebra Bank | — |
| System | Fing-2 Type | Car purchase | Yes |
| System | Fing-2 Start Amount | 40,000 | Yes |
| System | Fing-2 Start Date | t = 36 | Yes |
| System | Fing-2 Monthly Payment | 591 | Yes |
| System | Fing-2 End Payment | 0 | Yes |
| System | Fing-2 End Date | t = 120 | Yes |
| System | Fing-2 Security Interest | Yes | Yes |
| System | Fing-2 Max % of Value | 85 | Yes |
| System | Fing-2 One-Time Fee | 0 | Yes |
| System | Fing-2 Interest Rate | Prime + 3% | Yes |
| System | Fing-2 Principal Repayment | Amortize | Yes |
| System | Fing-2 Accept By | — | Yes |
| System | Fing-2 Payments Max % Inc | 30 | Yes |
| System | Fing-2 Max PDR tolerated | 8 | Yes |
| User | Investment I-1 | Stock Fund, Small Molecule Pharma | Yes |
| System | Investment I-1 ID | INV-1023-0387 | Yes |
| User | Investment weight wI-1 | 20 | — |
| User | Investment I-2 | Stock Index Fund, Russell 1000 | Yes |
| System | Investment I-2 ID | INV-1023-0166 | Yes |
| User | Investment weight wI-2 | 40 | — |
| User | Investment I-3 | Stock ETF, China Large Companies | Yes |
| System | Investment I-3 ID | INV-0688-0721 | Yes |
| User | Investment weight wI-3 | 10 | — |
| User | Investment I-4 | Municipal Bond Fund | Yes |
| System | Investment I-4 ID | INV-0688-0004 | Yes |
| User | Investment weight wI-4 | 10 | — |
| User | Investment I-5 | Money Market Fund | Yes |
| System | Investment I-5 ID | INV-0002-0007 | Yes |
| User | Investment weight wI-5 | 20 | — |
| System | Predicted Default Rate | 6.5 | Yes |

TABLE 36
MCFPS: Financial Plan Report excerpt
MCFPS, Financial Plan Excerpt

| Date Prepared Feb. 21, 2021 | | |
|---|---|---|
| Your Goals | | |
| (1) Retirement with $9,000 monthly income at month 240. | | |
| (2) Car Purchase of $50,000 at month 36 with $1,000 | | |
| monthly operating costs. | | |
| Your Goals Success Likelihood | | |
| Retirement | 86% | |
| Car Purchase | 99% | |
| Financings selected for your Car Purchase | | |
| $10,000 Private Loan from Aunt Agatha | | |
| Accept loan immediately, acceptance required by | | |
| Mar. 21, 2022 | | |
| 0% interest payments | | |
| Balloon payment of $10,000 at month 120 (Mar. 1, 2031) | | |
| $40,000 Third Party Loan from Zebra Bank | | |
| Must buy car at start of loan, as Zebra Bank demands | | |
| security interest | | |
| Receive $40,000 at month 36 (Mar. 1, 2024) | | |
| Make $591 monthly amortization payments from | | |
| Apr. 1, 2024 to Mar. 1, 2031 | | |
| Loan fully repaid at Mar. 1, 2031 | | |
| Your Investment Plan | | |
| Stock Fund, Small | | 20% |
| Molecule Pharma | | |
| Stock Index Fund, Russell | | 40% |
| 1000 | | |
| Stock ETF, China Large | | 10% |
| Companies | | |
| Municipal Bond Fund | | 10% |
| Money Market Fund | | 20% |

Your predicted default
rate 6.5%

Comparing the first and third use cases, it will be seen that that goal success likelihood for retirement has slightly dropped from 88% to 86%, but the goal success likelihood for the car purchase has increased from 65% to a whopping 99%, showing that FPs with higher success in achieving near-term goals result from automatically considering financing.

### Fourth Use Case: MBFPS with Automated Financing Selection

Turning to the MBFPS of FIG. 17, assume the same goals as in Table 26, and the same loan offers as in Table 30, stored in financing database 2027 and client database 2024. Also assume user parameters shown in Table 37. Comparing Table 37 to Table 31, it will be seen that the user provides more information to the MBFPS than to the MCFPS

TABLE 37
MBFPS
Exemplary user parameters

| | | | |
|---|---|---|---|
| 1 | FIG.:Step | Record | Client Database 2024 |
| 2 | 17C:2201 | Unique ID | FPS2020USER2010CLIENT0345 |
| 3 | 17C:2220 | Initial Savings Balance | $2,000 |
| 4 | 17C:2220 | User Age | 28 |
| 5 | 17C:2220 | Time periods T | 720 months (60 years) |
| 6 | 17C:2225 | Income | INC[t], t = 1 . . . 720 |
| 7 | 17C:2225 | Expenses | EXP[t], t = 1 . . . 720 |
| 8 | 17C:2230 | Goals | see Table 26 |
| 9 | 17C:2235 | Liquidatable asset | None |
| 10 | 17C:2240 | core System Strategy | Strategy-3 |
| 11 | 17C:2240 | Excess Threshold ET ($) | 800,000 |
| 12 | 17C:2240 | satellite System Strategy | Strategy-11 |
| 13 | 17C:2245 | Goals success likelihood acceptability | p = 1:95 |
| | | | p = 2:90 |
| 14 | 17C:2275 | Private financing | see Table 30 (Aunt Agatha) |
| 15 | 17C:2280 | Financing templates | Specified Goal = Car, |
| | | | Private Additional |
| 16 | 17C:2285 | FS periodic acceptability criteria | Liquidity cushion 12 months |
| 17 | 17C:2290 | FS scenario best criteria af* | maximize the value of goals achieved |

Since the financing templates chosen in Table 37 are the same as those in Table 31, the same seven financing scenarios are present at FIG. 17F step 2515. These financing scenarios are evaluated for each of the car purchase sub-goals.

Table 38 shows an excerpt of the MBFPS FS Report for the FS determined at FIG. 17D step 2390 on Feb. 21, 2021. Each car purchase sub-goal indicates the chosen best financing scenario. Table 39 shows an excerpt of the Periodic Advice at Mar. 1, 2024 (month 36 of the FS), when the car purchase occurs. At the car purchase date, the user's wealth will be known rather than simulated, so the achievable sub-goals will also be known.

TABLE 38
MBFPS, Financial Strategy Report excerpt
MBFPS, Financial Strategy Excerpt

Date Prepared Feb. 21, 2021
Your Goals
Priority HIGH, Acceptability required by you 95%
Goal: Car Purchase in month 36

| | |
|---|---|
| Sub-goal | Probability of Achieving |

| | | |
|---|---|---|
| $20,000 car | | 99% |
| without financing | 88% | |
| with Financing-1 | 99% | |
| $30,000 car | | 86% |
| without financing | 54% | |
| with Financing-2 | 86% | |
| $40,000 car | | 70% |
| without financing | | 38% |
| with Financing-3 | 70% | |
| $50,000 car | | 65% |
| without financing | 06% | |
| with Financing-4 | 65% | |

| | |
|---|---|
| Able to Car Purchase (most likely sub-goal) | 99% |
| Unable to Car Purchase | 1% |
| Total | 100% |

Financing-1 (one loan)
$10,000 Private Loan from Aunt Agatha
Accept loan immediately, acceptance required by Mar. 21, 2022
0% interest payments
Balloon payment of $10,000 at month 120 (Mar. 1, 2031)
Financing-2 (two loans)
$10,000 Private Loan from Aunt Agatha (see Financing-1)
$20,000 Third Party Loan from Zebra Bank
Must buy car at start of loan, as Zebra Bank demands security
interest
Receive $20,000 at month 36 (Mar. 1, 2024)
Make $296 monthly amortization payments from Apr. 1, 2024 to
Mar. 1, 2031
Loan fully repaid at Mar. 1, 2031
Financing-3 (two loans)
$10,000 Private Loan from Aunt Agatha (see Financing-1)
$30,000 Third Party Loan from Zebra Bank
Must buy car at start of loan, as Zebra Bank demands security
interest
Receive $30,000 at month 36 (Mar. 1, 2024)
Make $443 monthly amortization payments from Apr. 1, 2024 to
Mar. 1, 2031
Loan fully repaid at Mar. 1, 2031
Financing-4 (two loans)
$10,000 Private Loan from Aunt Agatha (see Financing-1)
$40,000 Third Party Loan from Zebra Bank
Must buy car at start of loan, as Zebra Bank demands security
interest
Receive $40,000 at month 36 (Mar. 1, 2024)
Make $591 monthly amortization payments from Apr. 1, 2024 to
Mar. 1, 2031
Loan fully repaid at Mar. 1, 2031
Priority MEDIUM, Acceptability required by you 90%
Goal: Retirement with $9,000 monthly income

| | |
|---|---|
| Sub-goal | Probability of Achieving |

| | |
|---|---|
| Retire at month 360 | 43% |
| Retire at month 480 | 88% |
| Retire at month 600 | 95% |

| | |
|---|---|
| Able to Retire (most likely sub-goal) | 95% |
| Unable to Retire | 5% |
| Total | 100% |

Your Investment Plan

| | |
|---|---|
| Stock Fund, Small Molecule Pharma | 20% |
| Stock Index Fund, Russell 1000 | 40% |
| Stock ETF, China Large Companies | 10% |
| Municipal Bond Fund | 10% |
| Money Market Fund | 20% |

TABLE 39
MBFPS, Periodic Advice Excerpt
Modified Benchmark Financial Planning System, Periodic Advice Excerpt

Date: Start of month 36 = Mar. 1, 2024
You should immediately purchase a $30,000 car by obtaining a $20,000 car loan from Zebra
Bank if your FS scenario best af* criteria remains: maximize the value of goals achieved.
Otherwise, you can purchase a $20,000 car using your savings and $10,000 loan from Aunt
Agatha that accepted on Mar. 1, 2021.
Goal of Car Purchase occurs now. You have sufficient funds to achieve the following sub-goals:
Goal: Car Purchase in month 36

| Sub-goal | Probability of Achieving | |
|---|---|---|
| $20,000 car | | 100% |
| without financing | 0% | |
| with Financing-1 | 100% | |
| $30,000 car | | 100% |
| without financing | 0% | |
| with Financing-2 | 100% | |
| $40,000 car | | 0% |
| without financing | 0% | |
| with Financing-3 | 0% | |
| $50,000 car | | 65% |
| without financing | 0% | |
| with Financing-4 | 0% | |

Financing-1 (one loan)
$10,000 Private Loan from Aunt Agatha
Accepted in month 1
0% interest payments
Balloon payment of $10,000 at month 120 (Mar. 1, 2031)
Financing-2 (two loans)
$10,000 Private Loan from Aunt Agatha (see Financing-1)
$20,000 Third Party Loan from Zebra Bank
Must buy car at start of loan, as Zebra Bank demands security interest
Receive $20,000 at month 36 (Mar. 1, 2024)
Make $296 monthly amortization payments from Apr. 1, 2024 to Mar.
1, 2031
Loan fully repaid at Mar. 1, 2031

### Fifth Use Case: MCFPS with Automated Product and Financing Selection

Turning now to the MCFPS of FIG. 21, assume that two product suppliers, Aleph Car Co. and Beta Car Co. have provided three car product offers, for Ultex, Scoop and Ohm model cars, as shown in the columns in Table 40. Note that the second product offer, a Scoop car, is eligible for two supplier financing offers.

TABLE 40
Exemplary Product Offers

| | | | | |
|---|---|---|---|---|
| 1 | Record Location | Products | Products | Products |
| | | Database | Database | Database |
| 2 | Record ID | TPPOffer-1 | TPPOffer-2 | TPPOffer-3 |
| 3 | Product Supplier | Aleph Car Co. | Aleph Car Co. | Beta Car Co. |
| 4 | Product Type | Car | Car | Car |
| 5 | Model Name | Ultex | Scoop | Ohm |
| 6 | Cost ($K) | 20 | 30 | 40 |
| 7 | Supplier Financing | No | PSFOffer-1, | No |
| | | | PSFOffer-2 | |
| 8 | MPG Combined | 32 | 28 | 35 |
| 9 | Length (mm) | 4210 | 4370 | 4046 |
| 10 | Doors | 4 | 4 | 4 |
| 11 | No. adult seats | 4 | 5 | 4 |
| 12 | Trunk size (cubic | 21 | 20 | 18 |
| | feet) | | | |

Further, assume that two third-party financing providers, Yoyo Bank and Zebra Bank, have offered to lend purchase money for a car, along with the two financing offers from Aleph Car Co. for its Scoop car. Also assume that the user's Aunt Agatha has offered, to the user, a ten year zero interest loan of $10,000 with no payments until a balloon payment at the end of the loan, for anything that s/he wishes to buy, and that Aunt Agatha wants to user to accept or decline Agatha's loan offer by Mar. 21, 2022. These five financing offers are shown in Table 41.

TABLE 41
Exemplary Financing Offers

| | | | | | | |
|---|---|---|---|---|---|---|
| 1 | Record Location | Financing | Financing | Products | Products | Client |
| | | Database | Database | Database | Database | Database |
| 2 | Record ID | TPFOffer-1 | TPFOffer-2 | PSFOffer-1 | PSFOffer-2 | UFOffer-1 |
| 3 | Financing Provider | Yoyo | Zebra | Aleph | Aleph | Aunt |
| | | Bank | Bank | Car Co. | Car Co. | Agatha |
| 4 | Financing Type | Car | Car | Car | Car | Anything |
| | | purchase | purchase | purchase | purchase | |
| 5 | Minimum Amount | 1 | 1 | 1 | 1 | 10 |
| | ($K) | | | | | |
| 6 | Maximum Amount | 50 | 50 | 50 | 50 | 10 |
| | ($K) | | | | | |
| 7 | Security Interest | Yes | Yes | Yes | Yes | No |
| | (Lien) | | | | | |
| 8 | Maximum Percent | 80 | 85 | 90 | 95 | 100 |
| | of Item Value | | | | | |
| 9 | One-Time Fee ($) | 0 | 0 | 100 | 0 | 0 |
| 10 | Term (months) | 60 | 84 | 60 | 60 | 120 |
| 11 | Interest Rate | Prime + 4% | Prime + 3% | Prime + 0% | Prime + 3% | 0%, |
| | | | | | | balloon |
| 12 | Accept By | NA | NA | Dec. 31, 2021 | NA | Mar. 21, 2022 |
| 13 | Prepayment Penalty | 0 | 0 | 0 | 0 | 0 |
| 14 | Borrower payments | 30 | 30 | 40 | 40 | NA |
| | max % of income | | | | | |
| 15 | Borrower max PDR | 10 | 8 | 05 | 05 | NA |
| | % | | | | | |

Assume user goals are as specified in the first use case. Also assume that the user has specified certain parameters for automated product and financing selection as shown in Table 42.

TABLE 42
MCFPS Exemplary user parameters

| | | | |
|---|---|---|---|
| 1 | FIG.:Step | Record Location | Client |
| | | | Database |
| 2 | 21C:3305 | Goal-ID | g = 2 |
| 3 | 21C:3305 | Description | Car Purchase |
| 4 | 21C:3305 | Goal Value G[g] ($K) | 30 |
| 5 | 21C:3305 | Goal Start Date GS[g] | month 36 |
| 6 | 21C:3305 | Goal End Date GE[g] | month 156 |
| 7 | 21C:3305 | Goal Cash Flow per month GCF[t, g] ($K) | 1 |
| 8 | 21D:3410 | Product type | Car |
| 9 | 21D:3420 | Cost ($K) | 20-40 |
| 10 | 21D:3420 | MPG Combined | 25-100 |
| 11 | 21D:3420 | Length (mm) | 4000-4500 |
| 12 | 21D:3420 | Doors | 2-5 |
| 13 | 21D:3420 | No. adult seats | 2-6 |
| 14 | 21D:3420 | Trunk size (cubic feet) | 16-32 |
| 15 | 21C:3325 | Private financing | UFOffer-1 |
| 16 | 21C:3330 | Financing templates | Any, |
| | | | Combined |
| 17 | 21C:3335 | Financial plan acceptability criteria | FP_PDR < PDR-Threshold, |
| | | | PDR-Threshold = 5% |
| 18 | 21C:3340 | Lifetime acceptability criteria | Maximize Value |
| | | | of Goals Achieved |

At FIG. 21D step 3407, for the second goal, Car Purchase, the user indicates that the goal is for a product. At step 3410, the user selects “Car” as the product type. At step 3420, the MCFPS uses the product characteristics provided at step 3415 to determine which of the product offers stored in products database 3179 are relevant, i.e., if the product offer's product characteristics satisfy the user's desired characteristics, then the product offer is relevant. Also, the user's characteristics must satisfy the borrower criteria in the product offer. As this is a contrived example, unsurprisingly, all three product offers are relevant. In reality, most of the product offers are usually irrelevant to a user's specific goal. At step 3430, the MCFPS determines that, since the goal value range endpoints, $20,000 and $40,000, do not differ from the selected product values, then the product scenarios are just the three cars in the relevant product offers.

At step 3530 of FIG. 21E, the MCFPS determines the goal-product financing scenarios. The product scenarios were determined at step 3430 of FIG. 21D. The financing scenarios arise from the two acceptable financing templates and the five financing offers. At step 3330 of FIG. 21C, the user specified that “any financing” and “combined financing” are acceptable. Due to the “any financing” template, each of the five financing offers shown above is relevant by itself, as is cash-only financing. Due to the “combined financing” template, Aunt Agatha's offer (private financing) can be combined with each of the third-party financing offers or with each of the product supplier financing offers, yielding four relevant combination financing offers. Thus, there are one cash-only scenario plus five standalone scenarios plus four combined scenarios, or ten financing scenarios. Table 43 shows the 22 goal-product financing scenarios to be evaluated in this example. Note that since PSFOffer-1 and PSFOffer-2 are available only for a Scoop car, the full 3 car product scenarios*10 financing scenarios=30 combinatoric goal-product financing scenarios are not available.

TABLE 43
Goal-product financing scenarios for MCFPS example

| | |
|---|---|
| 1 | Ultex Car, no financing |
| 2 | Scoop Car, no financing |
| 3 | Ohm Car, no financing |
| 4 | Ultex Car, financing TPFOffer-1 |
| 5 | Scoop Car, financing TPFOffer-1 |
| 6 | Ohm Car, financing TPFOffer-1 |
| 7 | Ultex Car, financing TPFOffer-2 |
| 8 | Scoop Car, financing TPFOffer-2 |
| 9 | Ohm Car, financing TPFOffer-2 |
| 10 | Scoop Car, financing PSFOffer-1 |
| 11 | Scoop Car, financing PSFOffer-2 |
| 12 | Ultex Car, financing UFOffer-1 |
| 13 | Scoop Car, financing UFOffer-1 |
| 14 | Ohm Car, financing UFOffer-1 |
| 15 | Ultex Car, financing TPFOffer-1 & UFOffer-1 |
| 16 | Scoop Car, financing TPFOffer-1 & UFOffer-1 |
| 17 | Ohm Car, financing TPFOffer-1 & UFOffer-1 |
| 18 | Ultex Car, financing TPFOffer-2 & UFOffer-1 |
| 19 | Scoop Car, financing TPFOffer-2 & UFOffer-1 |
| 20 | Ohm Car, financing TPFOffer-2 & UFOffer-1 |
| 21 | Scoop Car, financing PSFOffer-1 & UFOffer-1 |
| 22 | Scoop Car, financing PSFOffer-2 & UFOffer-1 |

At FIG. 21F step 3630, assume that all of the iteration plans corresponding to the goal-product financing scenarios meet the financial plan acceptability criteria selected by the user, that is, the PDR of each iteration plan is <5%.

At step 3670 of FIG. 21F, the MCFPS selects the iteration plan that best meets the lifetime criteria selected by the user: maximize value of goals. Here, the Ohm car has the highest value, $40,000, so only iteration plans with the Ohm car survive, and all of these scenarios have the same car goal value. The MCFPS selects the iteration plan that gets the Ohm car at lowest cost, because that maximizes the funds available for other user goals, consistent with the criteria of maximize goal values achieved. Cost is lowest when the user avoids interest charges exceeding the user's investment returns, so all of the third-party bank and product supplier financing is eliminated. Maximizing funds occurs when the user employs Aunt Agatha's loan, because the user is getting investment returns from Agatha's loaned money. Hence, the MCFPS chooses the iteration plan for the 14th goal-product financing scenario, Ohm car with financing UFOffer-1. Assume that at step 3625 of FIG. 21F, the MCFPS determined that the PDR for this scenario is 4.5%, and at step 3630, the MCFPS determined that this PDR satisfies the user's financial plan acceptability criteria requiring PDR<5%.

If the user lacked sufficient cash for the car purchase, the difference of $30,000 between the car cost of $40,000 and Aunt Agatha's $10,000 loan, then the MCFPS would have selected the best combined financing (lowest lifetime interest payments), TPFOffer-1 and UFOffer-1, in the iteration plan for 17th goal-product financing scenario. In particular, TPFOffer-1 includes interest payments of Prime+4% for 60 months, versus TPFOffer-2 includes interest payments of Prime+3% for 84 months, so TPFOffer-1 likely provides for lowest lifetime interest payments (depends on what Prime interest rate turns out to be during the loan term).

Table 44 is an excerpt of a financial plan for this use case.

TABLE 44
MCFPS: Financial Plan excerpt
Modified Conventional FPS, Financial Plan Excerpt

| Your Goals | |
|---|---|
| (1) Retirement with $9,000 monthly income | |
| at month 240. | |
| (2) Ohm Car Purchase from Beta Car Co., | |
| $40,000 at month 36 with $1,000 monthly | |
| operating costs, using Aunt Agatha loan of | |
| $10,000 at 0% interest and balloon payment. | |
| . . . | |
| Your Investment Plan | |
| Stock Fund, Small Molecule Pharma | 20% |
| Stock Index Fund, Russell 1000 | 40% |
| Stock ETF, China Large Companies | 10% |
| Municipal Bond Fund | 10% |
| Money Market Fund | 20% |
| Predicted Default Rate (PDR) | 4.5% |

### Sixth Use Case: MBFPS with Automated Product and Financing Selection

Assume the same product and financing offers as in the fifth use case above.

Assume user goals are as specified in the second use case. Also assume that the user has specified certain parameters for automated product and financing selection as shown in Table 46. The acceptability threshold for goals success likelihood, SFS-TH and SWeightpriority, is discussed at step 2245 of FIG. 17C. As discussed at step 2370 of FIG. 22D, the success of the Financial Strategy (SFS) is compared with SFS-TH. Here, the user defines his/her FS as successful if there is a 90% chance of meeting all goals. The user gives high priority goals a weight of 0.60, and medium priority goals a weight of 0.40. In this example, the user lacks low priority goals, so there is no weight for low priority goals, SWeight low. The available periodic acceptability criteria are discussed at step 2170 of FIG. 17B.

TABLE 46
MBFPS Exemplary user parameters

| | | | | |
|---|---|---|---|---|
| 1 | FIG.:Step | Record Location | Client | Client |
| | | | Database | Database |
| 2 | 22C:4230 | Goal-ID | g = 1 | g = 2 |
| 3 | 22C:4230 | Description | Retirement | Car Purchase |
| 4 | 22C:4230 | Priority | Medium | High |
| 5 | 22C:4230 | Goal Value G[g] ($K) | 0 | range: 20-40 |
| | | | | subgoal1: 20 |
| | | | | subgoal2: 30 |
| | | | | subgoal3: 40 |
| 6 | 22C:4230 | Goal Start Date GS[g] | range: 240-312 | month 36 |
| | | | subgoal1: 240 | |
| | | | subgoal2: 264 | |
| | | | subgoal3: 288 | |
| | | | subgoal4: 312 | |
| 7 | 22C:4230 | Goal End Date GE[g] | month 480 | month 156 |
| 8 | 22C:4230 | Goal Cash Flow | 9 | 1 |
| | | per month GCF[t, g] | | |
| | | ($K) | | |
| 9 | 22D:4310 | Product type | | Car |
| 10 | 22D:4315 | Use present or future | | Future Value |
| | | value | | |
| 11 | 22D:4315 | MPG Combined | | 25-100 |
| 12 | 22D:4315 | Length (mm) | | 4000-4500 |
| 13 | 22D:4315 | Doors | | 2-5 |
| 14 | 22D:4315 | No. adult seats | | 2-6 |
| 15 | 22D:4315 | Trunk size (cubic feet) | | 16-32 |

| | | | |
|---|---|---|---|
| 16 | 22C:4245 | Acceptability threshold | SFS-TH = 90% |
| | | for goals success | SWeight_high = 0.60 |
| | | likelihood | SWeight_medium = 0.40 |
| 17 | 22C:4275 | Private financing | UFOffer-1 |
| 18 | 22C:4280 | Financing templates | Any, |
| | | | Combined |
| 19 | 22C:4290 | Periodic acceptability | Min savings |
| | | criteria | $1000 per month |

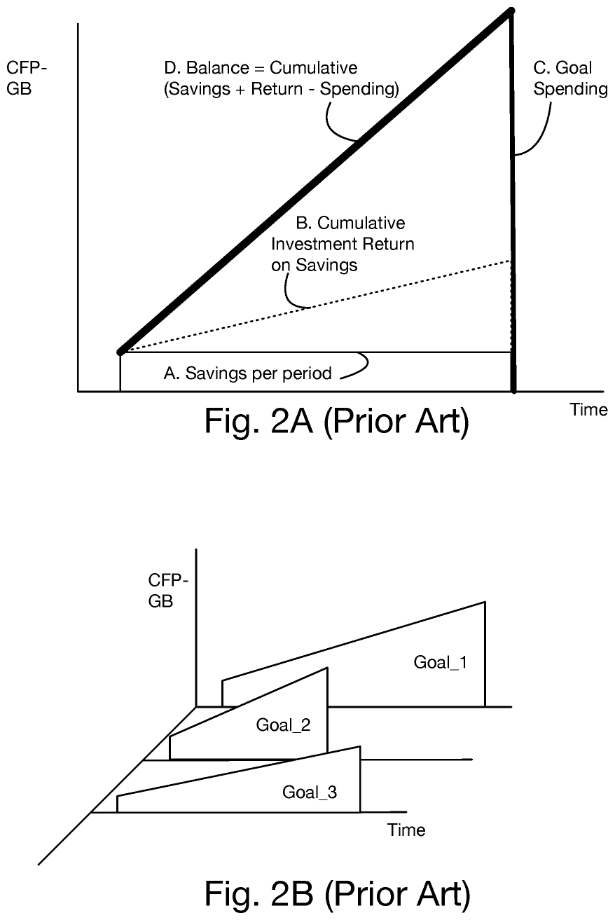

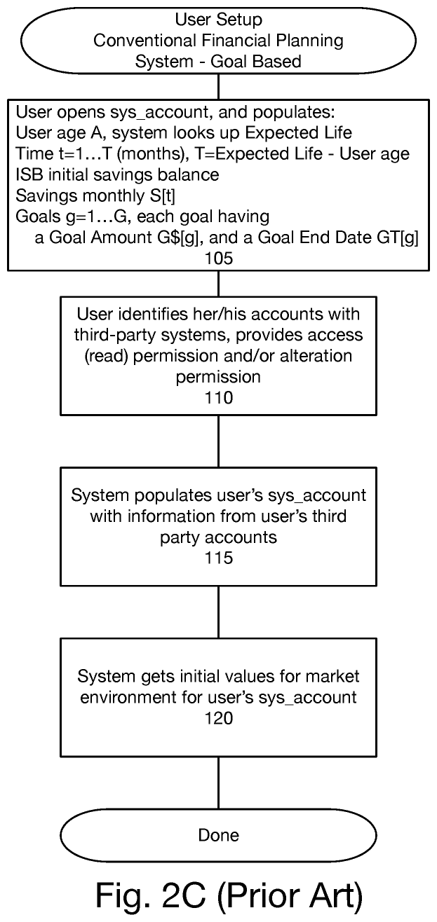

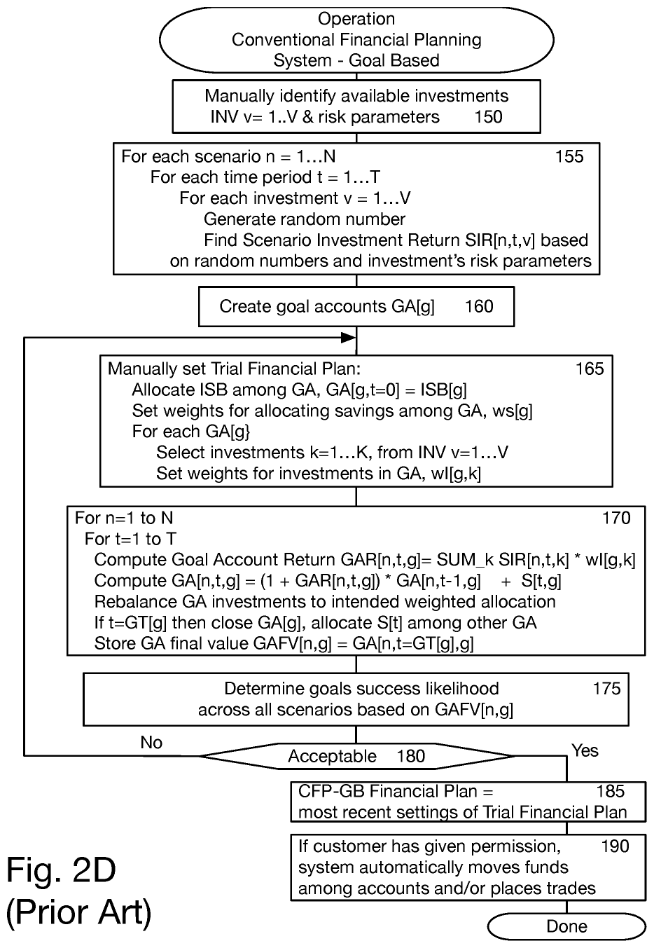

Constructing a FS begins at FIG. 22E step 4410, with creation of simulations for investment returns scenarios for the lifetime of the FS. As discussed for step 810 of FIG. 11A and step 155 of FIG. 2D, about 1,000 simulations are created, simulating the behavior of markets.

At step 4420 of FIG. 22E, the benchmark curve is determined for each priority level. See FIG. 8H, showing processing identical to FIG. 22F, and the discussion of FIG. 11B.

At step 4430 of FIG. 22E, investment weights are determined, see step 830 of FIG. 11A.

At step 4440 of FIG. 22E, the wealth at the start of the FS lifetime is set to the user's ISB defined at step 4220 of FIG. 22C.

At step 4445 of FIG. 22E, the goal-product financing scenarios are determined.

In this example, as in the third use case, there are three products that meet the user's requirements: Ultex, Scoop and Ohm cars, determined at step 4320 of FIG. 22D. Subgoal1, a $20,000 car, corresponds to an Ultex. Subgoal2, a $30,000 car, corresponds to a Scoop. Subgoal3, a $40,000 car, corresponds to an Ohm. There is no reason for the MBFPS to evaluate the each sub-goal in a separate scenario because the value of the products is identical to the value of the sub-goals. Thus, at step 4330 of FIG. 22D, the MBFPS decides that there are three product scenarios.

Assume financing offers as in the third use case: a private financing offer from Aunt Agatha, defined at step 4275 of FIG. 22C, and financing templates selected at step 4280. Then, at step 4445, the MBFPS determines that there are five relevant financing offers leading to nine financing scenarios. But, the product supplier financing offers are restricted to the Scoop car.

In a realistic situation, available products would not correspond so precisely to subgoals, so the MBFPS would maintain the original sub-goal for a scenario, and also evaluate the available products in separate scenarios. For instance, if the suitable financing offers in the financing database were for a $25,000 Acmi car and a $35,000 Luxura car, then the MBFPS would create five scenarios for:
a $20,000 generic car,
a $25,000 Acmi car,
a $30,000 generic car,
a $35,000 Luxura car, and
a $40,000 generic car.

The result is the goal-product financing scenarios shown in the third use case above.

At FIG. 22E, when t=36, the starting month of the Car Purchase goal, it is evaluated as in FIG. 22G. At FIG. 22G step 4615, the effect of financing on wealth B[n,t,af], for this simulated investment scenario n, time period t=month 36 (when this goal starts), and goal-product financing scenario af, is estimated. Assume that the user satisfies the lenders' borrower criteria for all loans.

At step 4620, the scenario is eliminated if it violates the user's periodic criteria. In this example, the periodic criteria are that the user wants to save at least $1,000 per month. Committing to a sub-goal that interferes with savings is not permitted.

Assume that the three all cash (no financing) product financing scenarios block the user from saving at least $1,000 per month. The MBFPS eliminates scenarios 1, 2, 3 at step 4620.

Also assume that the only scenario that permits saving $1,000 monthly when relying only on Aunt Agatha's financing is for the cheapest Ultex car. The MBFPS eliminates the scenarios for Scoop with only Aunt Agatha financing, and for Ohm with only Aunt Agatha financing at step 4620.

At step 4622, the remaining eligible scenarios are stored in client database 4024, 4055, 4064, 4083 when the MBFPS is FPS 4020, 4050, 4060, 4080, respectively.

At step 4630, according to the scenario-best criteria chosen by the user, the MBFPS picks the scenario with the highest B[n,t,af] as the af* scenario (see step 2530 of FIG. 17F). This will be the scenario that lets the user buy a car with the lowest immediate spending, the scenario for a $20,000 Ultex car using the $10,000 loan from Aunt Agatha and TPFOffer-2 from Zebra Bank, which provides a loan for 85% of the item's value, 0.85*20,000=17,000. Because of these two loans, the user spends only $3,000 in month 36 to purchase an Ultex car. Of course, the user then has monthly payments to Zebra Bank, and a balloon payment to Aunt Agatha.

At step 4635, the MBFPS checks whether the user's estimated wealth for month 36, assuming the af′ scenario, exceeds the benchmark curve for month 36. Assume so in all cases.

At step 4660, the MBFPS adjusts parameters for this scenario, and at step 4665 commits to this sub-goal.

Returning to FIG. 22E, at step 4460, the MBFPS determines the goals success likelihood. As in the second use case, assume the success likelihood of the car goal is 999/1,000=99.9%. As in the second use case, assume the retirement goal succeeds in 970 of the 1,000 scenarios, so its goal success likelihood is 97%.

At step 4465, the MBFPS automatically evaluates the success of the FS and determines if it is acceptable according to the acceptability threshold for goals success likelihood provided by the user. Here, SFS=(SWeight_high*(success likelihood of car purchase))+(SWeight medium*(success likelihood of retirement))=(0.6*0.99)+(0.4*0.97)=0.594+0.388=0.982=98.2%. The user specified SFS-Th=90%. Since SFS 98.2%>SFS-Th 90%, this FS is acceptable.

At step 4480, the MBFPS determines that Aunt Agatha's loan has an accept-by timing restriction, so at step 4484, the user commits to Aunt Agatha's loan. At step 4486, the MBFPS updates the FS to show the user has an additional $10,000 in cash, and also has an obligation to make a payment of $10,000 to Aunt Agatha in 120 months. The $10,000 is automatically invested until it is needed for purchasing the Ultex car.

At step 4490, the MBFPS stores the FS in the appropriate one of client databases 4024, 4055, 4064, 4083, and the MBFPS converts the FS to a reduced (anonymized) FS and sends it to benchmark utility program 4022 for storage in reduced database 4025.

At step 4495, the MBFPS applies the FS, so that when the user has approved automatic purchases and there have been no changes in the market environment or user's situation, at month 36, an Ultex car will be automatically purchased by the MBFPS on behalf of the user, using Aunt Agatha's $10,000 loan, a $17,000 loan from Zebra Bank and $3,000 from sale of appropriate quantity of the user's investments.

Based on this FS, an exemplary goals results report is shown in Table 47. Note that the PDR during the term of each loan is presented separately from the lifetime PDR. This report is available at step 4470 of FIG. 22E from the Personal Research interactive interface. Table 48 is an excerpt of periodic advice.

TABLE 47
MBFPS, Exemplary Results Report
Modified Benchmark Financial Planning
System, Financial Strategy Excerpt
Results Report for Goals
Priority HIGH
Goal: Car Purchase in month 36

| | |
|---|---|
| Sub-goal | Probability |
| | of Achieving |

| Ultex car | 99% |
|---|---|
| with $10,000 (0%) 120 month loan from | |
| Aunt Agatha and $17,000 (Prime + 3%) | |
| 84 month loan from Zebra Bank | |
| Scoop car | 0% |
| Ohm car | 0% |

| | |
|---|---|
| Able to Car Purchase (sum of sub-goals) | 99% |
| Unable to Car Purchase | 1% |
| Total | 100% |
| PDR during term of loan from Zebra Bank | 0.3% |
| PDR during term of loan from Aunt Agatha | 0.4% |

| Priority MEDIUM | |
|---|---|
| Goal: Retirement with $9,000 monthly income | |
| Sub-goal | Probability |
| | of Achieving |

| | |
|---|---|
| Retire at month 240 | 18% |
| Retire at month 264 | 22% |
| Retire at month 288 | 27% |
| Retire at month 312 | 30% |

| | |
|---|---|
| Able to Retire (sum of sub-goals) | 97% |
| Unable to Retire | 3% |
| Total | 100% |
| Predicted Default Rate (PDR) | 3% |

TABLE 48
MBFPS, Periodic Advice Excerpt
Modified Benchmark Financial Planning System, Periodic Advice Excerpt

Date: Start of month 36 = Mar. 1, 2024
You should immediately purchase a $20,000 Ultex car using your savings and $10,000 loan
from Aunt Agatha that accepted on Mar. 1, 2021.
Goal of Car Purchase occurs now. You have sufficient funds to achieve the following sub-goals:
Goal: Car Purchase in month 36

| Sub-goal | Probability of Achieving | |
|---|---|---|
| $20,000 Ultex car | | 100% |
| without financing | 0% | |
| with Financing-1 | 100% | |
| $30,000 Scoop car | | 100% |
| without financing | 0% | |
| with Financing-2 | 100% | |
| $40,000 car | | 0% |
| without financing | 0% | |
| with Financing-3 | 0% | |
| $50,000 car | | 65% |
| without financing | 0% | |
| with Financing-4 | 0% | |

Financing-1 (one loan)
$10,000 Private Loan from Aunt Agatha
Accepted in month 1
0% interest payments
Balloon payment of $10,000 at month 120 (Mar. 1, 2031)
Financing-2 (two loans)
$10,000 Private Loan from Aunt Agatha (see Financing-1)
$20,000 Third Party Loan from Zebra Bank
Must buy car at start of loan, as Zebra Bank demands security interest
Receive $20,000 at month 36 (Mar. 1, 2024)
Make $296 monthly amortization payments from Apr. 1, 2024 to Mar. 1, 2031
Loan fully repaid at March 1, 2031

Although illustrative embodiments of the present invention, and various modifications thereof, have been described in detail herein with reference to the accompanying drawings, it is to be understood that the invention is not limited to these precise embodiments and the described modifications, and that various changes and further modifications may be effected therein by one skilled in the art without departing from the scope or spirit of the invention as defined in the appended claims.

What is claimed is:

1: A method of creating a best financial plan for a user, the financial plan showing how at least one goal is affordable based on the user's income, expenses and investment performance, the financial plan having automatically selected financing for the at least one goal, comprising:
storing, in a user database, the at least one goal defined by the user, at least one financing template chosen by the user, acceptability criteria and optimality criteria;
storing, in a financing database, financing offers from financing providers, each financing offer having financing terms;
creating, for each goal, a set of goal-financing scenarios based on the goal, the user financing templates, and the financing offers;
generating a draft financial plan for each goal-financing scenario;
eliminating draft financial plans according to the acceptability criteria to generate a set of acceptable financial plans;
selecting the best financial plan according to the optimality criteria from the acceptable financial plans; and
storing the best financial plan in the user database.

2: The method of claim 1, wherein generating the draft financial plan includes:
generating a set of N investment performance scenarios, each investment performance scenario for T time periods, N being at least about 100 to provide realistic statistics; and
computing, for each goal-financing scenario, user wealth at time T for each of the N investment performance scenarios.

3: The method of claim 1,
wherein the financing terms of the financing offer include type of acceptable goal, and at least one borrower requirement; and
wherein creating the set of goal-financing scenarios includes:
creating a set of possible financing scenarios based on the goal and the at least one financing template,
selecting the financing offers so that the goal meets the goal type in the financing terms and the user meets the borrower requirement in the financing terms, and
associating one of the possible financing scenario with at least one of the selected financing offers to create one of the goal-financing scenarios.

4: The method of claim 1,
wherein the financing terms of the financing offer include a maximum loan amount, and
wherein creating the set of goal-financing scenarios includes selecting the loan amounts in each of the goal-financing scenarios.

5: The method of claim 1,
further comprising storing, in the user database, at least one private financing offer available only to the user; and
wherein the financing templates specify acceptable combinations of the financing offers in the financing database and the private financing offers in the user database.

6: The method of claim 1,
further comprising storing, in a supplemental financing database, at least one supplemental financing offer associated with a provider of a financial planning system; and
wherein the financing templates specify acceptable combinations of the financing offers in the financing database and the supplemental financing offers in the supplmental financing database.

7: The method of claim 1, further comprising:
creating an anonymized best financial plan by removing user identifying information from the best financial plan;
storing the anonymized best financial plan in a reduced client database; and
generating a financing demand curve based on the stored anonymized best financial plans.

8: The method of claim 7, further comprising
sending the financing demand curve to at least one of the financing providers;
receiving, from at least one of the financing providers, an improved financing offer; and
automatically determining whether the best financial plan should be revised to include the improved financing offer.

9: The method of claim 1, wherein at least one of the stored financing offers is a hypothetical offer; and
further comprising recording when the hypothetical financing offer is included in the best financial plan.

10: The method of claim 1, further comprising determining a predicted default rate for each of the draft financial plans; and
wherein the financing terms for at least one of the financing offers specifies a minimum value for the predicted default rate.

11: A method of creating a best financial strategy for a user, the financial strategy showing how at least one goal is affordable based on the user's income, expenses and investment performance, the financial strategy having automatically selected financing for at least one goal, comprising:
storing, in a user database, the at least one goal defined by the user, at least one financing template chosen by the user, periodic criteria and scenario-best criteria;
storing, in a financing database, financing offers from financing providers, each financing offer having financing terms;
creating, for each goal, a set of goal-financing scenarios based on the goal, the user financing templates, and the financing offers;
for each goal-financing scenario, estimating the effect of financing on user wealth;
eliminating goal-financing scenarios by comparing user wealth with the periodic criteria;
selecting the best goal-financing scenario according to the scenario-best criteria;
generating the best financial strategy in accordance with the best goal-financing scenario; and
storing the best financial strategy in the user database.

12: The method of claim 11, further comprising storing, in the user database, an investment strategy specifying allocation of wealth of the user among V investments;
and wherein each goal includes a start time period;
and wherein generating the best financial strategy includes
generating a set of N investment performance scenarios, each investment performance scenario for T time periods, N being at least about 100 to provide realistic statistics;
for each of the T time periods, generating a benchmark based on the goals;
for each of the T time periods in each of the N investment performance scenarios, determining wealth based on the investment performance scenario, the investment strategy, and the best goal-financing scenario; and
including the goal in the best financial strategy when, at the start time period of the goal, the determined wealth for the start time period exceeds the benchmark for the start time period,

13: The method of claim 11,
wherein the financing terms of the financing offer include type of acceptable goal, and at least one borrower requirement; and
wherein creating the set of goal-financing scenarios includes:
creating a set of possible financing scenarios based on the goal and the at least one financing template,
selecting the financing offers so that the goal meets the goal type in the financing terms and the user meets the borrower requirement in the financing terms, and
associating one of the possible financing scenario with at least one of the selected financing offers to create one of the goal-financing scenarios.

14: The method of claim 11,
wherein the financing terms of the financing offer include a maximum loan amount, and
wherein creating the set of goal-financing scenarios includes selecting the loan amounts in each of the goal-financing scenarios.

15: The method of claim 11,
further comprising storing, in the user database, at least one private financing offer available only to the user; and
wherein the financing templates specify acceptable combinations of the financing offers in the financing database and the private financing offers in the user database.

16: The method of claim 11,
further comprising storing, in a supplemental financing database, at least one supplemental financing offer associated with a provider of a financial planning system; and
wherein the financing templates specify acceptable combinations of the financing offers in the financing database and the supplemental financing offers in the supplmental financing database.

17: The method of claim 11, further comprising:
creating an anonymized best financial plan by removing user identifying information from the best financial plan;
storing the anonymized best financial plan in a reduced client database; and
generating a financing demand curve based on the stored anonymized best financial plans.

18: The method of claim 17, further comprising
sending the financing demand curve to at least one of the financing providers;
receiving, from at least one of the financing providers, an improved financing offer; and
automatically determining whether the best financial plan should be revised to include the improved financing offer.

19: The method of claim 11, wherein at least one of the stored financing offers is a hypothetical offer; and
further comprising recording when the hypothetical financing offer is included in the best financial strategy.

20: The method of claim 11, further comprising determining a predicted default rate for the best financial strategy; and
wherein the financing terms for at least one of the financing offers specifies a minimum value for the predicted default rate.

21: A method of creating a best financial plan for a user, the financial plan showing how at least one goal is affordable based on the user's income, expenses and investment performance, the financial plan having an automatically selected product for the at least one goal, comprising:
storing, in a user database, the at least one goal defined by the user, a set of chosen product characteristics associated with the goal and chosen by the user, acceptability criteria and optimality criteria;
storing, in a products database, product offers from product providers, each product offer having offered product characteristics;
automatically selecting a set of products from the products database, the offered product characteristics of each selected product satisfying the chosen product characteristics;
generating a draft financial plan for each selected product as the goal;
eliminating draft financial plans according to the acceptability criteria to generate a set of acceptable financial plans;
selecting the best financial plan according to the optimality criteria from the acceptable financial plans; and
storing the best financial plan in the user database.

22: The method of claim 21, wherein generating the draft financial plan includes:
generating a set of N investment performance scenarios, each investment performance scenario for T time periods, N being at least about 100 to provide realistic statistics; and
computing, for each product, user wealth at time T for each of the N investment performance scenarios.

23: The method of claim 21,
further comprising storing, in a supplemental products database, at least one supplemental product offer associated with a provider of a financial planning system; and
wherein the set of products is automatically selected from the products database and the supplemental products database.

24: The method of claim 21, further comprising:
creating an anonymized best financial plan by removing user identifying information from the best financial plan;
storing the anonymized best financial plan in a reduced client database; and
generating a product demand curve based on the stored anonymized best financial plans.

25: The method of claim 24, further comprising:
sending the product demand curve to at least one of the product providers;
receiving, from at least one of the product providers, an improved product offer; and
automatically determining whether the best financial plan should be revised to include the improved product offer.

26: The method of claim 21, wherein at least one of the stored product offers is a hypothetical product, and further comprising recording when the hypothetical product offer is included in the best financial plan.

27: The method of claim 21,
wherein storing, in the user database, also includes at least one financing template chosen by the user;
further comprising
storing, in a financing database, financing offers from financing providers, each financing offer having financing terms; and
creating, for each goal, a set of goal-product-financing scenarios based on the goal, the set of selected products, the user financing templates, and the financing offers; and
wherein a draft financial plan is generated for each goal-product-financing scenario.

28: The method of claim 27,
further comprising storing, in the products database, at least one product financing offer from the product provider; and
wherein the set of goal-product-financing scenarios is also based on the product financing offer.

29: The method of claim 27,
further comprising storing, in the user database, at least one private financing offer available only to the user; and
wherein the set of goal-product-financing scenarios is also based on the private financing offer.

30: The method of claim 27,
further comprising storing, in a supplemental financing database, at least one supplemental financing offer associated with a provider of a financial planning system; and
wherein the set of goal-product-financing scenarios is also based on the supplemental financing offer.

31: A method of creating a best financial strategy for a user, the financial strategy showing how at least one goal is affordable based on the user's income, expenses and investment performance, the financial strategy having an automatically selected product for at least one goal, comprising:
storing, in a user database, the at least one goal defined by the user, a set of chosen product characteristics associated with the goal and chosen by the user, periodic criteria and scenario-best criteria;
storing, in a products database, product offers from product providers, each product offer having offered product characteristics;
automatically selecting a set of products from the products database, the offered product characteristics of each selected product satisfying the chosen product characteristics;
for each selected product, estimating the effect of purchasing the product on user wealth;
eliminating products by comparing user wealth with the periodic criteria;
selecting a best product according to the scenario-best criteria;
generating the best financial strategy in accordance with the best product; and
storing the best financial strategy in the user database.

32: The method of claim 31,
further comprising storing, in the user database, an investment strategy specifying allocation of wealth of the user among V investments;
and wherein each goal includes a start time period;
and wherein generating the best financial strategy includes
generating a set of N investment performance scenarios, each investment performance scenario for T time periods, N being at least about 100 to provide realistic statistics;
for each of the T time periods, generating a benchmark based on the goals;
for each of the T time periods in each of the N investment performance scenarios, determining wealth based on the investment performance scenario, the investment strategy, and the best product; and
including the goal in the best financial strategy when, at the start time period of the goal, the determined wealth for the start time period exceeds the benchmark for the start time period.

33: The method of claim 31,
further comprising storing, in a supplemental products database, at least one supplemental product offer associated with a provider of a financial planning system; and
wherein the set of products is automatically selected from the products database and the supplemental products database.

34: The method of claim 31, further comprising:
creating an anonymized best financial plan by removing user identifying information from the best financial plan;
storing the anonymized best financial plan in a reduced client database; and
generating a product demand curve based on the stored anonymized best financial plans.

35: The method of claim 34, further comprising:
sending the product demand curve to at least one of the product providers;
receiving, from at least one of the product providers, an improved product offer; and
automatically determining whether the best financial plan should be revised to include the improved product offer.

36: The method of claim 31, wherein at least one of the stored product offers is a hypothetical product, and further comprising recording when the hypothetical product offer is included in the best financial plan.

37: The method of claim 31,
wherein storing, in the user database, also includes at least one financing template chosen by the user;
further comprising
storing, in a financing database, financing offers from financing providers, each financing offer having financing terms; and
creating, for each goal, a set of goal-product-financing scenarios based on the goal, the set of selected products, the user financing templates, and the financing offers; and
wherein
estimating the effect of purchasing the product on user wealth is performed for each goal-product-financing scenario;
eliminating occurs for goal-product-financing scenarios by comparing user wealth with the periodic criteria;
selecting occurs for a best goal-product-financing scenario according to the scenario-best criteria;
generating the best financial strategy occurs in accordance with the best goal-product-financing scenario.

38: The method of claim 37,
further comprising storing, in the products database, at least one product financing offer from the product provider; and
wherein the set of goal-product-financing scenarios is also based on the product financing offer.

39: The method of claim 37,
further comprising storing, in the user database, at least one private financing offer available only to the user; and
wherein the set of goal-product-financing scenarios is also based on the private financing offer.

40: The method of claim 37,
further comprising storing, in a supplemental financing database, at least one supplemental financing offer associated with a provider of a financial planning system; and
wherein the set of goal-product-financing scenarios is also based on the supplemental financing offer.
